(19) United States
(12) Patent Application Publication
(10) Pub. No.: US 2026/0291133 A1
(43) Pub. Date: Sep. 24, 2026

(54) CONNECTOR AND CONNECTOR ASSEMBLY WITH CONDUCTIVE COMPONENT FOR IMPEDANCE CONTROL

(71) Applicant: DONGGUAN LUXSHARE TECHNOLOGIES CO., LTD, Dongguan City (CN)

(72) Inventors: Tao SONG, Dongguan City (CN); Kun LIU, Dongguan City (CN); Feng ZHENG, Dongguan City (CN); Peibin WANG, Dongguan City (CN); Yuanxin WANG, Dongguan City (CN)

(73) Assignee: DONGGUAN LUXSHARE TECHNOLOGIES CO., LTD, Dongguan City (CN)

(21) Appl. No.: 19/573,772

(22) Filed: Mar. 20, 2026

(30) Foreign Application Priority Data
Mar. 21, 2025 (CN) 202510350103.9

(51) Int. Cl. H01R 13/6581; H01R 12/75

(52) U.S. Cl. CPC H01R 13/6581; H01R 12/75

(57) ABSTRACT

A connector includes a housing and an insertion module. The insertion module is at least partially disposed in the housing. The insertion module includes a terminal module. The terminal module includes a terminal block, a shielding sleeve at least partially surrounding the terminal block, and a conductive component at least partially disposed on one side of the shielding sleeve. The terminal block includes a first mating terminal having a first mating portion. The conductive component includes a first insertion hole at least partially located at one end of the first mating portion. A connector assembly including the connector is also disclosed.

### CROSS-REFERENCE TO RELATED APPLICATION

This patent application claims priority of a Chinese Patent Application No. 202510350103.9, filed on Mar. 21, 2025 and titled “SECOND CONNECTOR AND CONNECTOR ASSEMBLY”, the entire content of which is incorporated herein by reference.

### TECHNICAL FIELD

The present disclosure relates to a connector and a connector assembly, belonging to the technical field of electrical connectors.

### BACKGROUND

A connector assembly in the related art typically includes a plug connector and a receptacle connector. The receptacle connector is usually mounted on a circuit board. The receptacle connector generally includes a first housing, a plurality of receptacle terminal modules installed in the first housing, and a mounting plate cooperating with the first housing to secure the receptacle terminal modules. The receptacle terminal modules include an insulating plate, a plurality of receptacle signal terminals secured to the insulating plate, a plurality of receptacle ground terminals secured to the insulating plate, a first shielding plate disposed on one side of the receptacle signals and the ground terminals, and a second shielding plate disposed on another side of the receptacle signals and the ground terminals.

The plug connector includes a plurality of plug signal terminals. When the plug connector mates with the receptacle connector, the receptacle signal terminals are in contact with the plug signal terminals for data transmission.

However, how to control the impedance of the terminals in the process of separation of the plug connector and the receptacle connector to prevent abrupt impedance changes from occurring is a technical problem to solved by those skilled in the art.

### SUMMARY

An embodiment of the present disclosure adopts the following technical solution: a connector including: a housing; and an insertion module, the insertion module being at least partially disposed in the housing; the insertion module including a terminal module; the terminal module including a terminal block, a shielding sleeve at least partially surrounding the terminal block, and a conductive component partially disposed on a side of the shielding sleeve; the terminal block including a first mating terminal; the first mating terminal including a first mating portion; the conductive component defining a first insertion hole at least partially located at one end of the first mating portion.

An embodiment of the present disclosure adopts the following technical solution: a connector assembly including: a first connector including: a first housing; and a first terminal module assembled to the first housing; the first terminal module including a first terminal block; the first terminal block including a first conductive terminal and a first shielding tube; the first conductive terminal including a first contact portion; the first contact portion including a first segment, a second segment connected to the first segment, and a third segment connected to the second segment; the first shielding tube at least partially covering the first segment along a length thereof; the second segment and the third segment protruding beyond the first shielding tube; a second connector including: a second housing; and an insertion module assembled to the second housing; the insertion module including a second terminal module; the second terminal module including a second terminal block, a second shielding sleeve at least partially surrounding the second terminal block, and a conductive component partially disposed on a side of the second shielding sleeve; the second terminal block including an insulating block and a first mating terminal; the first mating terminal including a first mating portion at least partially located in the insulating block; the conductive component defining a first insertion hole at least partially located at one end of the first mating portion; when the first connector and the second connector are fully mated, the third segment of the first contact portion of the first conductive terminal passes through the first insertion hole, and is in contact with the first mating portion of the first mating terminal; and the second segment of the first contact portion is at least partially inserted into the insulating block.

### BRIEF DESCRIPTION OF DRAWINGS

FIG. 1 is a perspective view of a connector assembly in accordance with an embodiment of the present disclosure;

FIG. 2 is a perspective view of FIG. 1 from another angle;

FIG. 3 is a partially exploded perspective view of FIG. 1, with a second connector separated;

FIG. 4 is a partially exploded perspective view of FIG. 3 from another angle;

FIG. 5 is a front view of FIG. 3 after removing the second connector;

FIG. 6 is a rear view of FIG. 3 after removing the second connector;

FIG. 7 is an exploded perspective view of a first connector, a circuit board, and fasteners in FIG. 3;

FIG. 8 is an exploded perspective view of FIG. 7 from another angle;

FIG. 9 is a partial enlarged view of circled part D in FIG. 7;

FIG. 10 is a partial enlarged view of circled part E in FIG. 8;

FIG. 11 is a partially exploded perspective view of the first connector in FIG. 7, with a mounting block separated;

FIG. 12 is a partially exploded perspective view of FIG. 11 from another angle;

FIG. 13 is a partial enlarged view of circled part F in FIG. 12;

FIG. 14 is an exploded perspective view of the mounting block in FIG. 11;

FIG. 15 is an exploded perspective view of FIG. 14 from another angle;

FIG. 16 is a partial enlarged view of circled part G in FIG. 14;

FIG. 17 is a partial enlarged view of circled part H in FIG. 15;

FIG. 18 is a further partially exploded perspective view of the first connector after removing the mounting block in FIG. 11;

FIG. 19 is a partially exploded perspective view of FIG. 18 from another angle;

FIG. 20 is a partially exploded perspective view after removing first retaining pins and second retaining pins from FIG. 18, with a first housing separated;

FIG. 21 is a partially exploded perspective view of FIG. 20 from another angle;

FIG. 22 is a partially exploded perspective view of an installation module in FIG. 20;

FIG. 23 is a partially exploded perspective view of FIG. 22 from another angle;

FIG. 24 is a front view of a first terminal module in FIG. 22;

FIG. 25 is a rear view of the first terminal module in FIG. 22;

FIG. 26 is a left view of the first terminal module in FIG. 22;

FIG. 27 is a right view of the first terminal module in FIG. 22;

FIG. 28 is a partially exploded perspective view of the first terminal module in FIG. 22;

FIG. 29 is a partially exploded perspective view of FIG. 28 from another angle;

FIG. 30 is a partial enlarged view of circled part I in FIG. 29;

FIG. 31 is a further partially exploded perspective view of FIG. 28;

FIG. 32 is a partially exploded perspective view of FIG. 31 from another angle;

FIG. 33 is a partially exploded perspective view of a portion of the first terminal module in FIG. 31;

FIG. 34 is a partially exploded perspective view of FIG. 33 from another angle;

FIG. 35 is a further partially exploded perspective view of FIG. 33;

FIG. 36 is a partial enlarged view of circled part J in FIG. 35;

FIG. 37 is a partial enlarged view of circled part K in FIG. 35;

FIG. 38 is a partial enlarged view of circled part B in FIG. 1;

FIG. 39 is a partial enlarged view of circled part C in FIG. 2;

FIG. 40 is a front view of the second connector in FIG. 4;

FIG. 41 is a rear view of the second connector in FIG. 4;

FIG. 42 is a partially exploded perspective view of the second connector in FIG. 3;

FIG. 43 is a partially exploded perspective view of FIG. 42 from another angle;

FIG. 44 is a further partially exploded perspective view of FIG. 42;

FIG. 45 is a partially exploded perspective view of FIG. 44 from another angle;

FIG. 46 is a front view of an insertion module in FIG. 45;

FIG. 47 is a rear view of the insertion module in FIG. 45;

FIG. 48 is a left view of the insertion module in FIG. 45;

FIG. 49 is a right view of the insertion module in FIG. 45;

FIG. 50 is a partially exploded perspective view of the insertion module in FIG. 44;

FIG. 51 is a partially exploded perspective view of FIG. 50 from another angle;

FIG. 52 is a partially exploded perspective view after removing a second insulating plate from FIG. 50;

FIG. 53 is a partially exploded perspective view of FIG. 52 from another angle;

FIG. 54 is an exploded perspective view of a second terminal module, a second shielding sleeve, a cable, and a conductive component in FIG. 53;

FIG. 55 is an exploded perspective view of FIG. 54 from another angle;

FIG. 56 is a perspective view of a first mating terminal and a second mating terminal as shown in FIG. 54, in accordance with a first embodiment of the present disclosure;

FIG. 57 is a perspective view of the first mating terminal and the second mating terminal in accordance with a second embodiment of the present disclosure;

FIG. 58 is an exploded perspective view of FIG. 57;

FIG. 59 is an exploded perspective view of FIG. 58 from another angle;

FIG. 60 is a perspective view of the first terminal module mating with the insertion module;

FIG. 61 is a cross-sectional view taken along line N-N in FIG. 3;

FIG. 62 is a cross-sectional view taken along line Q-Q in FIG. 3;

FIG. 63 is a partial enlarged view of framed part R in FIG. 62;

FIG. 64 is a cross-sectional view taken along line O-O in FIG. 1;

FIG. 65 is a partial enlarged view of framed part L in FIG. 64, showing the first connector and the second connector in a mated state;

FIG. 66 is a partial enlarged view of FIG. 65 in a transitional state, showing the first connector and the second connector during separation;

FIG. 67 is a partial enlarged view of FIG. 66 in another transitional state during separation;

FIG. 68 is a partial enlarged view of framed part P in FIG. 67;

FIG. 69 is an exploded perspective view of a portion of the first terminal module in accordance with another embodiment of the present disclosure;

FIG. 70 is an exploded perspective view of FIG. 69 from another angle;

FIG. 71 is a front view of a first shielding sleeve and an elastic piece assembled together in FIG. 69;

FIG. 72 is a perspective view of the first terminal module in accordance with a second embodiment of the present disclosure;

FIG. 73 is a perspective view of FIG. 72 from another angle;

FIG. 74 is an exploded perspective view of FIG. 72;

FIG. 75 is a partial enlarged view of circled part M in FIG. 74;

FIG. 76 is a perspective view of the first terminal module in accordance with a third embodiment of the present disclosure;

FIG. 77 is a perspective view of FIG. 76 from another angle;

FIG. 78 is an exploded perspective view of FIG. 76;

FIG. 79 is an exploded perspective view of FIG. 78 from another angle;

FIG. 80 is a perspective view of the first terminal module in accordance with a fourth embodiment of the present disclosure;

FIG. 81 is an exploded perspective view of FIG. 80;

FIG. 82 is a partial enlarged view of circled part T in FIG. 81;

FIG. 83 is a right view of the first terminal module in FIG. 80, with a first conductive terminal and a second conductive terminal spaced apart from each other;

FIG. 84 is a partial enlarged view of FIG. 75 in accordance with another embodiment of the present disclosure;

FIG. 85 is an exploded perspective view of a first grounding module in FIG. 35 in accordance with another embodiment of the present disclosure;

FIG. 86 is an exploded perspective view of FIG. 85 from another angle;

FIG. 87 is a perspective view of a first shielding portion and a second shielding portion as shown in FIG. 30, in accordance with another embodiment of the present disclosure;

FIG. 88 is a top view of FIG. 87;

FIG. 89 is a perspective view of a first conductive terminal and a second conductive terminal in FIG. 33;

FIG. 90 is a cross-sectional view of a first segment of a first contact portion of the first and second conductive terminals in FIG. 89;

FIG. 91 is a cross-sectional view of a second segment of the first contact portion of the first and second conductive terminals in FIG. 89;

FIG. 92 is a cross-sectional view of a third segment of the first contact portion of the first and second conductive terminals in FIG. 89;

FIG. 93 is a perspective view of a fixture and a portion of the first connector during disassembly;

FIG. 94 is a partially exploded perspective view of FIG. 93;

FIG. 95 is a partially exploded perspective view of the first terminal module in FIG. 33;

FIG. 96 is a further exploded perspective view of FIG. 95;

FIG. 97 is a cross-sectional view taken along line X-X in FIG. 56;

FIG. 98 is a perspective view of a first mating terminal and a second mating terminal as shown in FIG. 56, in accordance with a third embodiment of the present disclosure; and

FIG. 99 is a cross-sectional view taken along line Y-Y in FIG. 98.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

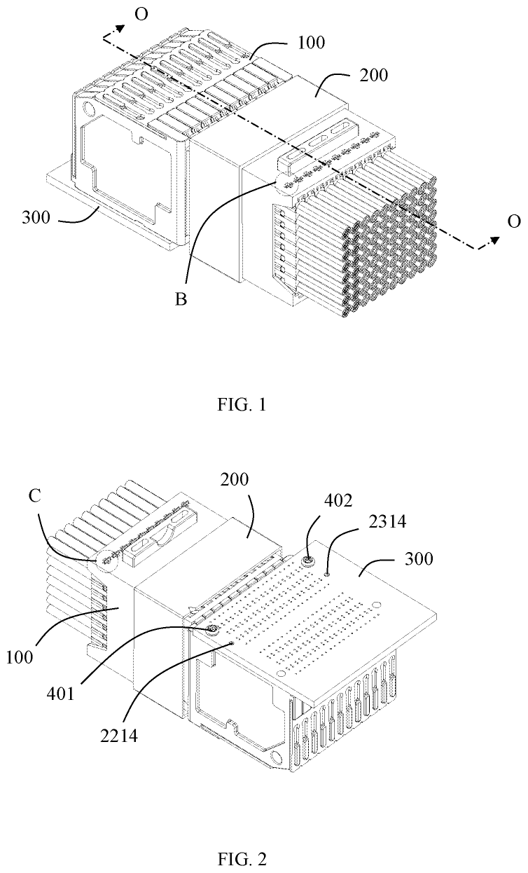

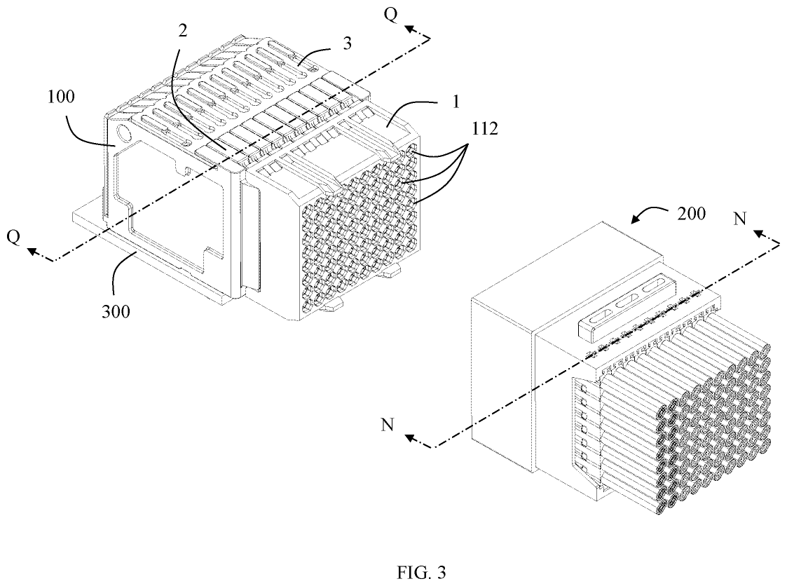

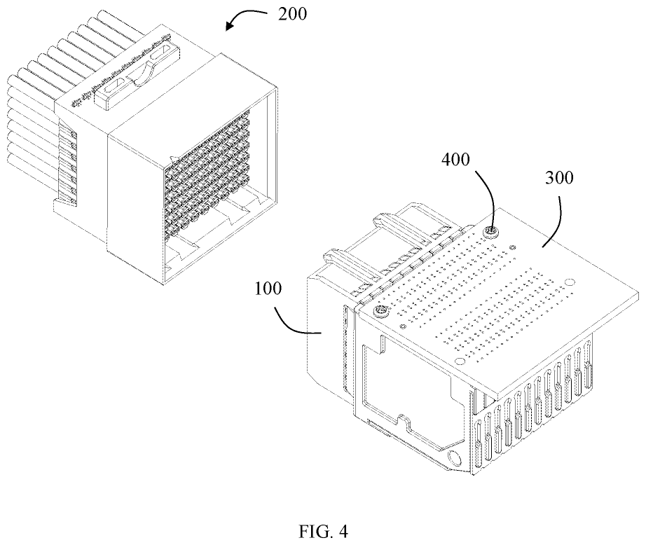

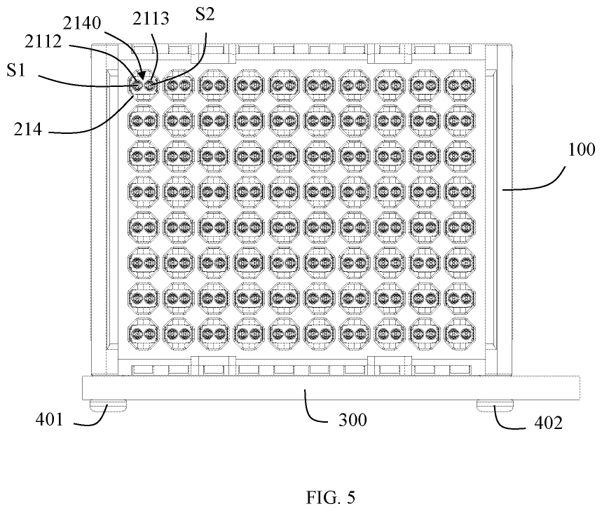

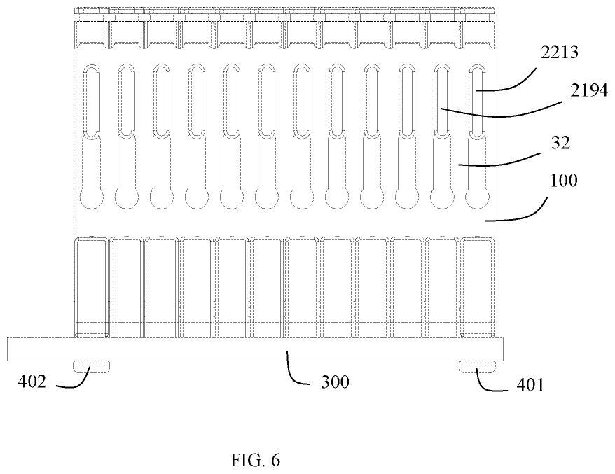

Referring to FIG. 1 to FIG. 99, the present disclosure discloses a connector assembly which includes a first connector 100, a second connector 200, a circuit board 300, and a plurality of fasteners 400. In the illustrated embodiments of the present disclosure, the first connector 100 is a board-end backplane connector which is configured to be mounted to the circuit board 300 and electrically connected to the circuit board 300. In the illustrated embodiments of the present disclosure, the second connector 200 is a cable backplane connector which is configured to mate with the first connector 100. In the illustrated embodiments of the present disclosure, the first connector 100 and the second connector 200 are mated along a first direction A1-A1 (i.e., a mating direction) to realize signal transmission. In the illustrated embodiment of the present disclosure, the mating direction is a front-rear direction. The fasteners 400 are configured to secure the first connector 100 to the circuit board 300 after the first connector 100 is mounted to the circuit board 300. In the illustrated embodiment of the present disclosure, the fasteners 400 include a first screw 401 and a second screw 402.

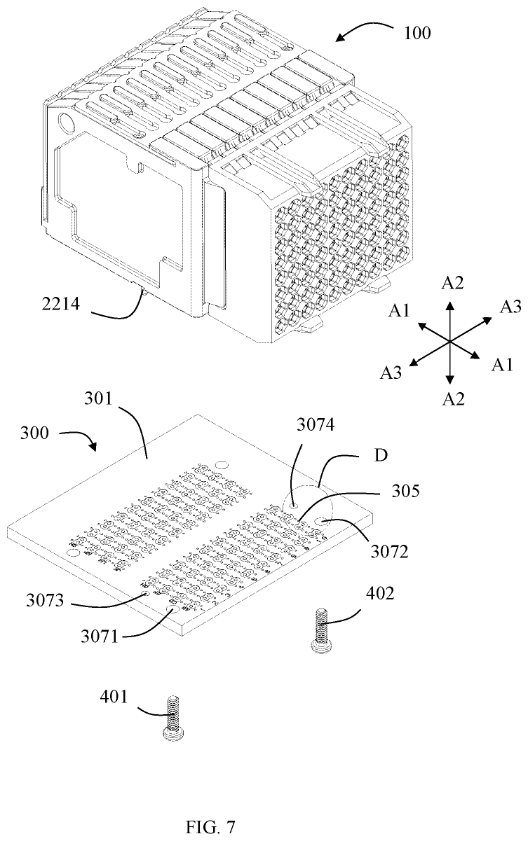

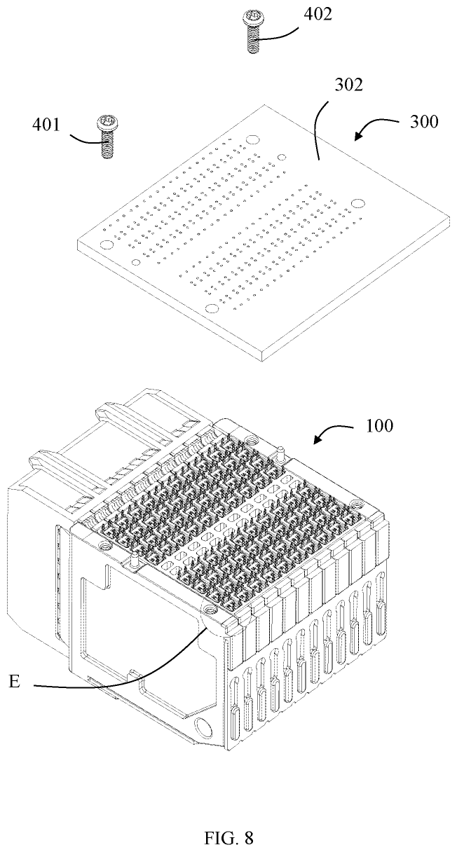

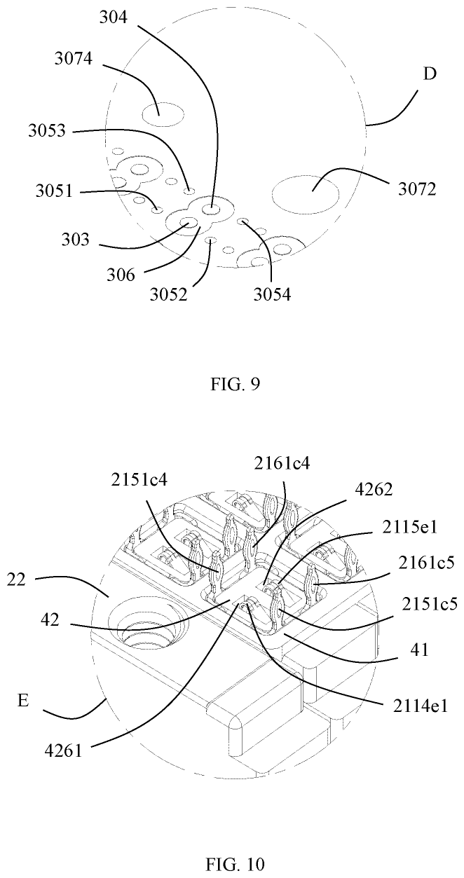

Referring to FIG. 7 to FIG. 9, the circuit board 300 includes a first surface 301 (e.g., an upper surface), a second surface 302 (e.g., a lower surface) disposed opposite to the first surface 301, a plurality of first conductive pads 303 disposed on the first surface 301, a plurality of second conductive pads 304 disposed on the first surface 301, and a plurality of mounting holes 305 extending through the first surface 301 and the second surface 302 along a second direction A2-A2 (e.g., a top-bottom direction). In the illustrated embodiment of the present disclosure, the first conductive pads 303 and the second conductive pads 304 are spaced apart along the first direction A1-A1 and a third direction A3-A3 (e.g., a left-right direction). In the illustrated embodiment of the present disclosure, each two of the first direction A1-A1, the second direction A2-A2 and the third direction A3-A3 are perpendicular to each other. In the illustrated embodiment of the present disclosure, one first conductive pad 303 and one second conductive pad 304 which are disposed adjacent to each other along the third direction A3-A3 form a differential pair conductive pad group to improve the rate of signal transmission. In the illustrated embodiment of the present disclosure, corresponding to each differential pair conductive pad group, the mounting holes 305 include a first mounting hole 3051, a second mounting hole 3052, a third mounting hole 3053 and a fourth mounting hole 3054. The first mounting hole 3051 and the third mounting hole 3053 are located on one side (e.g., a left side) of the differential pair conductive pad group, while the second mounting hole 3052 and the fourth mounting hole 3054 are located on an opposite side (e.g., a right side) of the differential pair conductive pad group. In the illustrated embodiment of the present disclosure, the first mounting hole 3051 and the second mounting hole 3052 are disposed on two sides of the first conductive pad 303 along the first direction A1-A1, and the first mounting hole 3051, the first conductive pad 303 and the second mounting hole 3052 are aligned along the first direction A1-A1. Similarly, the third mounting hole 3053 and the fourth mounting hole 3054 are disposed on two sides of the second conductive pad 304 along the first direction A1-A1, and the third mounting hole 3053, the second conductive pad 304 and the fourth mounting hole 3054 are aligned along the first direction A1-A1. Besides, in the illustrated embodiment of the present disclosure, corresponding to each differential pair conductive pad group, the circuit board 300 defines a surrounding groove 306 formed on the first surface 301, and enclosing the first conductive pad 303 and the second conductive pad 304. In the illustrated embodiment of the present disclosure, the surrounding groove 306 has an approximate “8”-shaped configuration. The first mounting hole 3051 and the third mounting hole 3053 are located on one side (e.g., a left side) of the surrounding groove 306, while the second mounting hole 3052 and the fourth mounting hole 3054 are located on an opposite side (e.g., a right side) of the surrounding groove 306. In the illustrated embodiment of the present disclosure, the circuit board 300 further defines a first mounting through hole 3071, a second mounting through hole 3072, a first positioning through hole 3073, and a second positioning through hole 3074, all extending through the first surface 301 and the second surface 302 along the second direction A2-A2.

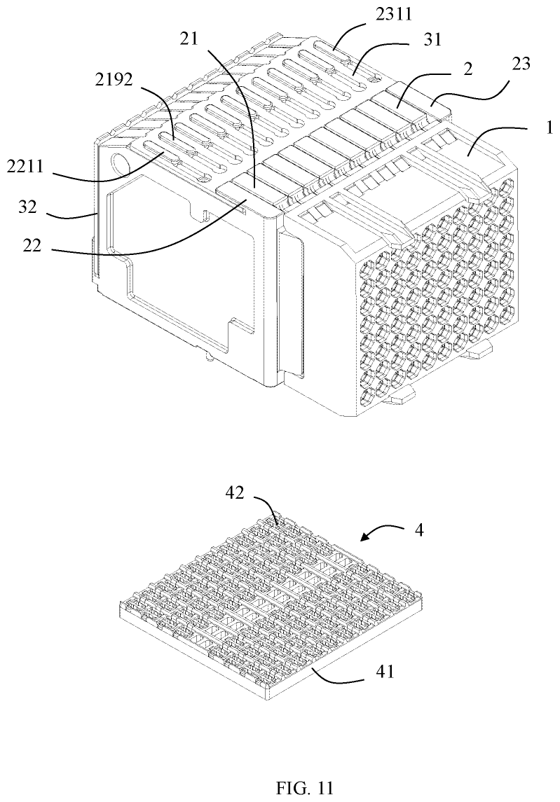

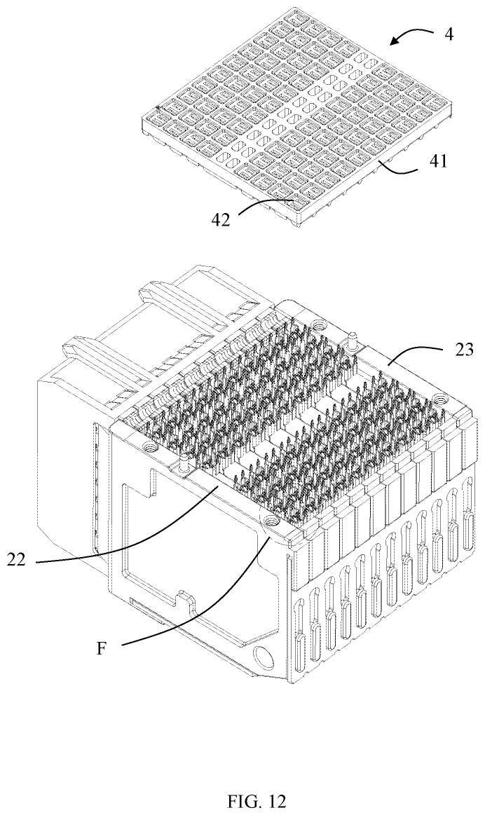

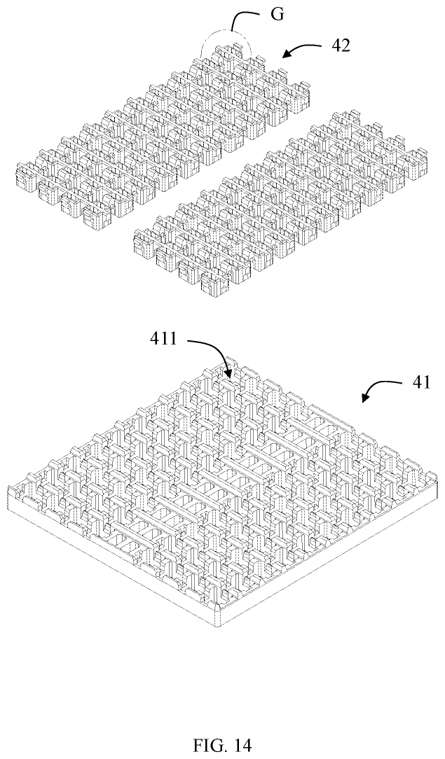

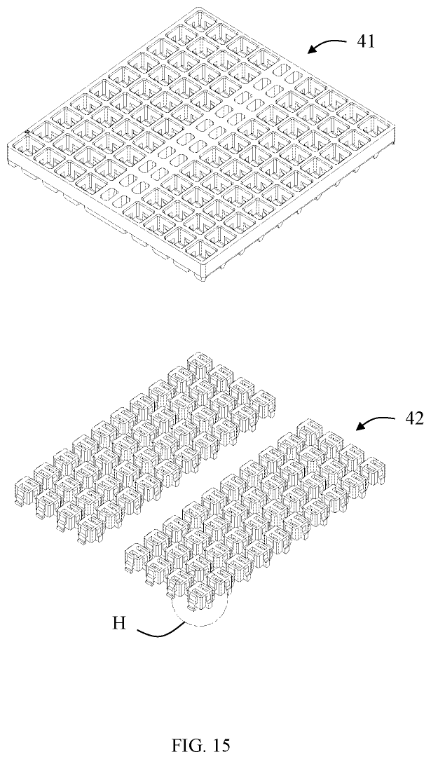

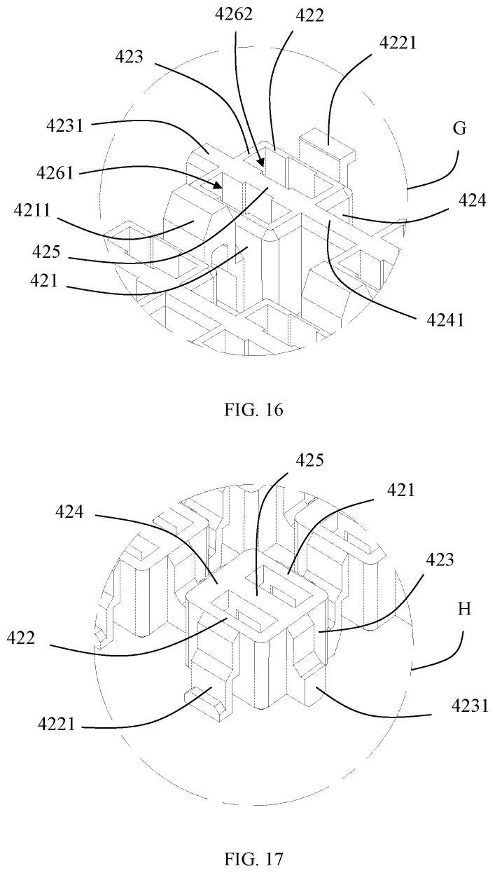

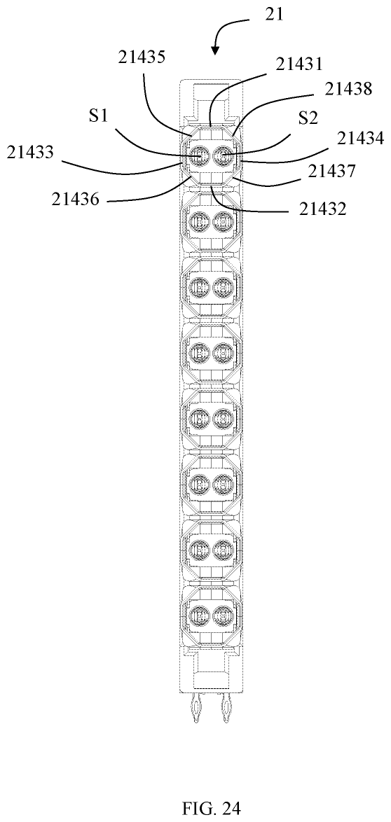

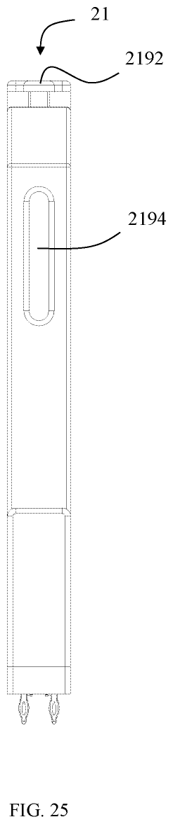

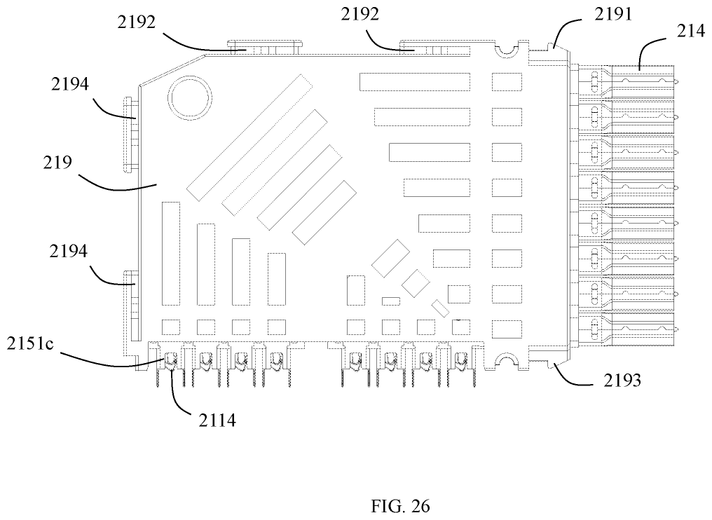

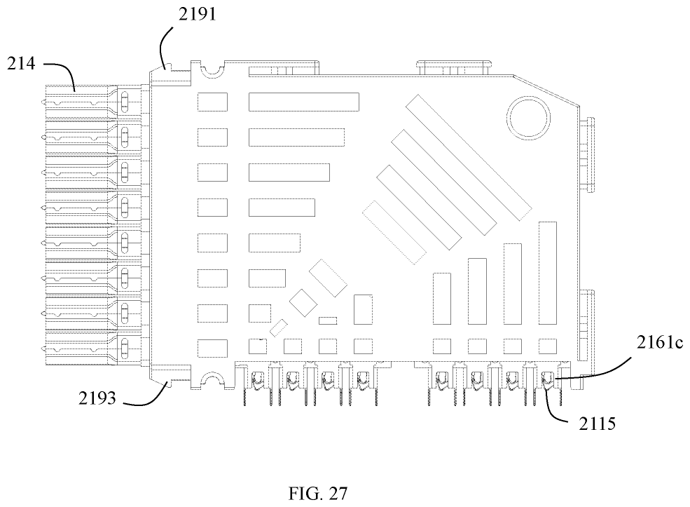

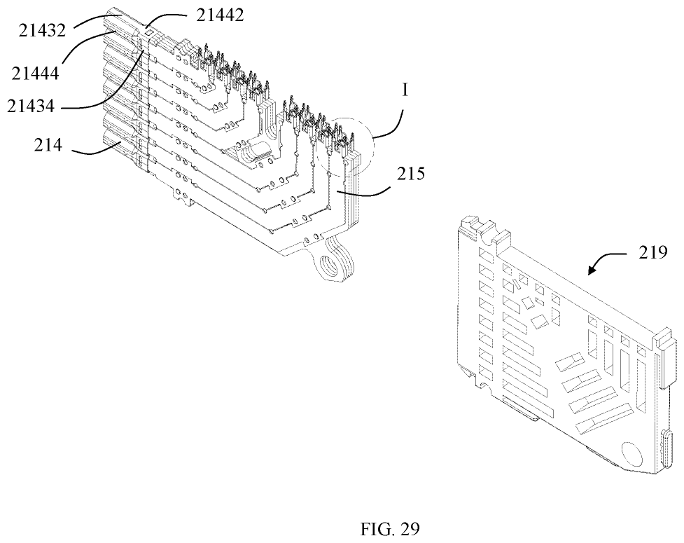

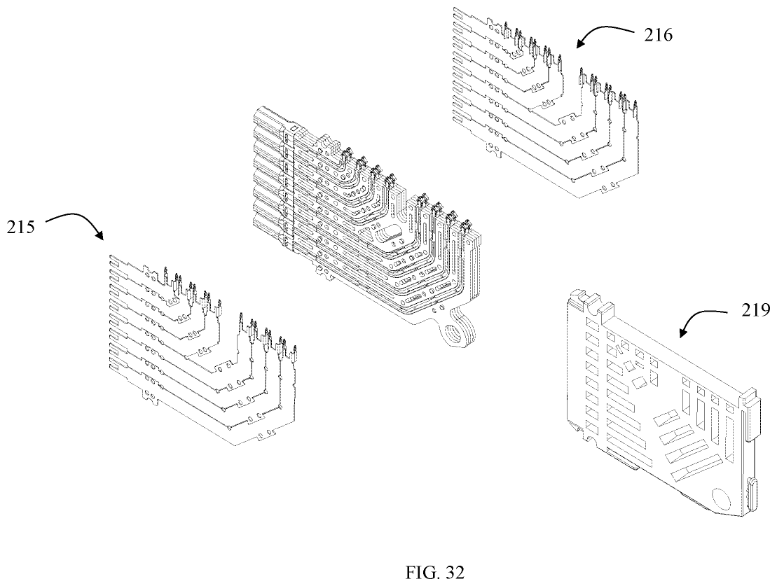

Referring to FIG. 11 to FIG. 37, the first connector 100 includes a first housing 1, an installation module 2 disposed in the first housing 1, at least one retaining plate 3 securing the installation module 2 to the first housing 1, and a mounting block 4 mounted at a bottom of the first housing 1 and mating with the installation module 2.

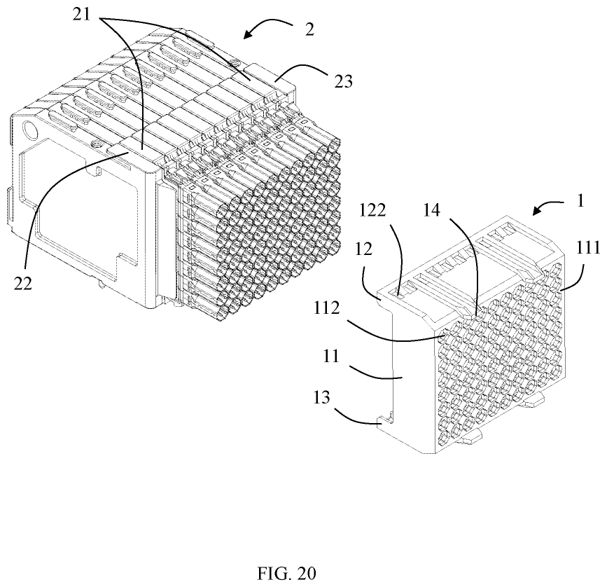

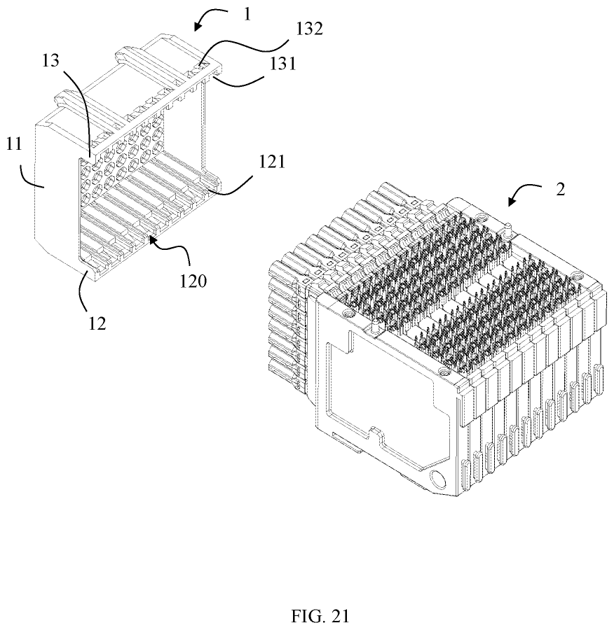

Referring to FIG. 20 and FIG. 21, in one embodiment of the present disclosure, the first housing 1 is an insulating housing which is made of insulating material. The first housing 1 includes a first main body 11, a first wall portion 12 extending backwardly from one end (e.g., an upper end) of the first main body 11, and a second wall portion 13 extending backwardly from an opposite end (e.g., a lower end) of the first main body 11. The first main body 11 includes a mating surface 111 and a plurality of first terminal receiving slots 112 extending through the mating surface 111 along the first direction A1-A1. In the illustrated embodiment of the present disclosure, the first terminal receiving slots 112 are arranged in a matrix. Each first terminal receiving slot 112 is polygonal with six or more sides. In some embodiments of the present disclosure, the polygon is an even-sided polygon with six or more sides. In the illustrated embodiment of the present disclosure, each first terminal receiving slot 112 is a regular octagon.

The first wall portion 12 includes a plurality of first insertion slots 121 and a plurality of first locking slots 122 communicating with the first insertion slots 121. The second wall portion 13 includes a plurality of second insertion slots 131 and a plurality of second locking slots 132 communicating with the second insertion slots 131. The first locking slots 122 extend upwardly through the first wall portion 12 along the second direction A2-A2. The second locking slots 132 extend downwardly through the second wall portion 13 along the second direction A2-A2. The first locking slots 122 and the second locking slots 132 are configured to lock a front end of the installation module 2 in order to prevent the installation module 2 from being disengaged from the first housing 1. One first insertion slot 121 and one second insertion slot 131 which are aligned in a vertical direction together form an installation slot 120 to accommodate corresponding portions of the installation module 2.

The first housing 1 further includes a plurality of positioning protrusions 14 which extend forwardly from the first wall portion 12 and the second wall portion 13 along the first direction A1-A1, and protrude beyond the mating surface 111. The positioning protrusions 14 are configured to guide and position the second connector 200 during mating.

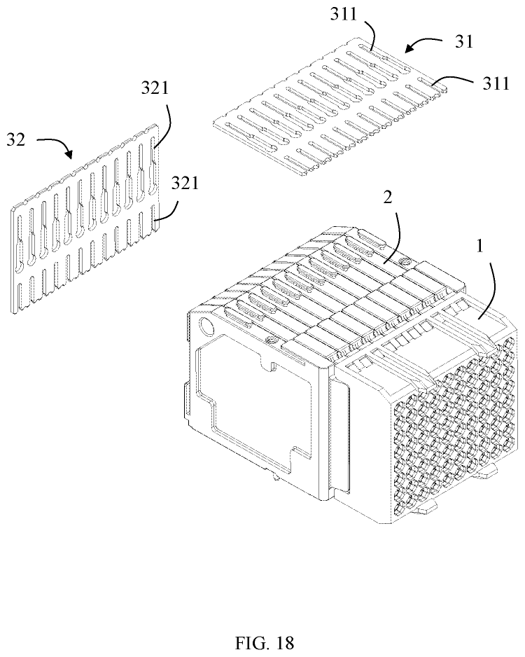

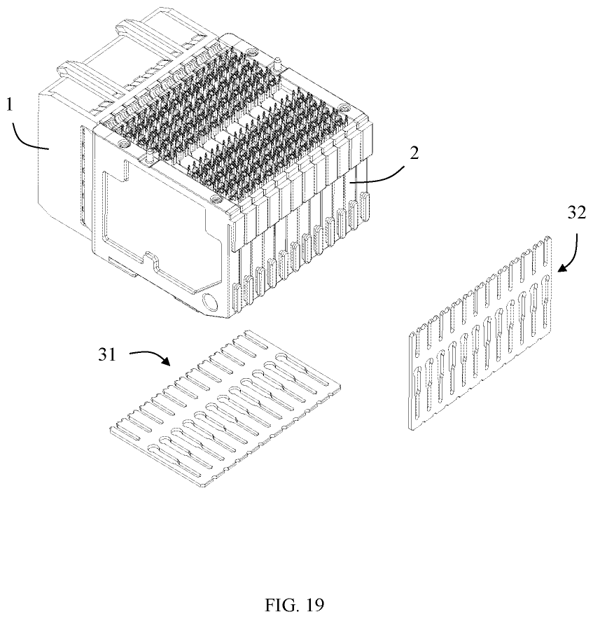

Referring to FIG. 18 and FIG. 19, the retaining plate 3 is made of metal, and includes a first retaining plate 31 and a second retaining plate 32. The first retaining plate 31 defines a plurality of first retaining grooves 311. The second retaining plate 32 defines a plurality of second retaining grooves 321. The first retaining plate 31 and the second retaining plate 32 are perpendicular to each other.

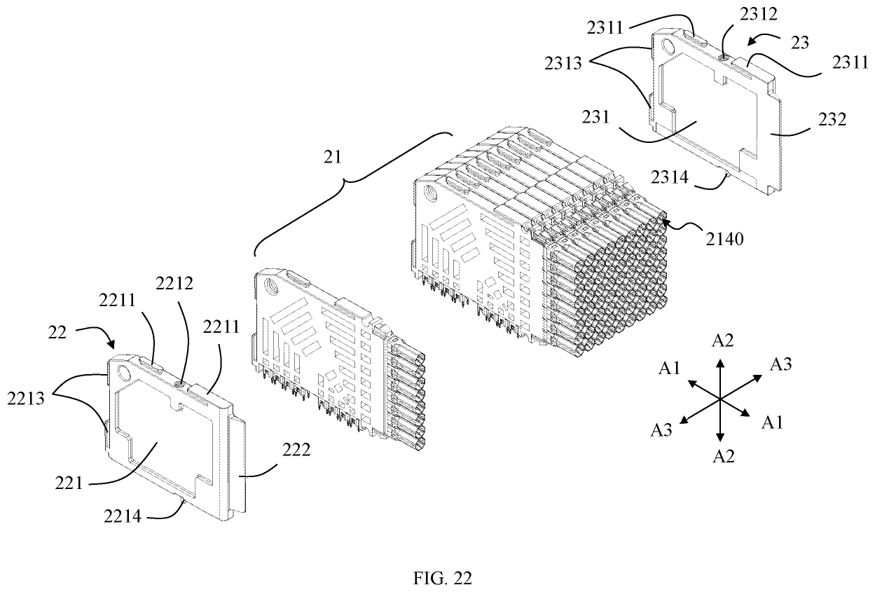

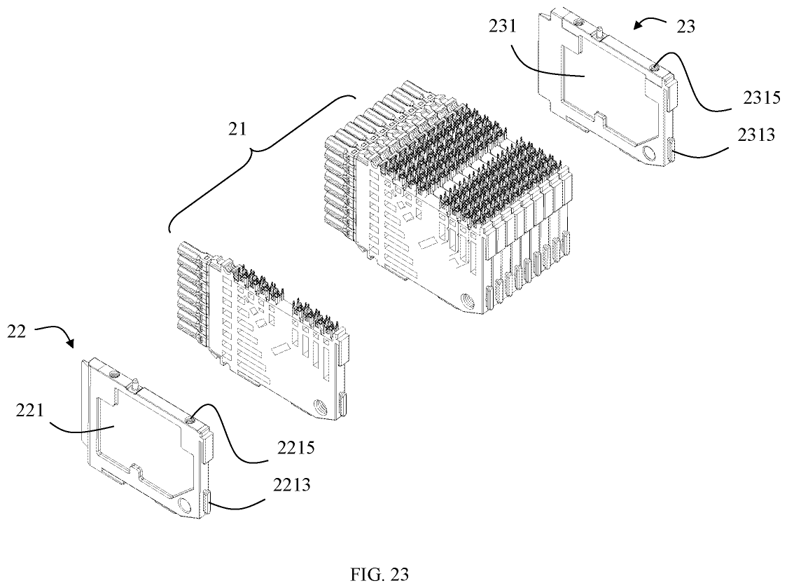

Referring to FIG. 22 and FIG. 23, in the illustrated embodiment of the present disclosure, the installation module 2 includes a plurality of first terminal modules 21, a first mounting plate 22 located on one side of the plurality of first terminal modules 21, and a second mounting plate 23 located on another side of the plurality of first terminal modules 21. In other words, the plurality of first terminal modules 21 are sandwiched between the first mounting plate 22 and the second mounting plate 23 along the third direction A3-A3. In one embodiment of the present disclosure, the first mounting plate 22 and the second mounting plate 23 are both metal mounting plates, i.e., they are made of metal material in order to enhance shielding and structural strength.

In the illustrated embodiment of the present disclosure, all the first terminal modules 21 are identical. The following description will take one of the first terminal modules 21 as an example.

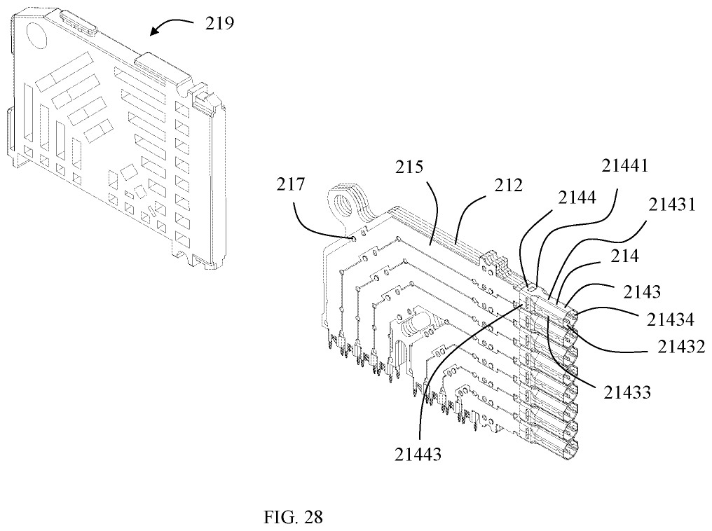

Referring to FIG. 28 to FIG. 35, the first terminal module 21 includes a plurality of first terminal blocks 211, a first grounding module 212 which is located on a first side (e.g., an outer side) of each first terminal block 211, a second grounding module 213 which is located on a second side (e.g., an inner side) of each first terminal block 211, a first shielding sleeve 214 which is sleeved on one end of the first grounding module 212 and the second grounding module 213, a first shielding plate 215 which is located on one side of the first terminal blocks 211, the first grounding module 212 and the second grounding module 213, a second shielding plate 216 which is located on another side of the first terminal blocks 211, the first grounding module 212 and the second grounding module 213, and a first insulating plate 219 which is fixed to the first terminal blocks 211, the first grounding module 212, the second grounding module 213, the first shielding plate 215 and the second shielding plate 216. The first shielding plate 215 is located on a third side (e.g., a left side) of the first terminal blocks 211, and the second shielding plate 216 is located on a fourth side (e.g., a right side) of the first terminal blocks 211.

In one embodiment of the present disclosure, the first insulating plate 219 is molded and fixed on the first terminal blocks 211, the first grounding module 212, the second grounding module 213, the first shielding plate 215 and the second shielding plate 216. The first insulating plate 219 includes a first locking protrusion 2191 disposed at a top of the first insulating plate 219, a first retaining rib 2192 disposed at the top of the first insulating plate 219 and located at a rear of the first locking protrusion 2191, a second locking protrusion 2193 disposed at a bottom of the first insulating plate 219, and a second retaining rib 2194 located at a rear side of the first insulating plate 219. The first insulating plate 219 is configured to be inserted into a corresponding installation slot 120. The first locking protrusion 2191 and the second locking protrusion 2193 are locked in the first locking groove 122 and the second locking groove 132, respectively. A portion of the first retaining groove 311 of the first retaining plate 31 engages with the first retaining rib 2192, and a portion of the second retaining groove 321 of the second retaining plate 32 engages with the second retaining rib 2194.

Each first terminal block 211 includes a first conductive terminal S1, a second conductive terminal S2, a first insulating isolation block 2117 at least partially fixed on the first conductive terminal S1, a second insulating isolation block 2118 at least partially fixed on the second conductive terminal S2, a first shielding tube 2112 sleeved over the first insulating isolation block 2117 and surrounding the first conductive terminal S1, a second shielding tube 2113 sleeved over the second insulating isolation block 2118 and surrounding the second conductive terminal S2, and a conductive metal block 2111 sleeved on the first shielding tube 2112 and the second shielding tube 2113.

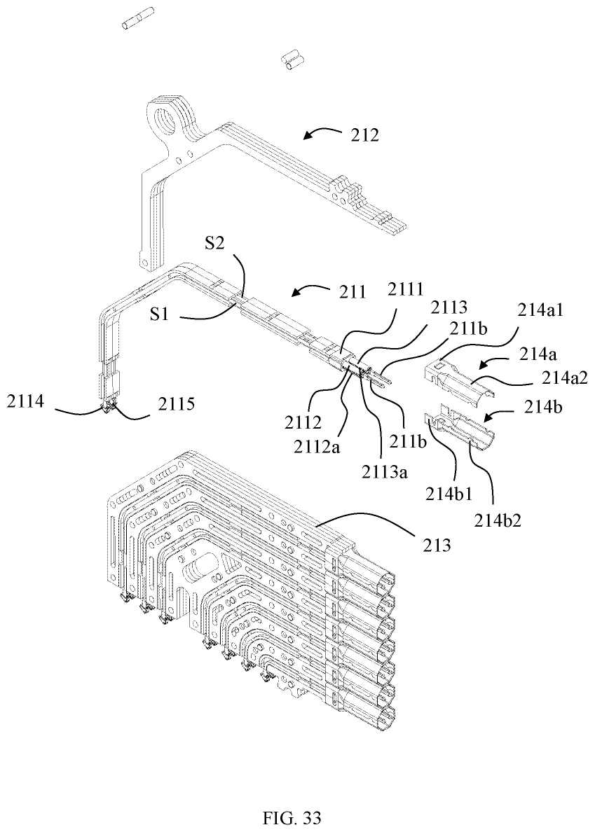

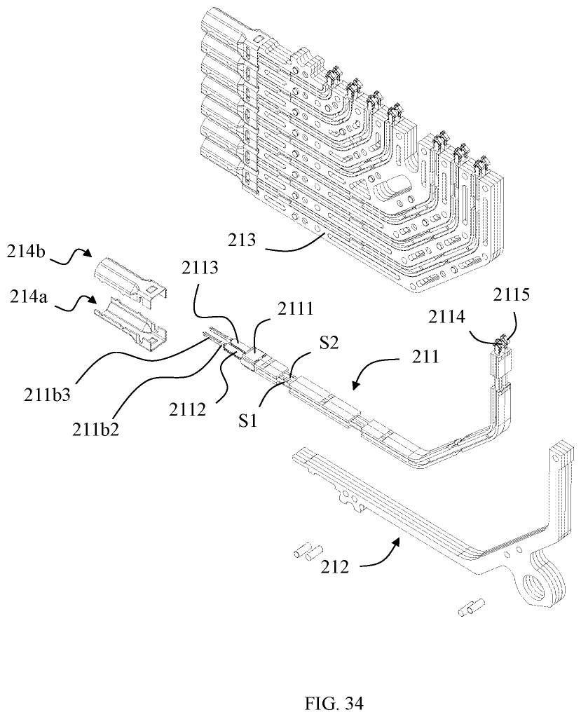

In the illustrated embodiment of the present disclosure, the first shielding tube 2112 includes a first sleeve portion 21121 which is of a generally cylindrical configuration, and a first flanged portion 21122 which extends outward from a rear end of the first sleeve portion 21121. The first sleeve portion 21121 defines two first slots 2112a on two sides thereof. Referring to FIG. 33 and FIG. 34, the first slots 2112a extend through a first end surface 21123 of the first shielding tube 2112 along the first direction A1-A1, so that the first shielding tube 2112 has a certain degree of elastic deformation. The first conductive terminal S1 partially protrudes beyond the first shielding tube 2112. Similarly, the second shielding tube 2113 includes a second sleeve portion 21131 which is of a generally cylindrical configuration, and a second flanged portion 21132 which extends outward from a rear end of the second sleeve portion 21131. The second sleeve portion 21131 defines two second slots 2113a on two sides thereof. Referring to FIG. 33 and FIG. 34, the second slots 2113a extend through a second end surface 21133 of the second shielding tube 2113 along the first direction A1-A1, so that the second shielding tube 2113 has a certain degree of elastic deformation. The second conductive terminal S2 partially protrudes beyond the second shielding tube 2113. In the illustrated embodiment of the present disclosure, the first shielding tube 2112 and the second shielding tube 2113 are made of metal material.

In one embodiment of the present disclosure, the conductive metal block 2111 is sleeved on the first shielding tube 2112 and the second shielding tube 2113 to form the first terminal block 211 as a whole. The first flanged portion 21122 and the second flanged portion 21132 are both in contact with the conductive metal block 2111.

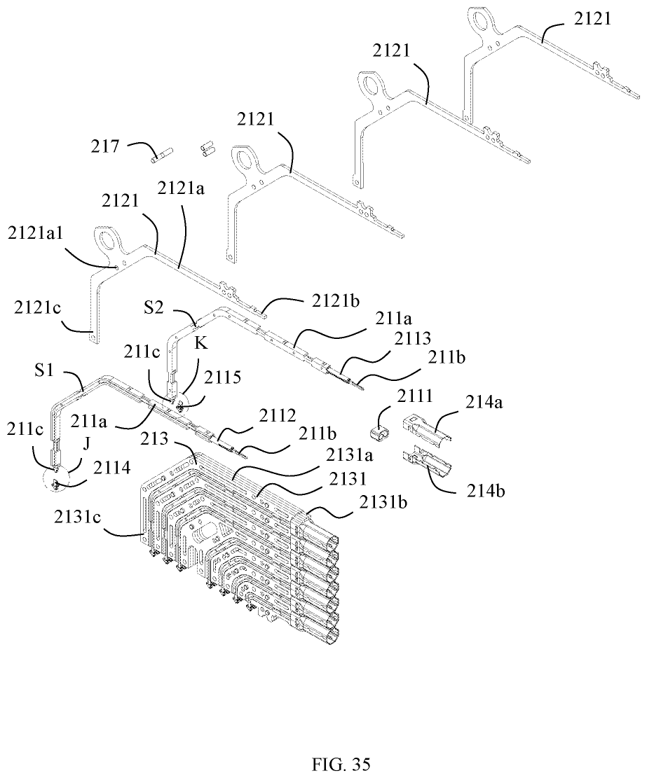

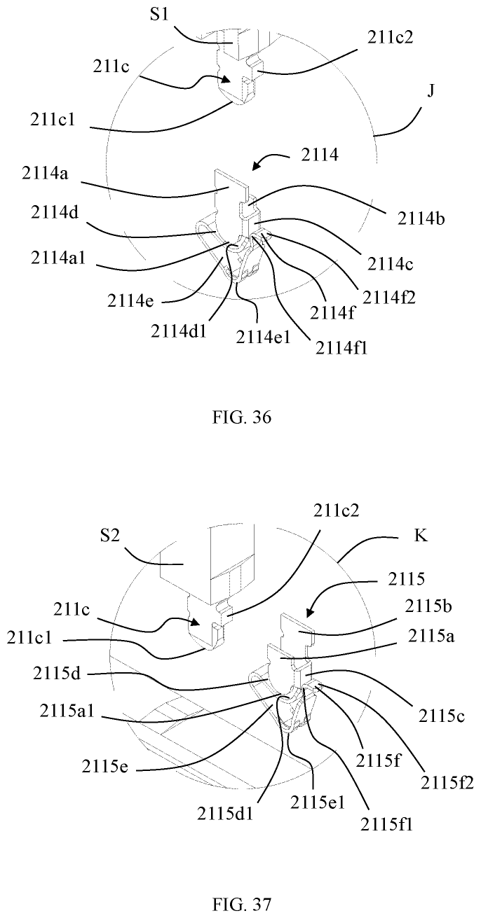

Referring to FIG. 35, each conductive terminal of the first terminal block 211 includes a first retaining portion 211a, a first contact portion 211b connected to one end of the first retaining portion 211a, and a first tail portion 211c connected to another end of the first retaining portion 211a. In the illustrated embodiment of the present disclosure, the first retaining portion 211a is of a curved configuration. The first contact portion 211b is needle-shaped and perpendicular to the first tail portion 211c. The first shielding tube 2112 is sleeved over a part of the first contact portion 211b of the first conductive terminal S1. The second shielding tube 2113 is sleeved over a part of the first contact portion 211b of the second conductive terminal S2. Another part of the first contact portion 211b of the first conductive terminal S1 protrudes beyond the first shielding tube 2112. Another part of the first contact portion 211b of the second conductive terminal S2 protrudes beyond the second shielding tube 2113. Referring to FIG. 36, in the illustrated embodiment of the present disclosure, the first tail portion 211c is contracted compared to the first retaining portion 211a. The first tail portion 211c includes a first arcuate portion 211c1 at a bottom thereof, and a first limiting protrusion 211c2 protruding along the first direction A1-A1.

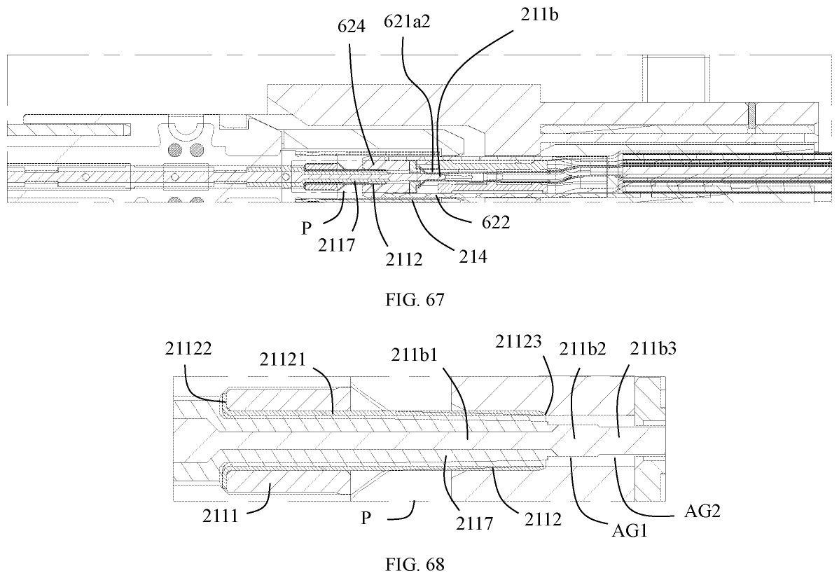

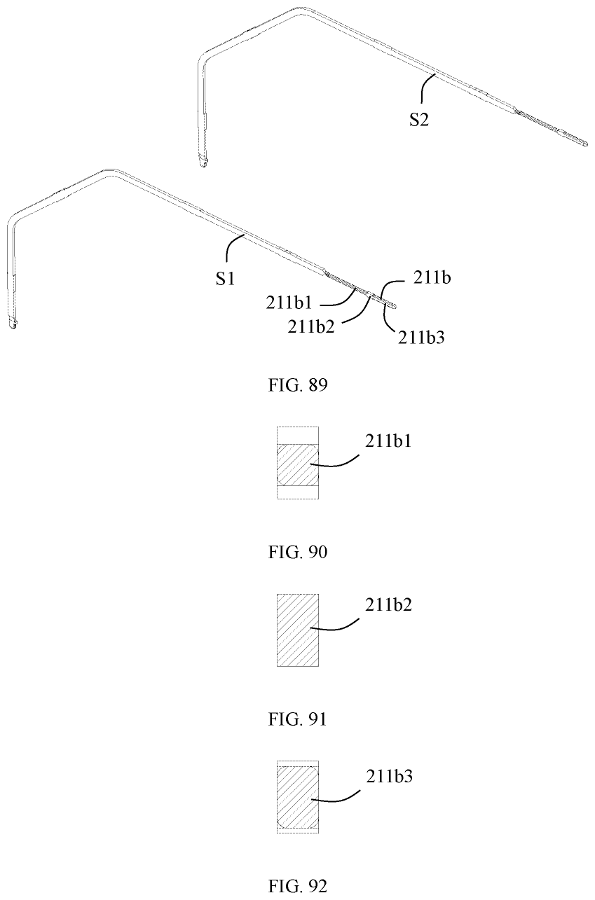

Referring to FIG. 67, FIG. 68, and FIG. 89 to FIG. 92, in the illustrated embodiment of the present disclosure, the first contact portion 211b of the first conductive terminal S1 includes a first segment 211b1 covered by the first shielding tube 2112, a second segment 211b2 connected to the first segment 211b1 and protruding beyond the first shielding tube 2112, and a third segment 211b3 connected to the second segment 211b2. The second segment 211b2 is connected between the first segment 211b1 and the third segment 211b3. The first segment 211b1, the second segment 211b2 and the third segment 211b3 are sequentially arranged along the first direction A1-A1. The third segment 211b3 is configured to electrically mate with the second connector 200. Referring to FIG. 90 to FIG. 92, in the illustrated embodiment of the present disclosure, each first terminal block 211 further includes a first insulating isolation block 2117 fixed on the first segment 211b1 of the first conductive terminal S1 and covered by the first shielding tube 2112, and a second insulating isolation block 2118 fixed on the first segment 211b1 of the second conductive terminal S2 and covered by the second shielding tube 2113. The first insulating isolation block 2117 prevents electrical contact between the first shielding tube 2112 and the first segment 211b1 of the first conductive terminal S1, thereby avoiding short circuits. Similarly, the second insulating isolation block 2118 prevents electrical contact between the second shielding tube 2113 and the first segment 211b1 of the second conductive terminal S2, thereby avoiding short circuits. Besides, the first insulating isolation block 2117 wraps around the first segment 211b1 of the first conductive terminal S1 to adjust the impedance of the first segment 211b1 of the first conductive terminal S1. Similarly, the second insulating isolation block 2118 wraps around the first segment 211b1 of the second conductive terminal S2 to adjust the impedance of the first segment 211b1 of the second conductive terminal S2. In the illustrated embodiment of the present disclosure, a cross-sectional area of the first segment 211b1, a cross-sectional area of the second segment 211b2 and a cross-sectional area of the third segment 211b3 along the second direction A2-A2 are different so as to facilitate impedance control. Specifically, in the illustrated embodiment of the present disclosure, the cross-sectional area of the second segment 211b2 along the second direction A2-A2 is greater than the cross-sectional area of the third segment 211b3 along the second direction A2-A2, and the cross-sectional area of the third segment 211b3 along the second direction A2-A2 is greater than the cross-sectional area of the first segment 211b1 along the second direction A2-A2. This design facilitates the avoidance of impedance abruption on the length of the first contact portion 211b of the first conductive terminal S1 when the first connector 100 and the second connector 200 are disengaged from each other (described in detail hereinafter).

The first contact portion 211b of the second conductive terminal S2 is identical to the first contact portion 211b of the first conductive terminal S1, which will not be repeated here.

In the illustrated embodiment of the present disclosure, the first conductive terminal S1 and the second conductive terminal S2 in each first terminal block 211 form a pair of differential signal terminals in order to improve the rate of signal transmission. The first conductive terminal S1 and the second conductive terminal S2 are arranged side by side along the third direction A3-A3.

Referring to FIG. 35, in the illustrated embodiment of the present disclosure, the first grounding module 212 includes a plurality of first grounding sheets 2121 stacked along the third direction A3-A3. It is understandable to those skilled in the art that in the illustrated embodiment of the present disclosure, the plurality of first grounding sheets 2121 arranged in a stacked manner means that the plurality of first grounding sheets 2121 are disposed adjacent to one another along the third direction A3-A3. That is, the plurality of first grounding sheets 2121 are stacked left and right. Each first grounding sheet 2121 includes a first intermediate portion 2121a, a first engagement portion 2121b connected to one end of the first intermediate portion 2121a, and a first abutting portion 2121c connected to another end of the first intermediate portion 2121a. In the illustrated embodiment of the present disclosure, the first intermediate portion 2121a is of a curved configuration. The first engagement portion 2121b is perpendicular to the first abutting portion 2121c. The first intermediate portion 2121a defines at least one first perforation 2121a1 extending through the first intermediate portion 2121a along the third direction A3-A3. In the illustrated embodiment of the present disclosure, all the first grounding sheets 2121 are identical in order to reduce costs.

Similarly, the second grounding module 213 includes a plurality of second grounding sheets 2131 stacked along the third direction A3-A3. Each second grounding sheet 2131 includes a second intermediate portion 2131a, a second engagement portion 2131b connected to one end of the second intermediate portion 2131a, and a second abutting portion 2131c connected to another end of the second intermediate portion 2131a. The second intermediate portion 2131a is of a curved configuration. The second engagement portion 2131b is perpendicular to the second abutting portion 2131c. All the second grounding sheets 2131 are identical in order to reduce costs. After assembly, the conductive metal block 2111 is located between the first engagement portion 2121b and the second engagement portion 2131b, and is in contact with at least one of the first engagement portion 2121b and the second engagement portion 2131b so as to improve the ground shielding effect. In one embodiment of the present disclosure, the conductive metal block 2111 is sandwiched between the first engagement portion 2121b and the second engagement portion 2131b, and is in contact with the first engagement portion 2121b and the second engagement portion 2131b.

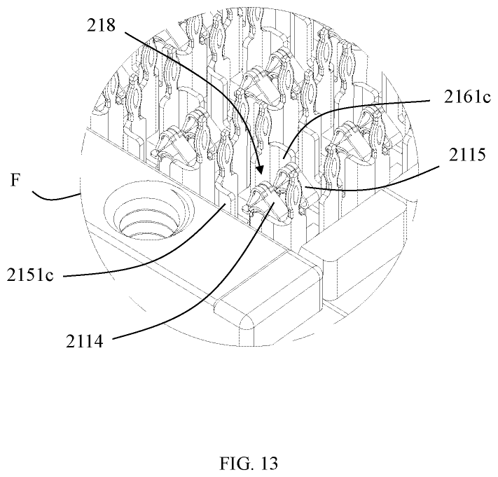

Referring to FIG. 13 and FIG. 30 to FIG. 32, in the illustrated embodiment of the present disclosure, the first shielding plate 215 includes a plurality of first shielding sheets 2151. The plurality of first shielding sheets 2151 are provided separately. Each first shielding sheet 2151 is located on one side of the first terminal block 211 along the third direction A3-A3. The first shielding sheet 2151 is provided with a first curved portion 2151a, a first extension portion 2151b connected to one end of the first curved portion 2151a, and a first shielding portion 2151c connected to another end of the first curved portion 2151a. In the illustrated embodiment of the present disclosure, the first shielding portion 2151c includes a first side wall 2151c1, a first bent wall 2151c2 bent from one end of the first side wall 2151c1, a second bent wall 2151c3 bent from another end of the first side wall 2151c1, a first mounting leg 2151c4 integrally extending downwardly from the first bent wall 2151c2, and a second mounting leg 2151c5 integrally extending downwardly from the second bent wall 2151c3. The first side wall 2151c1 defines a first opening 2151c6 extending downwardly through the first side wall 2151c1. The first shielding sheet 2151 shields one side of the first conductive terminal S1 and the second conductive terminal S2 along the third direction A3-A3, and is in contact with the first grounding module 212 and the second grounding module 213. Specifically, in the illustrated embodiment of the present disclosure, the first curved portion 2151a of the first shielding sheet 2151 defines at least one second perforation 2151a1 extending through the first curved portion 2151a along the third direction A3-A3. In the illustrated embodiment of the present disclosure, the first shielding portion 2151c is in contact with the first abutting portion 2121c. It is understandable to those skilled in the art that, in the illustrated embodiment of the present disclosure, since the first shielding portion 2151c of each first shielding sheet 2151 includes the first side wall 2151c1, the first bent wall 2151c2, the second bent wall 2151c3, the first mounting leg 2151c4, and the second mounting leg 2151c5, the first shielding plate 215 of a single-piece configuration is not able to meet manufacturing feasibility. Therefore, the first shielding plate 215 of the present disclosure includes the plurality of first shielding sheets 2151. This arrangement allows the first shielding portion 2151c of each first shielding sheet 2151 to be designed and manufactured using the material of the first shielding sheet 2151 itself, avoiding interference from other first shielding sheets 2151. In the illustrated embodiment of the present disclosure, the first curved portions 2151a and first extension portions 2151b of all first shielding sheets 2151 are located in a same plane. The first curved portions 2151a of all first shielding sheets 2151 are stacked in this plane, and the first extension portions 2151b of all first shielding sheets 2151 are also stacked in this plane. In the illustrated embodiment of the present disclosure, each adjacent first shielding sheets 2151 are provided with mutually fitting first dovetail groove 2151a2 and first dovetail protrusion 2151a3 on their first curved portions 2151a to combine the first shielding sheets 2151 as a whole.

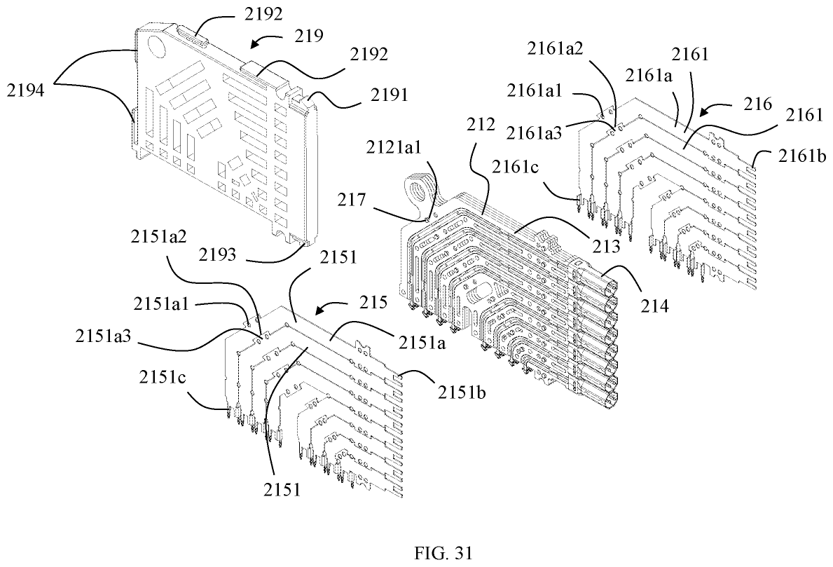

Referring to FIG. 31, in the illustrated embodiment of the present disclosure, the second shielding plate 216 includes a plurality of second shielding sheets 2161. The plurality of second shielding sheets 2161 are provided separately. Each second shielding sheet 2161 is located on another side of the first terminal block 211 along the third direction A3-A3. The second shielding sheet 2161 is provided with a second curved portion 2161a, a second extension portion 2161b connected to one end of the second curved portion 2161a, and a second shielding portion 2161c connected to another end of the second curved portion 2161a. In the illustrated embodiment of the present disclosure, the second shielding portion 2161c includes a second side wall 2161c1, a third bent wall 2161c2 bent from one end of the second side wall 2161c1, a fourth bent wall 2161c3 bent from another end of the second side wall 2161c1, a third mounting leg 2161c4 integrally extending downwardly from the third bent wall 2161c2, and a fourth mounting leg 2161c5 integrally extending downwardly from the fourth bent wall 2161c3. The second side wall 2161c1 is provided with a second opening 2161c6 extending downwardly through the second side wall 2161c1. The second shielding sheet 2161 shields another side of the first conductive terminal S1 and the second conductive terminal S2 along the third direction A3-A3, and is in contact with the first grounding module 212 and the second grounding module 213. Specifically, in the illustrated embodiment of the present disclosure, the second curved portion 2161a of the second shielding sheet 2161 defines at least one third perforation 2161a1 extending through the second curved portion 2161a along the third direction A3-A3. In the illustrated embodiment of the present disclosure, the second shielding portion 2161c is in contact with the first abutting portion 2121c. It is understandable to those skilled in the art that, in the illustrated embodiment of the present disclosure, since the second shielding portion 2161c of each second shielding sheet 2161 includes the second side wall 2161c1, the third bent wall 2161c2, the fourth bent wall 2161c3, the third mounting leg 2161c4 and the fourth mounting leg 2161c5, the second shielding plate 216 of a single-piece configuration is not able to meet manufacturing feasibility. Therefore, the second shielding plate 216 of the present disclosure includes the plurality of second shielding sheets 2161. This arrangement allows the second shielding portion 2161c of each second shielding sheet 2161 to be designed and manufactured using the material of the second shielding sheet 2161 itself, avoiding interference from other second shielding sheets 2161. In the illustrated embodiment of the present disclosure, the second curved portions 2161a and second extension portions 2161b of all second shielding sheets 2161 are located in a same plane. The second curved portions 2161a of all second shielding sheets 2161 are stacked in this plane, and the second extension portions 2161b of all second shielding sheets 2161 are also stacked in this plane. In the illustrated embodiment of the present disclosure, each two adjacent second shielding sheets 2161 are provided with mutually fitting second dovetail groove 2161a2 and second dovetail protrusion 2161a3 on their second curved portions 2161a to combine the second shielding sheets 2161 as a whole.

Referring to FIG. 31 and FIG. 35, in the illustrated embodiment of the present disclosure, the second perforation 2151a1, the first perforation 2121a1, and the third perforation 2161a1 are aligned and in communication along the third direction A3-A3. The first terminal module 21 includes a first connecting component 217 filled in the second perforation 2151a1, the first perforation 2121a1, and the third perforation 2161a1 to combine the first shielding sheet 2151, the first grounding sheet 2121 and the second shielding sheet 2161 together.

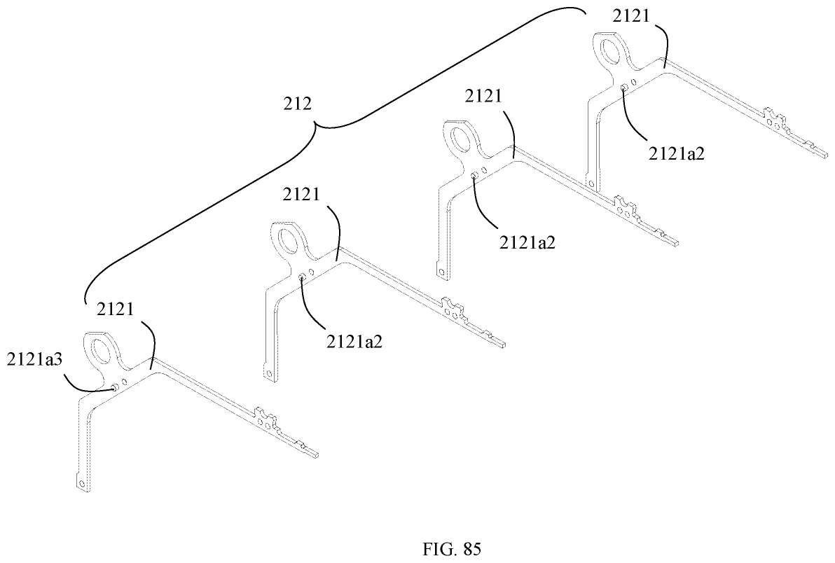

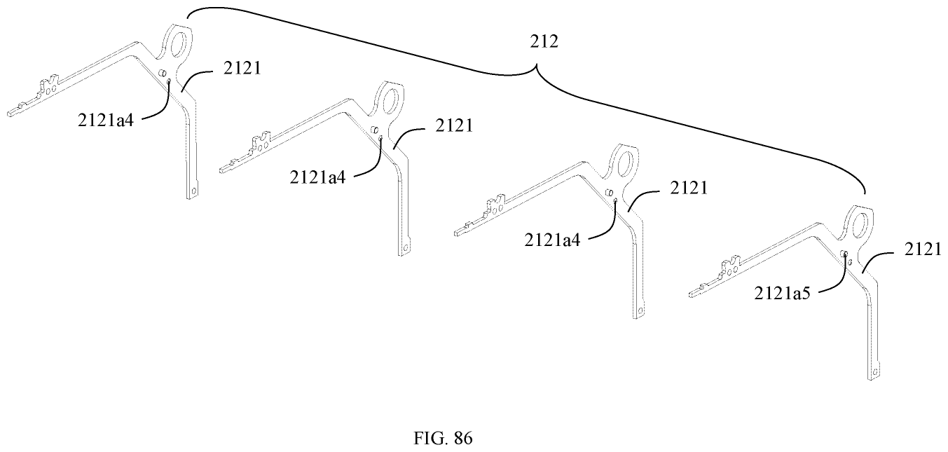

Referring to FIG. 85 and FIG. 86, in another embodiment of the first grounding module 212, adjacent first grounding sheets 2121 are provided with mutually fitting first mounting post 2121a2 and mounting groove 2121a4 to connect all first grounding sheets 2121 as a whole. The mounting groove 2121a4 is located on a backside of the first mounting post 2121a2, allowing all first grounding sheets 2121 to have identical structures for cost reduction. Besides, the first grounding sheet 2121 disposed adjacent to the first shielding plate 215 is provided with a second mounting post 2121a3 matching the second perforation 2151a1, and the first grounding sheet 2121 disposed adjacent to the second shielding plate 216 is provided with a third mounting post 2121a5 matching the third perforation 2161a1. This configuration allows the first shielding sheet 2151, the first grounding sheet 2121 and the second shielding sheet 2161 to be assembled together as a whole.

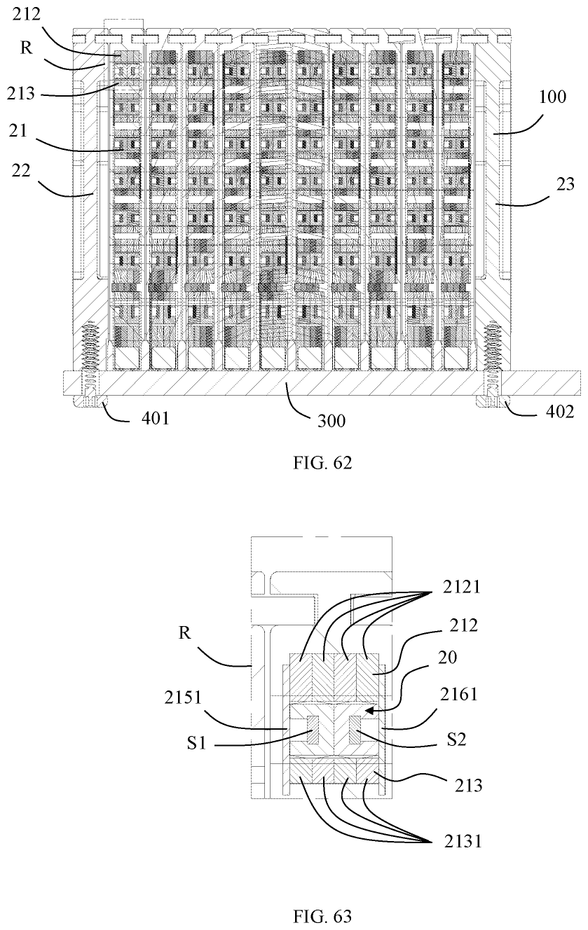

Referring to FIG. 62 and FIG. 63, in the illustrated embodiment of the present disclosure, the first shielding sheet 2151, the plurality of first grounding sheets 2121 of the first grounding module 212, the plurality of second grounding sheets 2131 of the second grounding module 213, and the second shielding sheet 2161 jointly form a shielding cavity 20 surrounding the first terminal block 211 to improve shielding effectiveness. Specifically, the shielding cavity 20 surrounds the first retaining portion 211a of the first conductive terminal S1 and the first retaining portion 211a of the second conductive terminal S2 along their length directions, thereby improving shielding effectiveness and enhancing signal transmission quality. In the illustrated embodiment of the present disclosure, by providing the plurality of first grounding sheets 2121 and the plurality of second grounding sheets 2131, the present disclosure can form the shielding cavity 20 using a thickness of the plurality of first grounding sheets 2121 which are stacked, and a thickness of the plurality of second grounding sheets 2131 which are stacked, respectively, which facilitates the adjustment of the shielding cavity 20 by adjusting the number and thickness of the first grounding sheets 2121 and the second grounding sheets 2131.

Referring to FIG. 33 to FIG. 37, the first terminal block 211 further includes a first elastic abutting leg 2114 and a second elastic abutting leg 2115. The first elastic abutting leg 2114 and the second elastic abutting leg 2115 are made of metal. The first elastic abutting leg 2114 is either integrally formed or provided separately with the first conductive terminal S1. The second elastic abutting leg 2115 is either integrally formed or provided separately with the second conductive terminal S2. In the illustrated embodiment of the present disclosure, the first elastic abutting leg 2114 and first conductive terminal S1 are separate components, but connected together. The second elastic abutting leg 2115 and second conductive terminal S2 are also separate components, but connected together.

In the illustrated embodiment of the present disclosure, the first tail portion 211c of the first conductive terminal S1 and the second conductive terminal S2 extend downwardly beyond the first grounding module 212 and the second grounding module 213, respectively. In other words, the first tail portion 211c of the first conductive terminal S1 and the second conductive terminal S2 protrude beyond the shielding cavity 20.

Specifically, in the illustrated embodiment of the present disclosure, the first elastic abutting leg 2114 includes a first mounting plate 2114a, a second mounting plate 2114b disposed opposite to the first mounting plate 2114a, a first connecting portion 2114c connecting one side of the first mounting plate 2114a and one side of the second mounting plate 2114b, a second connecting portion 2114d connected to the first connecting portion 2114c, a first abutting arm 2114e connected to the second connecting portion 2114d, and a first distal end portion 2114f connected to and located at a free end of the first abutting arm 2114e. Specifically, the first distal end portion 2114f includes a first connecting section 2114f1 connected to the first abutting arm 2114e and a first tail 2114f2 bent outward from the first connecting section 2114f1. In the illustrated embodiment of the present disclosure, the first distal end portion 2114f extends adjacent to the first connecting portion 2114c. When the first elastic abutting leg 2114 is installed on the circuit board 300, the first connecting section 2114f1 comes into contact with the first connecting portion 2114c to enhance performance. In the illustrated embodiment of the present disclosure, along the second direction A2-A2, the first mounting plate 2114a protrudes upwardly with respect to the second mounting plate 2114b. The first mounting plate 2114a and the second mounting plate 2114b are spaced apart along the third direction A3-A3, forming a first receiving slot 2114g between the first mounting plate 2114a and the second mounting plate 2114b. The first connecting portion 2114c is located at one end of the first receiving slot 2114g. The first mounting plate 2114a has a first arcuate surface 2114a1 at a bottom thereof. The second mounting plate 2114b has a second arcuate surface at a bottom thereof. The second arcuate surface is the same as the first arcuate surface 2114a1. The second connecting portion 2114d defines a first recessed groove 2114d1 into which the first arcuate surface 2114a1 and the second arcuate surface partially extend. The first arcuate surface 2114a1 and the second arcuate surface abut against the first connecting portion 2114c along the second direction A2-A2 to limit excessive deformation of the first abutting arm 2114e during elastic deflection. In the illustrated embodiment of the present disclosure, the first abutting arm 2114e is generally V-shaped, and includes a first pressing portion 2114e1 at a bottom thereof. The first pressing portion 2114e1 is configured to elastically abut against the first conductive pad 303. In the illustrated embodiment of the present disclosure, the first pressing portion 2114e1 is not soldered or welded with the first conductive pad 303.

Similarly, in the illustrated embodiment of the present disclosure, the second elastic abutting leg 2115 includes a third mounting plate 2115a, a fourth mounting plate 2115b disposed opposite to the third mounting plate 2115a, a third connecting portion 2115c connecting one side of the third mounting plate 2115a and one side of the fourth mounting plate 2115b, a fourth connecting portion 2115d connected to the third connecting portion 2115c, a second abutting arm 2115e connected to the fourth connecting portion 2115d, and a second distal end portion 2115f connected to and located at a free end of the second abutting arm 2115e. The second distal end portion 2115f includes a second connecting section 2115f1 connected to the second abutting arm 2115e and a second tail 2115f2 bent outward from the second connecting section 2115f1. In the illustrated embodiment of the present disclosure, the second distal end portion 2115f extends adjacent to the third connecting portion 2115c. When the second elastic abutting leg 2115 is installed on the circuit board 300, the second connecting section 2115f1 comes into contact with the third connecting portion 2115c to enhance performance. Along the second direction A2-A2, the third mounting plate 2115a protrudes upwardly with respect to the fourth mounting plate 2115b. The third mounting plate 2115a and the fourth mounting plate 2115b are spaced apart along the third direction A3-A3. The second elastic abutting leg 2115 includes a second receiving slot 2115g between the third mounting plate 2115a and the fourth mounting plate 2115b. The third connecting portion 2115c is located at one end of the second receiving slot 2115g. The third mounting plate 2115a has a third arcuate surface 2115a1 at a bottom thereof. The fourth mounting plate 2115b has a fourth arcuate surface at a bottom thereof. The fourth arcuate surface is the same as the third arcuate surface 2115a1. The fourth connecting portion 2115d defines a second recessed groove 2115d1 into which the third arcuate surface 2115a1 and the fourth arcuate surface partially extend. The third arcuate surface 2115a1 and the fourth arcuate surface abut against the third connecting portion 2115c along the second direction A2-A2 to limit excessive deformation of the second abutting arm 2115e during elastic deflection. The second abutting arm 2115e is generally V-shaped, and includes a second pressing portion 2115e1 at a bottom thereof. The second pressing portion 2115e1 is configured to elastically abut against the second conductive pad 304. In the illustrated embodiment of the present disclosure, the second pressing portion 2115e1 is not soldered or welded with the second conductive pad 304.

During assembly, the first tail portion 211c of the first conductive terminal S1 is received in the first receiving slot 2114g of the first elastic abutting leg 2114. The first arcuate portion 211c1 of the first conductive terminal S1 abuts against the first connecting portion 2114c along the second direction A2-A2 to limit excessive deformation of the first abutting arm 2114e. The first limiting protrusion 211c2 of the first conductive terminal S1 abuts against the first connecting portion 2114c to provide installation restriction. The first mounting plate 2114a and the second mounting plate 2114b are positioned on two sides of are in contact with the first tail portion 211c. In one embodiment of the present disclosure, at least one of the first mounting plate 2114a and the second mounting plate 2114b is fixed (e.g., soldered or welded) to the first tail portion 211c of the first conductive terminal S1.

Similarly, the first tail portion 211c of the second conductive terminal S2 is received in the second receiving slot 2115g of the second elastic abutting leg 2115. The first arcuate portion 211c1 of the second conductive terminal S2 abuts against the third connecting portion 2115c along the second direction A2-A2 to limit excessive deformation of the second abutting arm 2115e. The first limiting protrusion 211c2 of the second conductive terminal S2 abuts against the third connecting portion 2115c to provide installation restriction. The third mounting plate 2115a and the fourth mounting plate 2115b are positioned on two sides of and are in contact with the first tail portion 211c. In one embodiment of the present disclosure, at least one of the third mounting plate 2115a and the fourth mounting plate 2115b is fixed (e.g., soldered or welded) to the first tail portion 211c of the second conductive terminal S2.

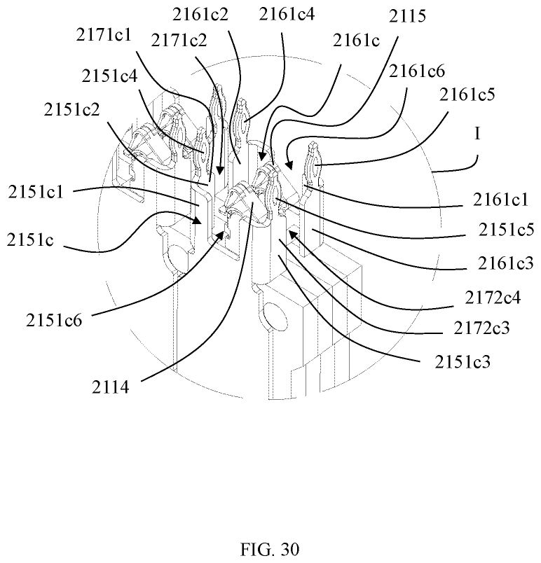

Referring to FIG. 13 and FIG. 30, in one embodiment of the present disclosure, corresponding to the first abutting arm 2114e and second abutting arm 2115e, the first shielding portion 2151c of the first shielding plate 215 and the second shielding portion 2161c of the second shielding plate 216 form a shielding chamber 218. The first abutting arm 2114e and the second abutting arm 2115e are at least partially located in the shielding chamber 218. Specifically, the first side wall 2151c1 and second side wall 2161c1 are arranged opposite to each other. The first bent wall 2151c2 and the third bent wall 2161c2 extend toward each other to form a third side wall 2171c1. The first bent wall 2151c2 and the third bent wall 2161c2 extend face to face and approach each other. A third opening 2171c2 is formed between the first bent wall 2151c2 and the third bent wall 2161c2. The second bent wall 2151c3 and the fourth bent wall 2161c3 extend toward each other to form a fourth side wall 2172c3. The second bent wall 2151c3 and the fourth bent wall 2161c3 extend face to face and approach each other. A fourth opening 2172c4 is formed between the second bent wall 2151c3 and the fourth bent wall 2161c3. The third side wall 2171c1 and the fourth side wall 2172c3 are arranged opposite to each other. The shielding chamber 218 is enclosed by the first side wall 2151c1, the second side wall 2161c1, the third side wall 2171c1 and the fourth side wall 2172c3, thereby improving shielding effectiveness for the first abutting arm 2114e and the second abutting arm 2115e.

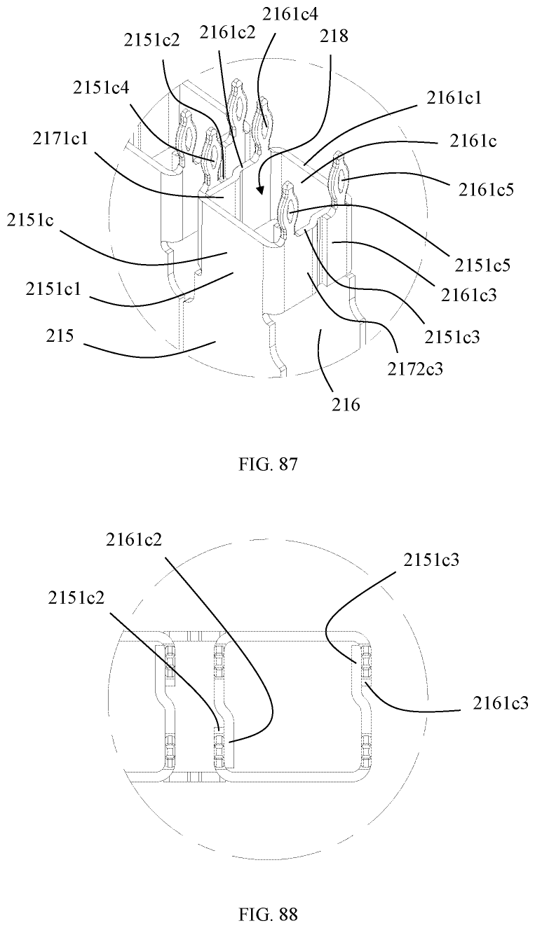

Referring to FIG. 87 and FIG. 88 and with reference to FIG. 30, in another embodiment of the present disclosure, corresponding to the first abutting arm 2114e and the second abutting arm 2115e, the first shielding portion 2151c of the first shielding plate 215 and the second shielding portion 2161c of the second shielding plate 216 form a shielding chamber 218. The first abutting arm 2114e and the second abutting arm 2115e are at least partially located in the shielding chamber 218. Specifically, the first side wall 2151c1 and the second side wall 2161c1 are arranged opposite to each other. The first bent wall 2151c2 and the third bent wall 2161c2 extend oppositely to form a third side wall 2171c1. The first bent wall 2151c2 and the third bent wall 2161c2 extend face-to-face and overlap each other. The second bent wall 2151c3 and the fourth bent wall 2161c3 extend oppositely to form a fourth side wall 2172c3. The second bent wall 2151c3 and the fourth bent wall 2161c3 extend face-to-face and overlap each other. The third side wall 2171c1 and the fourth side wall 2172c3 are arranged opposite to each other. The shielding chamber 218 is seamlessly and circumferentially enclosed by the first side wall 2151c1, the second side wall 2161c1, the third side wall 2171c1 and the fourth side wall 2172c3, thereby improving the shielding effect on the first abutting arm 2114e and the second abutting arm 2115e. At this time, the mounting block 4 may be omitted. When the first mounting leg 2151c4, the second mounting leg 2151c5, the third mounting leg 2161c4 and the fourth mounting leg 2161c5 are mounted to the circuit board 300, bottom surfaces of the first side wall 2151c1, the second side wall 2161c1, the third side wall 2171c1 and the fourth side wall 2172c3 are configured to be as close as possible to the first surface 301 of the circuit board 300 to minimize gaps and thereby enhance the shielding effect. Preferably, the bottom surfaces of the first side wall 2151c1, the second side wall 2161c1, the third side wall 2171c1 and the fourth side wall 2172c3 are in contact with the first surface 301 of the circuit board 300 to further improve the shielding effect.

Since the first tail portion 211c of the first conductive terminal S1 and the first tail portion 211c of the second conductive terminal S2 both extend downwardly and protrude beyond the shielding cavity 20, the first terminal module 21 defines the shielding chamber 218 to enhance the shielding effect on the first tail portion 211c of the first conductive terminal S1 and the first tail portion 211c of the second conductive terminal S2. The first tail portion 211c of the first conductive terminal S1 and the first tail portion 211c of the second conductive terminal S2 are both located at least partially in the shielding chamber 218.

Each of the first mounting leg 2151c4, the second mounting leg 2151c5, the third mounting leg 2161c4 and the fourth mounting leg 2161c5 defines a fish-eye hole, so that the first mounting leg 2151c4, the second mounting leg 2151c5, the third mounting leg 2161c4 and the fourth mounting leg 2161c5 all have certain elasticity. The first mounting leg 2151c4, the second mounting leg 2151c5, the third mounting leg 2161c4 and the fourth mounting leg 2161c5 are configured to be pressed into the first mounting hole 3051, the second mounting hole 3052, the third mounting hole 3053 and the fourth mounting hole 3054, respectively, to establish the electrical connection with the circuit board 300. The first mounting leg 2151c4, the second mounting leg 2151c5, the third mounting leg 2161c4 and the fourth mounting leg 2161c5 are located on two sides of the first tail portion 211c of the first conductive terminal S1 and the first tail portion 211c of the second conductive terminal S2. When the first elastic abutting leg 2114 and the second elastic abutting leg 2115 elastically abut against the circuit board 300, the reliability of contact between the first elastic abutting leg 2114 and the circuit board 300, and the reliability of contact between the second elastic abutting leg 2115 and the circuit board 300 are ensured.

The first shielding sleeve 214 is sleeved over the first contact portion 211b of the first conductive terminal S1, the first shielding tube 2112, the first contact portion 211b of the second conductive terminal S2, and the second shielding tube 2113. The first shielding sleeve 214 defines a shielding space 2140 in which the first contact portion 211b of the first conductive terminal S1, the first shielding tube 2112, the first contact portion 211b of the second conductive terminal S2, and the second shielding tube 2113 are at least partially located, thereby providing effective shielding for the first contact portion 211b of the first conductive terminal S1 and the first contact portion 211b of the second conductive terminal S2. Besides, the first engagement portion 2121b of the first grounding module 212, the second engagement portion 2131b of the second grounding module 213, the first extension portion 2151b of the first shielding plate 215 and the second extension portion 2161b of the second shielding plate 216 are all in contact with the first shielding sleeve 214, thereby further improving the shielding effect. In one embodiment of the present disclosure, the first engagement portion 2121b of the first grounding module 212 and the second engagement portion 2131b of the second grounding module 213 are located on an outer side and/or an inner side of the first shielding sleeve 214. In one embodiment of the present disclosure, the first engagement portion 2121b of the first grounding module 212 and the second engagement portion 2131b of the second grounding module 213 are fixed to the first shielding sleeve 214 by soldering or welding. The first extension portion 2151b of the first shielding plate 215 and the second extension portion 2161b of the second shielding plate 216 are located on an outer and/or an inner side of the first shielding sleeve 214. In one embodiment of the present disclosure, the first extension portion 2151b of the first shielding plate 215 and the second extension portion 2161b of the second shielding plate 216 are fixed with the first shielding sleeve 214 by soldering or welding.

Referring to FIG. 31 to FIG. 35, in the illustrated embodiment of the present disclosure, the first shielding sleeve 214 includes a first shielding shell 214a and a second shielding shell 214b. The first shielding shell 214a and the second shielding shell 214b are fixed together (e.g., by soldering or welding). The first shielding shell 214an includes a first end portion 214a1 and a first extending portion 214a2 connected to the first end portion 214a1. The second shielding shell 214b includes a second end portion 214b1 and a second extending portion 214b2 connected to the second end portion 214b1. The first end portion 214a1 cooperates with the second end portion 214b1 to form a quadrilateral sleeve portion 2144. The first extending portion 214a2 and the second extending portion 214b2 cooperate with each other to form a polygonal tubular portion 2143 with six or more sides. In some embodiments of the present disclosure, the polygon is an even-sided polygon with six or more sides. In the illustrated embodiment of the present disclosure, the polygon is an octagon, i.e., the tubular portion 2143 is octagonal. Correspondingly, the tubular portion 2143 defines a hollow octagonal first cavity 2141. In the illustrated embodiment of the present disclosure, the octagonal tubular portion 2143 is a regular octagon. The sleeve portion 2144 includes a first outer surface 21441 (e.g., an upper surface), a second outer surface 21442 (e.g., a lower surface) disposed opposite to the first outer surface 21441, a third outer surface 21443 (e.g., a left surface), and a fourth outer surface 21444 (e.g., a right surface) disposed opposite to the third outer surface 21443. The sleeve portion 2144 is circumferentially enclosed sequentially by the first outer surface 21441, the third outer surface 21443, the second outer surface 21442, and the fourth outer surface 21444. The first outer surface 21441 and the second outer surface 21442 lie in horizontal planes, while the third outer surface 21443 and the fourth outer surface 21444 lie in vertical planes.

The tubular portion 2143 includes a first outer wall 21431 (e.g., an upper wall), a second outer wall 21432 (e.g., a lower wall) disposed opposite to the first outer wall 21431, a third outer wall 21433 (e.g., a left wall), a fourth outer wall 21434 (e.g., a right wall) disposed opposite to the third outer wall 21433, a first inclined wall 21435 (e.g., an upper-left inclined wall) connecting the first outer wall 21431 and the third outer wall 21433, a second inclined wall 21436 (e.g., a lower-left inclined wall) connecting the third outer wall 21433 and the second outer wall 21432, a third inclined wall 21437 (e.g., a lower-right inclined wall) connecting the second outer wall 21432 and the fourth outer wall 21434, and a fourth inclined wall 21438 (e.g., an upper-right inclined wall) connecting the fourth outer wall 21434 and the first outer wall 21431. The tubular portion 2143 is circumferentially enclosed sequentially by the first outer wall 21431, the first inclined wall 21435, the third outer wall 21433, the second inclined wall 21436, the second outer wall 21432, the third inclined wall 21437, the fourth outer wall 21434, and the fourth inclined wall 21438.

In the illustrated embodiment of the present disclosure, the first outer wall 21431 is coplanar with the first outer surface 21441; the second outer wall 21432 is coplanar with the second outer surface 21442; the third outer wall 21433 is coplanar with the third outer surface 21443; and the fourth outer wall 21434 is coplanar with the fourth outer surface 21444.

In the illustrated embodiment of the present disclosure, the first contact portion 211b of the first conductive terminal S1 and the first contact portion 211b of the second conductive terminal S2 are disposed along opposite sides of the regular octagonal tubular portion 2143. Specifically, the first contact portion 211b of the first conductive terminal S1 and the first contact portion 211b of the second conductive terminal S2 are disposed between the third outer wall 21433 and the fourth outer wall 21434 of the octagonal tubular portion 2143. The first contact portion 211b of the first conductive terminal S1 and the first contact portion 211b of the second conductive terminal S2 are horizontally aligned, and arranged side by side.

Referring to FIG. 22 and FIG. 23, in one embodiment of the present disclosure, the first mounting plate 22 includes a first main body portion 221 and a first limiting side plate 222 protruding forwardly from the first main body portion 221 along the first direction A1-A1. The first main body portion 221 is provided with a plurality of first fixing ribs 2211 on a top thereof, a first fastening hole 2212 extending upwardly through the first main body portion 221, a plurality of second fixing ribs 2213 protruding backwardly from the first main body portion 221, a first positioning post 2214 protruding downwardly from the first main body portion 221, and a first threaded hole 2215 extending downwardly through the first main body portion 221. The first main body portion 221 abuts an outer side of a corresponding first terminal module 21 along the third direction A3-A3, and the first limiting side plate 222 abuts a corresponding first insulating plate 219. A portion of the first retaining groove 311 of the first retaining plate 31 engages with the first fixing rib 2211, and a portion of the second retaining groove 321 of the second retaining plate 32 engages with the second fixing rib 2213.

In one embodiment of the present disclosure, the second mounting plate 23 includes a second main body portion 231 and a second limiting side plate 232 protruding forwardly from the second main body portion 231 along the first direction A1-A1. The second main body portion 231 is provided with a plurality of third fixing ribs 2311 on a top thereof, a second fastening hole 2312 extending upwardly through the second main body portion 231, a plurality of fourth fixing ribs 2313 protruding backwardly from the second main body portion 231, a second positioning post 2314 protruding downwardly from the second main body portion 231, and a second threaded hole 2315 extending downwardly through the second main body portion 231. The second main body portion 231 abuts an outer side of another corresponding first terminal module 21 along the third direction A3-A3, and the second limiting side plate 232 abuts another corresponding first insulating plate 219. Another portion of the first retaining groove 311 of the first retaining plate 31 engages with the third fixing rib 2311, and another portion of the second retaining groove 321 of the second retaining plate 32 engages with the fourth fixing rib 2313.

By providing the first retaining plate 31 and the second retaining plate 32, the present disclosure is able to fix the first mounting plate 22, the plurality of first terminal modules 21, and the second mounting plate 23 as a whole. The first screw 401 passes through the first mounting through hole 3071 and is tightened into the first threaded hole 2215. The second screw 402 passes through the second mounting through hole 3072 and is tightened into the second threaded hole 2315. The first positioning post 2214 and the second positioning post 2314 are inserted into the first positioning through hole 3073 and the second positioning through hole 3074, respectively, to achieve positioning.

Referring to FIG. 10 to FIG. 17, the mounting block 4 includes a mounting base 41 and a plurality of insulating plastics 42 mounted in the mounting base 41. In one embodiment of the present disclosure, the mounting base 41 is made of electroplated plastic or conductive plastic so as to mate with the circuit board 300 for improving the shielding effect. The mounting base 41 defines a plurality of through-holes 411 extending through the mounting base 41 along the second direction A2-A2. In the illustrated embodiment of the present disclosure, the through-holes 411 are arranged in rows and columns. Correspondingly, the insulating plastics 42 are arranged in rows and columns, and mounted in the through-holes 411. Each insulating plastic 42 includes a first side wall portion 421, a second side wall portion 422 disposed opposite to the first side wall portion 421, a third side wall portion 423 connecting one end of the first side wall portion 421 and one end of the second side wall portion 422, a fourth side wall portion 424 connecting another end of the first side wall portion 421 and another end of the second side wall portion 422, and an intermediate wall portion 425 connecting the third side wall portion 423 and the fourth side wall portion 424, and disposed between the first side wall portion 421 and the second side wall portion 422. The first side wall portion 421, the second side wall portion 422, the third side wall portion 423 and the fourth side wall portion 424 jointly form a frame. The intermediate wall portion 425 divides the frame into a first mounting slot 4261 on one side of the intermediate wall portion 425, and a second mounting slot 4262 on another side. The first side wall portion 421 is provided with a first protrusion 4211 protruding away from the second side wall portion 422. The second side wall portion 422 is provided with a second protrusion 4221 protruding away from the first side wall portion 421. The third side wall portion 423 is provided with a third protrusion 4231 protruding away from the fourth side wall portion 424. The fourth side wall portion 424 is provided with a fourth protrusion 4241 protruding away from the third side wall portion 423.

During assembly, the mounting block 4 is mounted at a bottom of the first housing 1. The first protrusion 4211 is inserted into the first opening 2151c6 to fill the first opening 2151c6 as much as possible, thereby improving shielding effectiveness. The second protrusion 4221 is inserted into the second opening 2161c6 to fill the second opening 2161c6 as much as possible, thereby improving shielding effectiveness. The third protrusion 4231 is inserted into the third opening 2171c2 to fill the third opening 2171c2 as much as possible, thereby improving shielding effectiveness. The fourth protrusion 4241 is inserted into the fourth opening 2172c4 to fill the fourth opening 2172c4 as much as possible, thereby improving shielding effectiveness. At this time, the first abutting arm 2114e and the second abutting arm 2115e protrude beyond the mounting block 4 from the first mounting slot 4261 and the second mounting slot 4262, respectively. Besides, the first mounting leg 2151c4 and the third mounting leg 2161c4 extend out of the mounting block 4 through gaps on two sides of the third protrusion 4231 to be mounted to the circuit board 300. The second mounting leg 2151c5 and the fourth mounting leg 2161c5 extend out of the mounting block 4 through gaps on two sides of the fourth protrusion 4241 to be mounted on the circuit board 300. Referring to FIG. 10 and FIG. 13, the mounting base 41 surrounds a periphery of each first shielding portion 2151c and each second shielding portion 2161c in order to enhance shielding effectiveness.

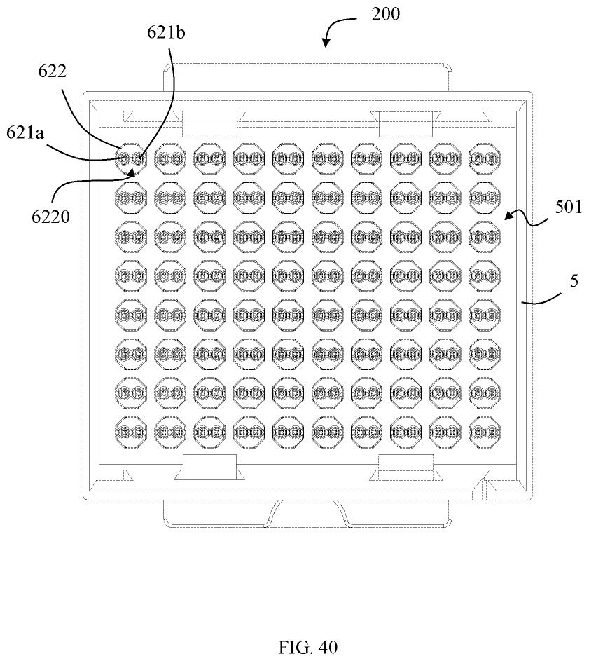

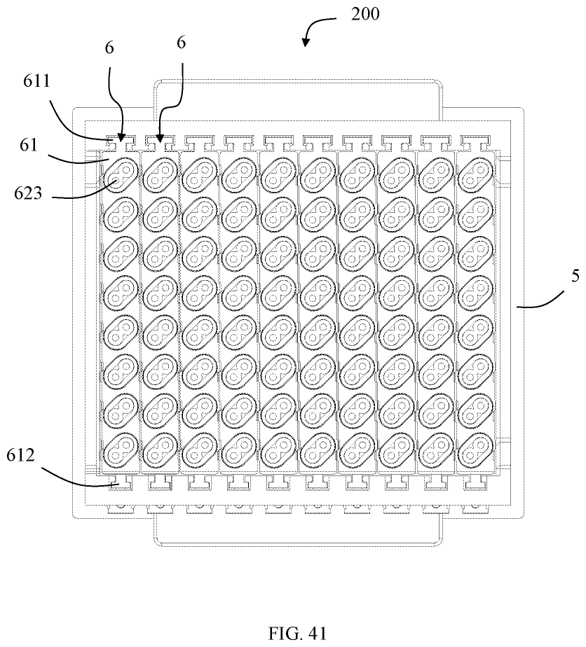

Referring to FIG. 40 to FIG. 45, the second connector 200 includes a second housing 5, a plurality of insertion modules 6 installed on the second housing 5, and a plurality of first positioning pins 7 and a plurality of second positioning pins 8 for securing the insertion modules 6 in the second housing 5.

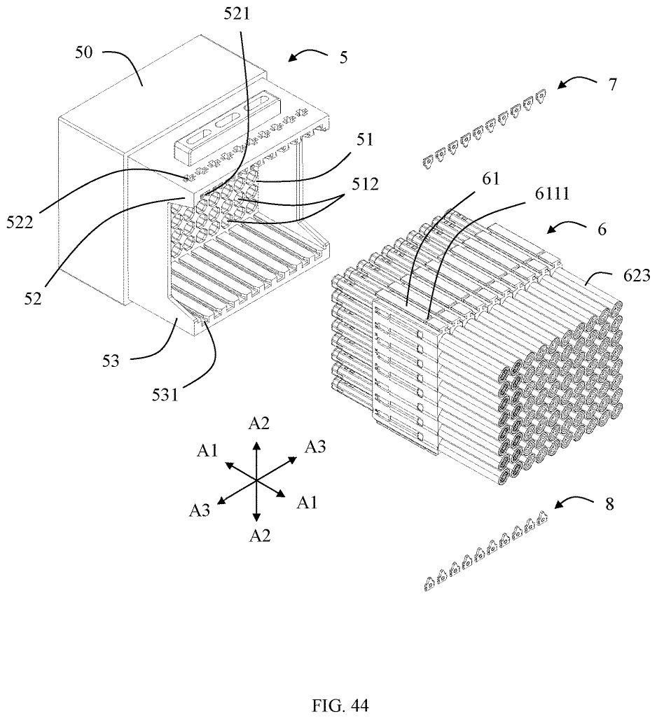

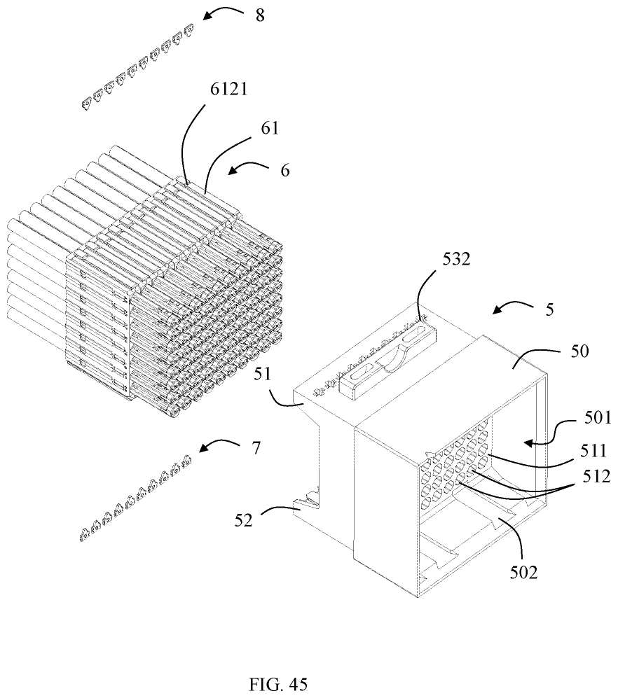

Referring to FIG. 44 and FIG. 45, the second housing 5 is made of insulating material, and includes a second main body 51, a third wall portion 52 extending backwardly from one end (e.g., an upper end) of the second main body 51, and a fourth wall portion 53 extending backwardly from an opposite end (e.g., a lower end) of the second main body 51. The second main body 51 includes a second mating surface 511 and a plurality of second terminal receiving slots 512 extending through the second mating surface 511. In the illustrated embodiment of the present disclosure, the second terminal receiving slots 512 are arranged in a matrix. Each second terminal receiving slot 512 is polygonal with six or more sides. In some embodiments of the present disclosure, the polygon is an even-sided polygon with six or more sides. In the illustrated embodiment of the present disclosure, the polygon is an octagon, i.e., the second terminal receiving slots 512 are octagonal. In the illustrated embodiment of the present disclosure, each second terminal receiving slot 512 is a regular octagon. The third wall portion 52 defines a plurality of first mounting slots 521 and a plurality of first locking slots 522 communicating with the first mounting slots 521. The fourth wall portion 53 defines a plurality of second mounting slots 531 and a plurality of second locking slots 532 communicating with the second mounting slots 531. Each of the first mounting slots 521 and the second mounting slots 531 extends along the first direction A1-A1. The first mounting slot 521 and the second mounting slot 531 aligned along the second direction A2-A2 are configured to jointly receive a corresponding insertion module 6. Each of the first locking slots 522 and the second locking slots 532 extends vertically. The first locking slots 522 extend through the third wall portion 52 vertically and communicate with the corresponding first mounting slots 521. The second locking slots 532 extend through the fourth wall portion 53 vertically and communicate with the corresponding second mounting slots 531. Besides, the second housing 5 includes a second frame 50 connected with the second main body 51. The second frame 50 defines a receiving space 501 communicating with the second terminal receiving slots 512, and a plurality of positioning grooves 502 located on inner wall surfaces of the second frame 50 and exposed to the receiving space 501. The positioning grooves 502 are configured to mate with the positioning protrusions 14.

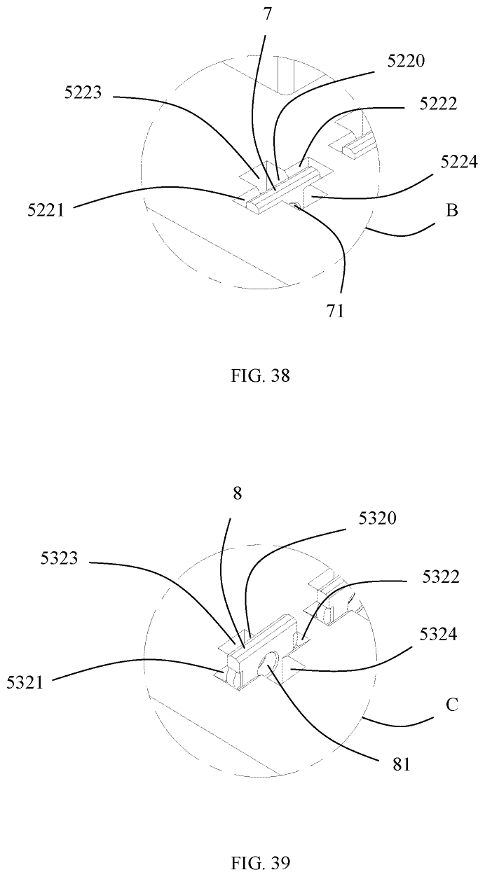

Referring to FIG. 38, in the illustrated embodiment of the present disclosure, each first locking slot 522 is generally cross-shaped, including a first central slot 5220, a first slot portion 5221 located on one side (e.g., a left side) of the first central slot 5220 along the third direction A3-A3, a second slot portion 5222 located on an opposite side (e.g., a right side) of the first central slot 5220 along the third direction A3-A3, a first notch 5223 located on one side (e.g., a front side) of the first central slot 5220 along the first direction A1-A1, and a second notch 5224 located on an opposite side (e.g., a rear side) of the first central slot 5220 along the first direction A1-A1. For a single first locking slot 522, the first slot portion 5221, the first central slot 5220 and the second slot portion 5222 are interconnected along the left-right direction. The first notch 5223, the first central slot 5220 and the second notch 5224 are interconnected along the front-rear direction. The first slot portion 5221 and second slot portion 5222 extend through the third wall portion 52 vertically to communicate with a corresponding first mounting slot 521. The first central slot 5220 does not extend downwardly through the third wall portion 52, so that a surface of the third wall portion 52 within the first central slot 5220 is able to limit the first positioning pin 7. Besides, by providing the first notch 5223 and the second notch 5224, the present disclosure facilitates clamping of the first positioning pin 7 by a fixture, and assembling or disassembling the first positioning pin 7 into or from the first locking slot 522.

Similarly, referring to FIG. 39, each second locking slot 532 is generally cross-shaped, including a second central slot 5320, a third slot portion 5321 located on one side (e.g., a left side) of the second central slot 5320 along the third direction A3-A3, a fourth slot portion 5322 located on an opposite side (e.g., a right side) of the second central slot 5320 along the third direction A3-A3, a third notch 5323 located on one side (e.g., a front side) of the second central slot 5320 along the first direction A1-A1, and a fourth notch 5324 located on an opposite side (e.g., a rear side) of the second central slot 5320 along the first direction A1-A1. For a single second locking slot 532, the third slot portion 5321, the second central slot 5320, and the fourth slot portion 5322 are interconnected along the left-right direction. The third notch 5323, the second central slot 5320, and the fourth notch 5324 are interconnected along the front-rear direction. The fourth slot portion 5322 extend vertically through the fourth wall portion 53 to communicate with a corresponding second mounting slot 531. The third slot portion 5321 and the fourth slot portion 5322 extend vertically through the fourth wall portion 53 to communicate with a corresponding second mounting slot 531. The second central slot 5320 does not extend upwardly through the fourth wall portion 53, so that a surface of the fourth wall portion 53 within the second central slot 5320 is able to limit the second positioning pin 8. Besides, by providing the third notch 5323 and the fourth notch 5324, the present disclosure facilitates clamping of the second positioning pin 8 by a fixture, and assembling or disassembling the second positioning pin 8 into or from the second locking slot 532. In one embodiment of the present disclosure, the first positioning pin 7 defines a first removal hole 71 extending through the first positioning pin 7 along a thickness direction, facilitating clamping with the fixture for installation or removal from the first locking slot 522. The second positioning pin 8 defines a second removal hole 81 extending through the second positioning pin 8 along a thickness direction, facilitating clamping with the fixture for installation or removal from the second locking slot 532. In the illustrated embodiment of the present disclosure, the thickness direction of the first positioning pin 7 and the second positioning pin 8 aligns with the first direction A1-A1. When one insertion module 6 is damaged, maintenance or replacement can be performed by disassembling the first positioning pin 7 and the second positioning pin 8.

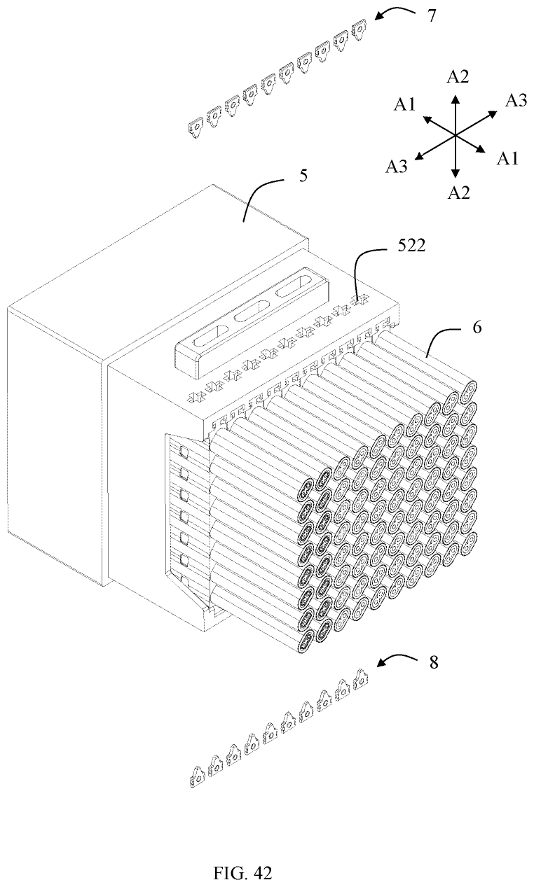

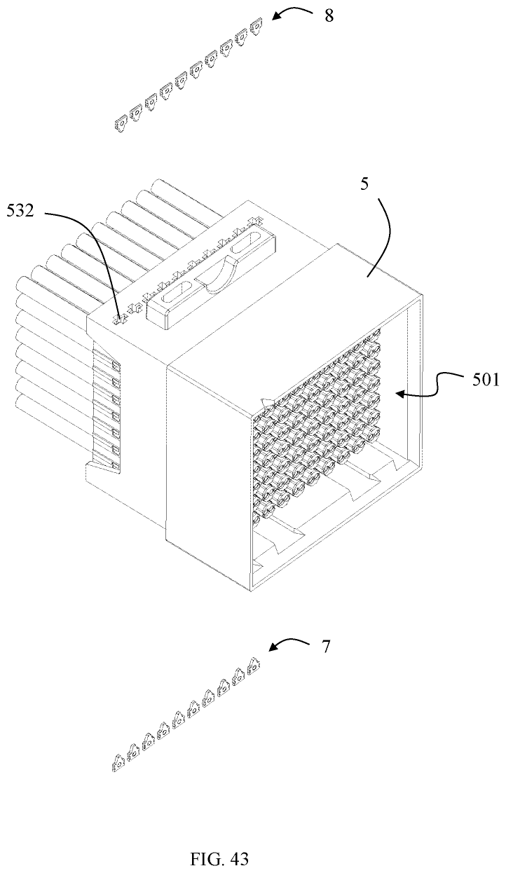

In one embodiment of the present disclosure, the first positioning pin 7 and the second positioning pin 8 are formed by stamping metal sheets. Referring to FIG. 42 and FIG. 43, in one embodiment of the present disclosure, the first positioning pins 7 may be individually installed into corresponding first locking slots 522, and the second positioning pins 8 may be individually installed into corresponding second locking slots 532. In other embodiments, the first positioning pins 7 may be connected as a single unit via a first carrier strip (not shown), and the second positioning pins 8 may be connected as a single unit via a second carrier strip (not shown). During assembly, the first positioning pins 7 and the second positioning pins 8 are installed as integrated units into the corresponding first locking slots 522 and the second locking slots 532, respectively, to improve installation efficiency. After assembly, the first carrier strip and the second carrier strip may be removed or retained as needed.

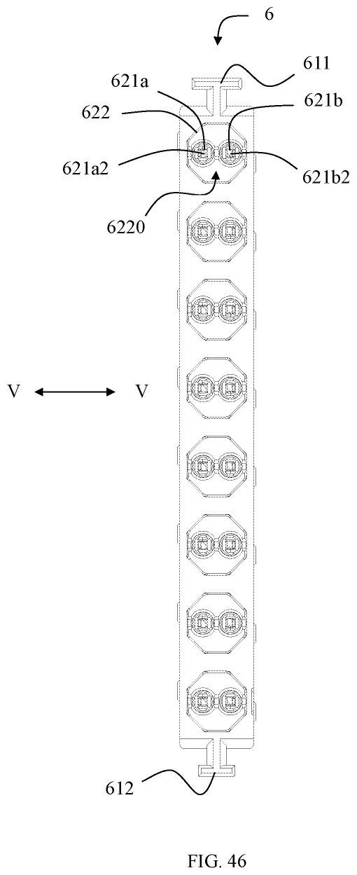

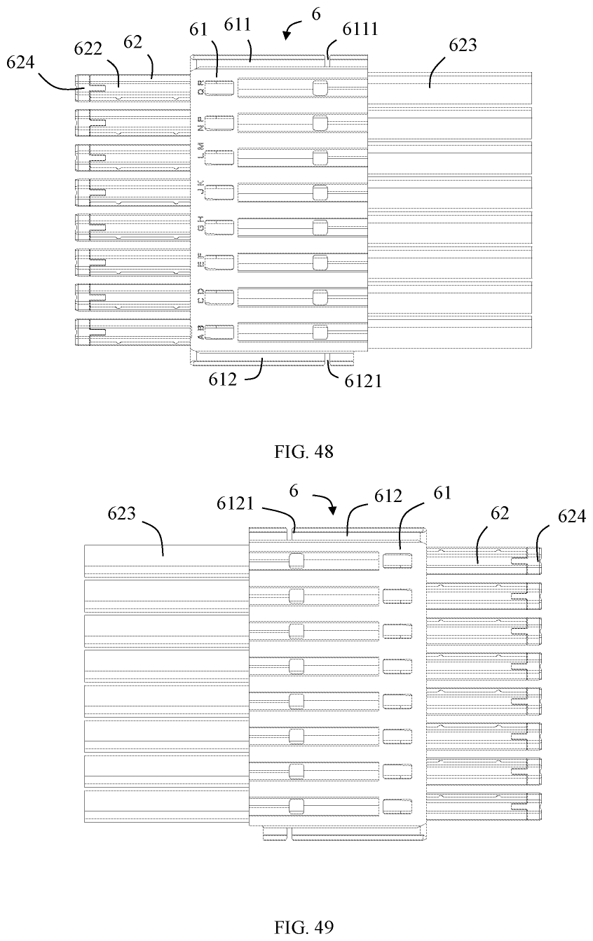

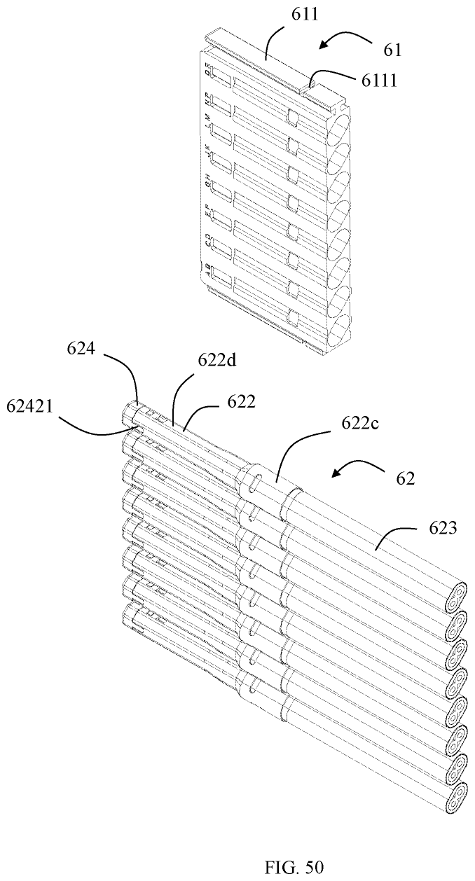

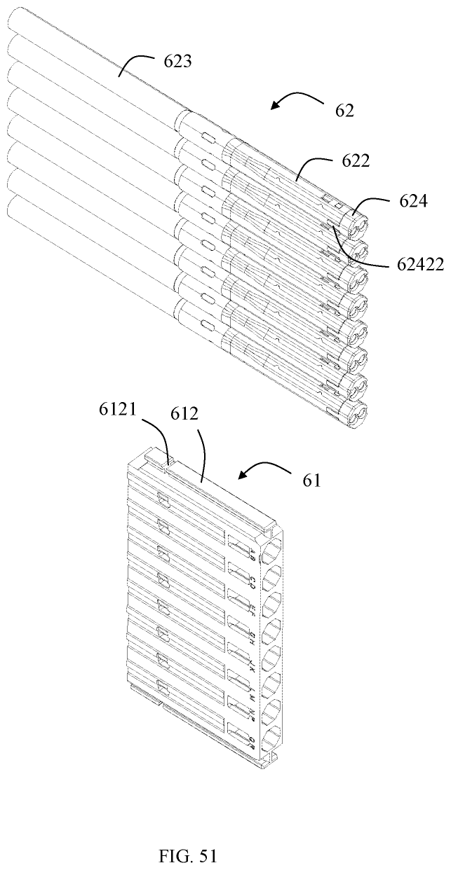

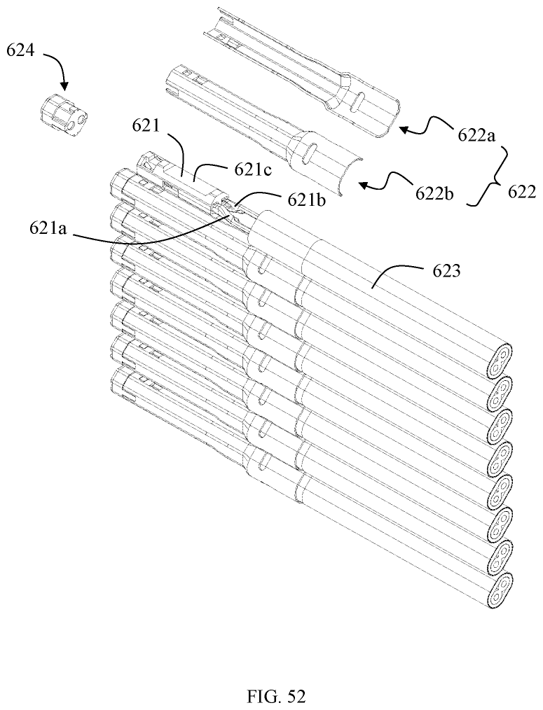

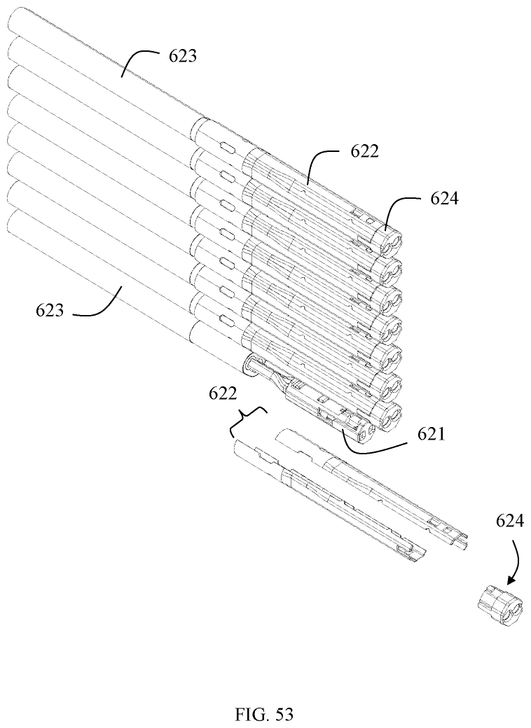

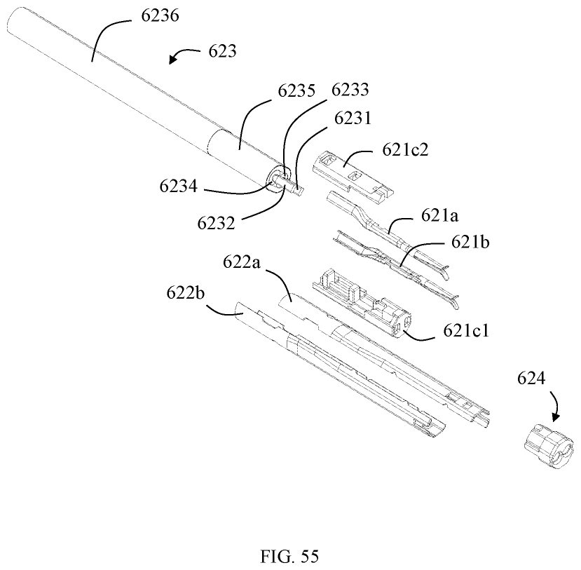

Referring to FIG. 46 to FIG. 55, each insertion module 6 includes a second insulating plate 61 and a plurality of second terminal modules 62 secured to the second insulating plate 61. In the illustrated embodiment of the present disclosure, all the second terminal modules 62 are identical. The following description will take one of the second terminal modules 62 as an example.

The second insulating plate 61 is installed in the second housing 5. The second insulating plate 61 includes a first mounting protrusion 611 installed in the first mounting slot 521 and a second mounting protrusion 612 installed in the second mounting slot 531. In the illustrated embodiment of the present disclosure, the first mounting protrusion 611 and the second mounting protrusion 612 are T-shaped in order to enhance installation reliability. The first mounting protrusion 611 defines a first positioning groove 6111, and the second mounting protrusion 612 defines a second positioning groove 6121. The first positioning groove 6111 is configured to engage with the first positioning pin 7, and the second positioning groove 6121 is configured to engage with the second positioning pin 8, thereby securing the insertion module 6 in the second housing 5 and preventing disengagement.

The second terminal module 62 includes a plurality of second terminal blocks 621, a second shielding sleeve 622 at least partially surrounding the second terminal blocks 621, a plurality of cables 623 electrically connected to the second terminal blocks 621, and a plurality of conductive components 624 each installed at a front end of a corresponding second shielding sleeve 622.

Each second terminal block 621 includes a first mating terminal 621a, a second mating terminal 621b, and an insulating block 621c fixed on the first mating terminal 621a and the second mating terminal 621b. In one embodiment of the present disclosure, the first mating terminal 621a and the second mating terminal 621b form a differential signal pair to enhance the rate of signal transmission.

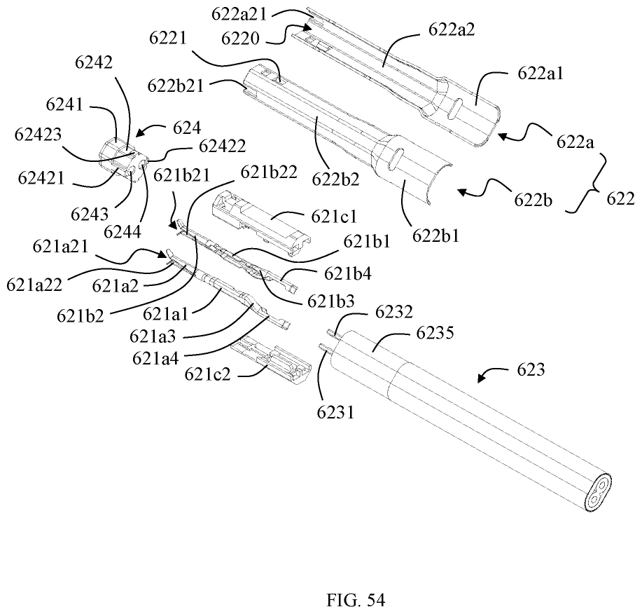

Referring to FIG. 54 to FIG. 56, in the illustrated embodiment of the present disclosure, the first mating terminal 621an includes a first retention portion 621a1, a first mating portion 621a2, a first twisted portion 621a3, and a first cable connection portion 621a4. In the illustrated embodiment of the present disclosure, the first mating portion 621a2, the first retention portion 621a1, the first twisted portion 621a3 and the first cable connection portion 621a4 are sequentially arranged along the first direction A1-A1. Specifically, the first mating portion 621a2 extends from one end of the first retention portion 621a1. The first twisted portion 621a3 extends from an opposite end of the first retention portion 621a1. The first cable connection portion 621a4 is connected to the first twisted portion 621a3. Of course, it is understandable to those skilled in the art that in other embodiments of the present disclosure, other parts may be provided between the first mating portion 621a2, the first retention portion 621a1, the first twisted portion 621a3, and the first cable connection portion 621a4. For example, a second twisted portion or the like may be provided between the first mating portion 621a2 and the first retention portion 621a1, which will not be described in detail.

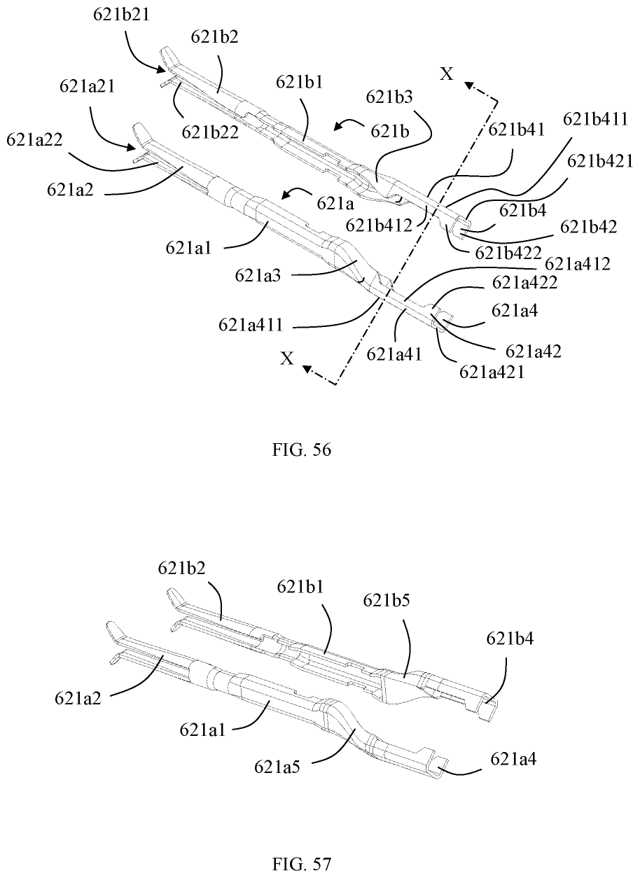

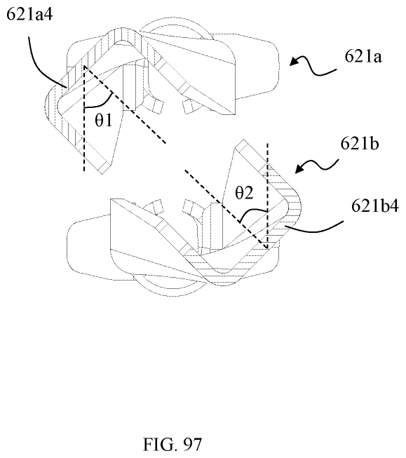

Referring to FIG. 56 and FIG. 97, in the illustrated embodiment of the present disclosure, the first retention portion 621a1 is generally U-shaped, and retained in the insulating block 621c. The first mating portion 621a2 includes a first flared opening 621a21 at a distal end thereof, and a first accommodation space 621a22 communicating with the first flared opening 621a21. The first flared opening 621a21 guides insertion of the first contact portion 211b of the first conductive terminal S1 into the first accommodation space 621a22. The first mating portion 621a2 extends along the first direction A1-A1 within the insulating block 621c. The first retention portion 621a1 and the first mating portion 621a2 are linearly connected without angular deviation. The first twisted portion 621a3 positions the first cable connection portion 621a4 at a first angle θ1 with respect to the first retention portion 621a1 and the first mating portion 621a2, where 0°<θ1<90°. In one embodiment of the present disclosure, since the first conductive wire 6231 and the first cable connection portion 621a4 are linearly connected without angular deviation, θ1 is equivalent to α1. In the illustrated embodiment of the present disclosure, θ1 is 45°. In one embodiment of the present disclosure, the first twisted portion 621a3 also has a U-shaped configuration before being twisted, and does not make structural design changes compared with the first retention portion 621a1. The first retention portion 621a1 or the first twisted portion 621a3 has a U-shaped cross-sectional area, and the cross-sectional area increases with respect to the overall elongate terminal, thereby adjusting the impedance.

Similarly, the second mating terminal 621b includes a second retention portion 621b1, a second mating portion 621b2 extending from one end of the second retention portion 621b1, a second twisted portion 621b3 extending from an opposite end of the second retention portion 621b1, and a second cable connection portion 621b4 connected to the second twisted portion 621b3. In the illustrated embodiment of the present disclosure, the second retention portion 621b1 is generally U-shaped and retained in the insulating block 621c. The second mating portion 621b2 includes a second flared opening 621b21 at a distal end thereof, and a second accommodation space 621b22 communicating with the second flared opening 621b21. The second flared opening 621b21 guides insertion of the first contact portion 211b of the second conductive terminal S2 into the second accommodation space 621b22. The second mating portion 621b2 extends along the first direction A1-A1 within the insulating block 621c. The second retention portion 621b1 and the second mating portion 621b2 are linearly connected without angular deviation. The second twisted portion 621b3 positions the second cable connection portion 621b4 at a second angle θ2 with respect to the second retention portion 621b1 and the second mating portion 621b2, where 0°<θ2<90°. In one embodiment of the present disclosure, θ2 is 45°. In one embodiment of the present disclosure, the second twisted portion 621b3 also has a U-shaped configuration before being twisted, and does not make structural design changes compared with the second retention portion 621b1.

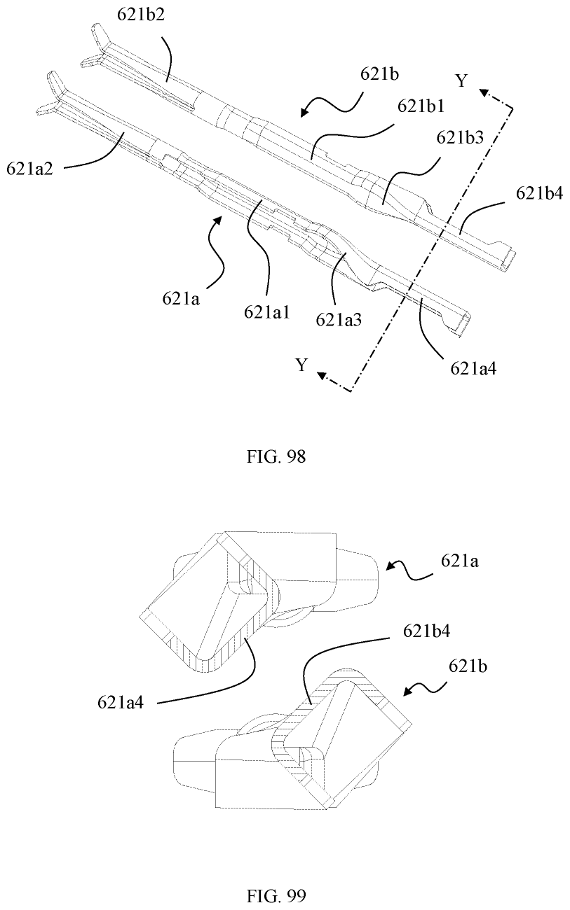

Referring to FIG. 56, FIG. 57 and FIG. 98, in the illustrated embodiment of the present disclosure, the local corresponding structures of the first mating terminal 621a and the second mating terminal 621b are configured as symmetrical or identical structures to enhance their coupling effect. Specifically, in the illustrated embodiment of the present disclosure, the first mating portion 621a2 of the first mating terminal 621a is identical to the second mating portion 621b2 of the second mating terminal 621b; the first retention portion 621a1 of the first mating terminal 621a and the second retention portion 621b1 of the second mating terminal 621b are symmetrically arranged; the first twisted portion 621a3 of the first mating terminal 621a and the second twisted portion 621b3 of the second mating terminal 621b are symmetrically arranged; and the first cable connection portion 621a4 of the first mating terminal 621a and the second cable connection portion 621b4 of the second mating terminal 621b are symmetrically arranged. Referring to FIG. 56 and FIG. 97, in one embodiment of the present disclosure, after the first twisted portion 621a3 and the second twisted portion 621b3 are twisted, it causes the first cable connection portion 621a4 and the second cable connection portion 621b4 to face each other, i.e., the U-shaped opening of the first cable connection portion 621a4 and the U-shaped opening of the second cable connection portion 621b4 are disposed face-to-face. Alternatively, referring to FIG. 98 and FIG. 99, in another embodiment, the first cable connection portion 621a4 and the second cable connection portion 621b4 are disposed back-to-back, i.e., the U-shaped opening of the first cable connection portion 621a4 and the U-shaped opening of the second cable connection portion 621b4 are disposed facing away from each other.

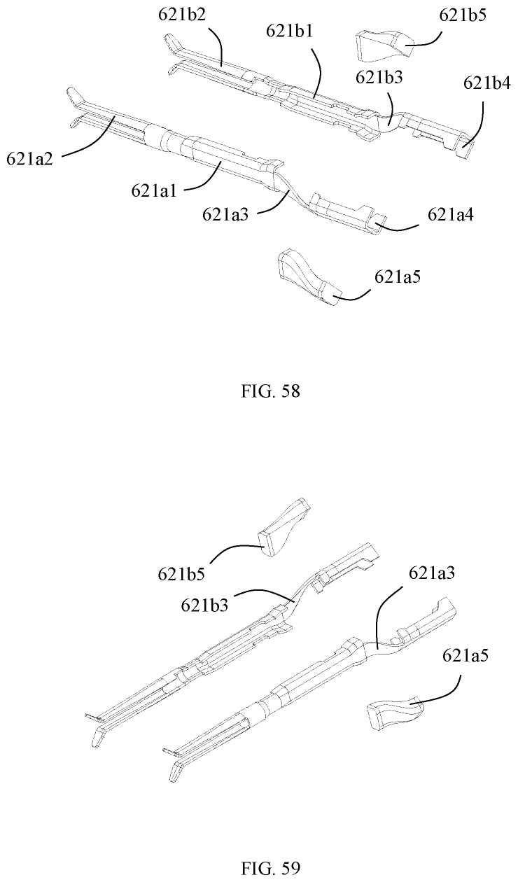

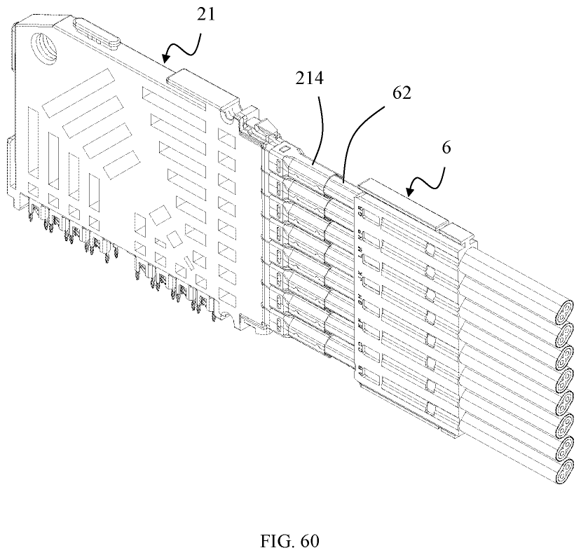

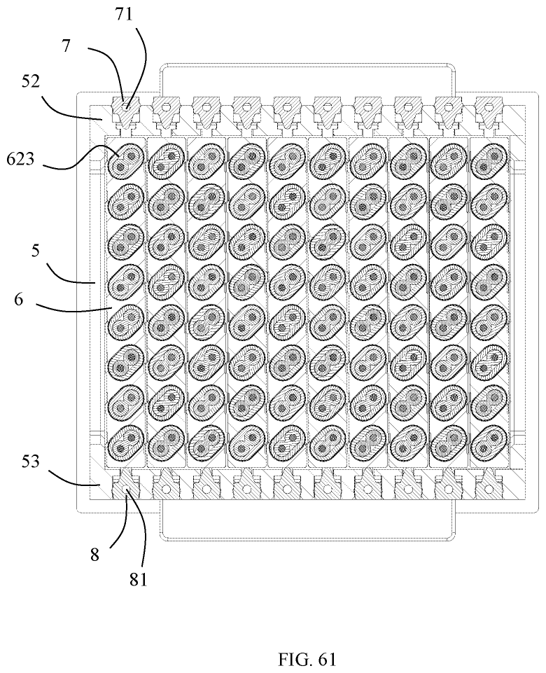

Referring to FIG. 57 to FIG. 59, in another illustrated embodiment of the present disclosure, the first mating terminal 621an includes a first retention portion 621a1, a first mating portion 621a2 extending from one end of the first retention portion 621a1, a first twisted portion 621a3 extending from another end of the first retention portion 621a1, and a first cable connection portion 621a4 connected to the first twisted portion 621a3. The first retention portion 621a1 is approximately U-shaped and secured in the insulating block 621c. The first twisted portion 621a3 tilts the first cable connection portion 621a4 at a first angle θ1 with respect to the first retention portion 621a1 and the first mating portion 621a2, where 0°<θ1<90°. In one embodiment of the present disclosure, θ1 is 45°. In one embodiment of the present disclosure, the first twisted portion 621a3 is thinned compared to the first retention portion 621a1. In other words, the first twisted portion 621a3 is in a single layer sheet shape (no longer in a U-shaped configuration) to facilitate twisting and adjusting the impedance of the first mating terminal 621a.

Besides, referring to FIG. 57 to FIG. 59, the first mating terminal 621an includes a first electrical connection component 621a5 fixed to the first twisted portion 621a3 to further adjust impedance. In one embodiment of the present disclosure, the first electrical connection component 621a5 is integrally molded with the first twisted portion 621a3, so that the first electrical connection component 621a5 and the first twisted portion 621a3 are integrated as a whole. The first electrical connection component 621a5 smoothly transitions with the first retention portion 621a1 and the first cable connection portion 621a4. In some embodiments of the present disclosure, the first electrical connection component 621a5 is made of electroplated plastic or conductive plastic.

Similarly, the second mating terminal 621b includes a second retention portion 621b1, a second mating portion 621b2, a second twisted portion 621b3, and a second cable connection portion 621b4. The second retention portion 621b1 is U-shaped and secured in the insulating block 621c. The second twisted portion 621b3 tilts the second cable connection portion 621b4 at a second angle θ2 with respect to the second retention portion 621b1 and the second mating portion 621b2, where 0°<θ2<90°. In one embodiment of the present disclosure, θ2 is 45°. In one embodiment of the present disclosure, the second twisted portion 621b3 is thinned compared to the second retention portion 621b1. In other words, the second twisted portion 621b3 is in a single layer sheet shape (no longer in a U-shaped configuration) to facilitate twisting and adjusting the impedance of the second mating terminal 621b.

Besides, referring to FIG. 57 to FIG. 59, the second mating terminal 621b includes a second electrical connection component 621b5 fixed to the second twisted portion 621b3 to further adjust impedance. In one embodiment of the present disclosure, the second electrical connection component 621b5 is integrally molded with the second twisted portion 621b3, so that the second electrical connection component 621b5 and the second twisted portion 621b3 are integrated as a whole. The second electrical connection component 621b5 smoothly transitions with the second retention portion 621b1 and the second cable connection portion 621b4. In some embodiments of the present disclosure, the second electrical connection component 621b5 is made of electroplated plastic or conductive plastic.

In various embodiments of the present disclosure, the first cable connection portion 621a4 and the second cable connection portion 621b4 are U-shaped, and face each other. In other words, the U-shaped opening of the first cable connection portion 621a4 and the U-shaped opening of the second cable connection portion 621b4 are disposed face-to-face. Specifically, the first cable connection portion 621a4 includes a first transition portion 621a41 which is generally in a U-shaped configuration, and a first rear end portion 621a42 which is generally in a U-shaped configuration and connected to the first transition portion 621a41. The first transition portion 621a41 includes a first outer side wall 621a411 and two first folding portions 621a412 bent from upper and lower edges of the first outer side wall 621a411. The first rear portion 621a42 includes a second outer side wall 621a421 and two second folding portions 621a422 bent from upper and lower edges of the second outer side wall 621a421. The second cable connection portion 621b4 includes a second transition portion 621b41 which is generally in a U-shaped configuration, and a second rear end portion 621b42 which is generally in a U-shaped configuration and connected to the second transition portion 621b41. The second transition portion 621b41 includes a third outer side wall 621b411 and two third folding portions 621b412 bent from upper and lower edges of the third outer side wall 621b411. The second rear portion 621b42 includes a fourth outer side wall 621b421 and two fourth folding portions 621b422 bent from upper and lower edges of the fourth outer side wall 621b421. The first rear portion 621a42 is disposed closer to the cable 623 than the first transition portion 621a41. In other words, the first rear portion 621a42 is further away from the first mating portion 621a2 than the first transition portion 621a41. The second rear portion 621b42 is disposed closer to the cable 623 than the second transition portion 621b41. In other words, the second rear portion 621b42 is further away from the second mating portion 621b2 than the second transition portion 621b41. In the illustrated embodiment of the present disclosure, the first folding portion 621a412 and the third folding portion 621b412 extend face-to-face, and form a first spacing between the first folding portion 621a412 and the third folding portion 621b412. The second folding portion 621a422 and the fourth folding portion 621b422 extend face-to-face, and form a second spacing between the second folding portion 621a422 and the fourth folding portion 621b422. The first spacing is larger than the second spacing to control impedance.

Besides, in the various illustrated embodiments of the present disclosure, the first mating terminal 621a and the second mating terminal 621b are made of thin metal materials to facilitate impedance adjustment.

In the illustrated embodiment of the present disclosure, the insulating block 621c includes a first insulating block 621c1 and a second insulating block 621c2. The first insulating block 621c1 and the second insulating block 621c2 are separate components but assembled together to secure the first mating terminal 621a and the second mating terminal 621b, respectively. The first cable connection portion 621a4 and the second cable connection portion 621b4 protrude backwardly beyond the insulating block 621c along the first direction A1-A1.

In the illustrated embodiment of the present disclosure, the second shielding sleeve 622 surrounds the second terminal block 621 to enhance the shielding effect. The second shielding sleeve 622 includes a first shielding shell 622a and a second shielding shell 622b. The first shielding shell 622a and the second shielding shell 622b are fixed together (e.g., by soldering or welding). The first shielding shell 622an includes a first installation end portion 622a1 and a first extending portion 622a2. The second shielding shell 622b includes a second installation end portion 622b1 and a second extending portion 622b2. The first installation end portion 622a1 and the second installation end portion 622b1 mate with each other and form an elliptical covering portion 622c. The first extending portion 622a2 and the second extending portion 622b2 mate with each other and form a polygonal tubular portion 622d with six or more sides. In some embodiments of the present disclosure, the polygon has an even number of sides, and the even number is greater than or equal to six. In the illustrated embodiment of the present disclosure, the even number is eight, that is, the tubular portion 622d is octagonal. Accordingly, the tubular portion 622d defines a hollow octagonal second cavity 6220. In illustrated embodiment of the present disclosure, the octagonal shape of the second cavity 6220 is a regular octagonal shape. The first extending portion 622a2 has a first mounting notch 622a21 extending forwardly through the first extending portion 622a2 along the first direction A1-A1. The second extending portion 622b2 defines a second mounting notch 622b21 extending forwardly through the second extending portion 622b2 along the first direction A1-A1. Referring to FIG. 46, in illustrated embodiment of the present disclosure, a portion of the first mating terminal 621a and a portion of the second mating terminal 621b that are disposed in the second cavity 6220 are aligned along a thickness direction V-V of the insertion module 6. The thickness direction V-V is the same as the third direction A3-A3.

In one embodiment of the present disclosure, the conductive component 624 is a metal block or electroplated plastic block. The conductive component 624 is partially inserted into the second cavity 6220, and includes a head 6241, an insertion portion 6242 connected with the head 6241, a first insertion hole 6243, and a second insertion hole 6244. The first insertion hole 6243 and the second insertion hole 6244 extend through the head 6241 and the insertion portion 6242 along the first direction A1-A1. The insertion portion 6242 has a first mounting rib 62421 and a second mounting rib 62422 on two sides thereof. The first mounting rib 62421 and the second mounting rib 62422 are inserted into the first mounting notch 622a21 and the second mounting notch 622b21, respectively, to achieve positioning and limiting. Besides, the insertion portion 6242 includes at least one latch protrusion 62423 that engages with a latch opening 6221 on the second shielding sleeve 622. The head 6241 protrudes beyond the second shielding sleeve 622. The first insertion hole 6243 communicates with the first accommodation space 621a22 to receive the first contact portion 211b of the first conductive terminal S1. The second insertion hole 6244 communicates with the second accommodation space 621b22 to receive the first contact portion 211b of the second conductive terminal S2. In illustrated embodiment of the present disclosure, the head 6241 is octagonal to match the shape of the second shielding sleeve 622. A cross-sectional area of either the first insertion hole 6243 or the second insertion hole 6244 is smaller than a cross-sectional area of the second cavity 6220.

The cable 623 includes a first conductive wire 6231, a second conductive wire 6232, a first insulation layer 6233 circumferentially wrapping around the first conductive wire 6231, a second insulation layer 6234 circumferentially wrapping around the second conductive wire 6232, a shielding layer 6235 circumferentially wrapping around the first insulation layer 6233 and the second insulation layer 6234, and an outermost insulating sheath 6236 circumferentially wrapping around the shielding layer 6235. In the illustrated embodiment of the present disclosure, the first conductive wire 6231 and the second conductive wire 6232 extend beyond the first insulation layer 6233 and the second insulation layer 6234, respectively, to electrically connect with the first cable connection portion 621a4 and the second cable connection portion 621b4. The first conductive wire 6231 and the second conductive wire 6232 respectively and electrically contact the first cable connection portion 621a4 and the second cable connection portion 621b4, either directly or indirectly. In one embodiment of the present disclosure, the first conductive wire 6231 and the second conductive wire 6232 are fixed to the first cable connection portion 621a4 and the second cable connection portion 621b4, respectively, by soldering or welding. The shielding layer 6235 is partially exposed to the outermost insulating sheath 6236. The shielding layer 6235 is clamped between the first installation end portion 622a1 and the second installation end portion 622b1. In one embodiment of the present disclosure, the shielding layer 6235 is fixed to the first installation end portion 622a1 and the second installation end portion 622b1 by soldering or welding.

The cable 623 further includes a first signal wire 6237 which is connected to the first conductive wire 6231 and wrapped by the first insulation layer 6233, and a second signal wire 6238 which is connected to the second conductive wire 6232 and wrapped by the second insulation layer 6234. An arrangement direction U-U between the first signal wire 6237 and the second signal wire 6238 forms a first angle α1 with the thickness direction V-V of the insertion module 6, where 0°<α1<90°. Preferably, the first angle α1 is 45°. The arrangement direction U-U connects a center point of the first signal wire 6237 and a center point of the second signal wire 6238.

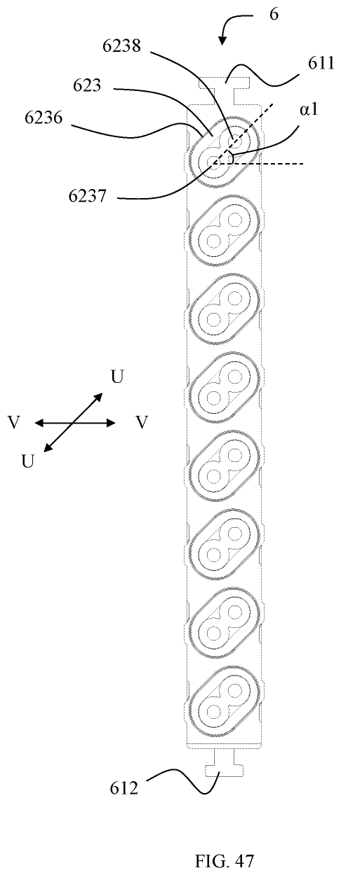

Referring to FIG. 47, the outermost insulating sheath 6236 of the cable 623 is elliptical to match the covering portion 622c. The elliptical shape is arranged inclined with respect to the thickness direction V-V of the insertion module 6. That is, a connection line between two focal points of the ellipse also shows a first angle α1 with the thickness direction V-V of the insertion module 6, where 0°<α1<90°. Preferably, the first angle α1 is 45°.

Referring to FIG. 47, in the illustrated embodiment of the present disclosure, the cable 623 is inclined at an angle greater than 0° and less than 90°. In one embodiment of the present disclosure, since the first conductive wire 6231 and the first cable connection portion 621a4 extend without angular deviation, an inclination angle of the cable 623 corresponds to the first angle α1. In one embodiment of the present disclosure, the inclination angle is 45°. As a result, it is beneficial to improve the overall arrangement of the second connector 200 and reduce the width occupied by the insertion module 6. It is understandable to those skilled in the art that in the illustrated embodiment of the present disclosure, when the cable 623 is tilted at 45°, in order to maintain horizontal alignment of the first mating terminal 621a and the second mating terminal 621b, the disclosed octagonal design concept can be obtained according to 360/45=8. Of course, other shapes with the number of sides greater than or equal to six are also feasible implementations. Preferably, the number of sides is even and the even number is greater than or equal to six. In this way, it is possible to maintain the symmetry of a mating frame port as much as possible.

In the illustrated embodiment of the present disclosure, the second insulating plate 61 is molded on the second terminal module 62. Specifically, the second insulating plate 61 is molded on the first installation end portion 622a1 and the second installation end portion 622b1. The cable 623 extends backwardly beyond the second insulating plate 61 along the first direction A1-A1.

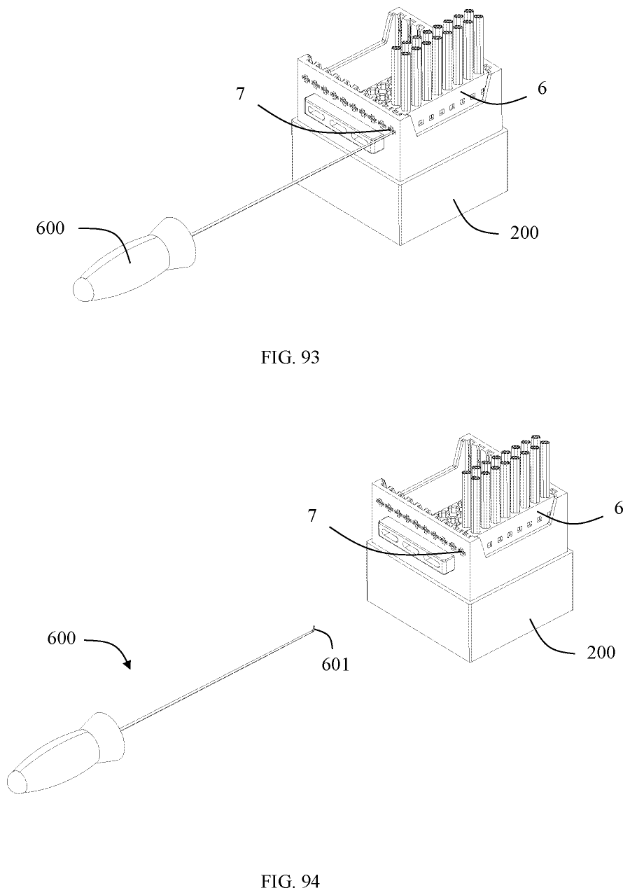

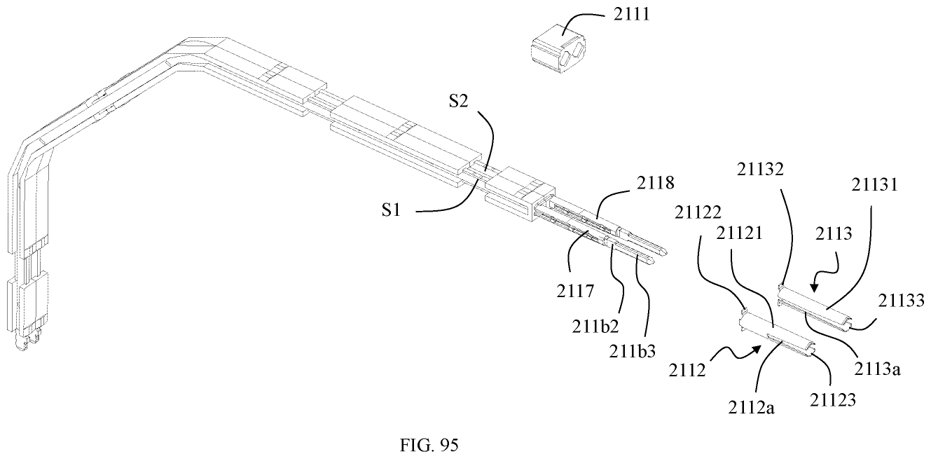

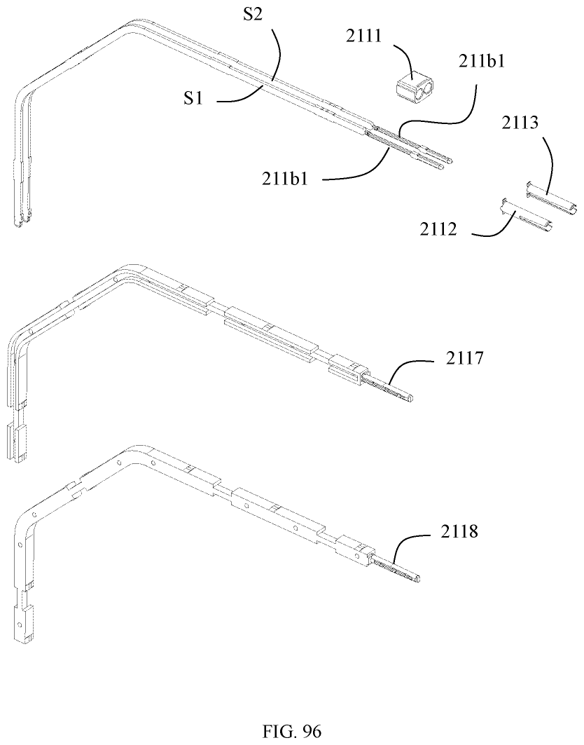

When assembling the second connector 200, the plurality of insertion modules 6 are firstly installed onto the second housing 5 along the first direction A1-A1. The second shielding sleeve 622 and the conductive component 624 of each insertion module 6 pass through a corresponding second terminal receiving slot 512 to protrude into the receiving space 501. Then, the first positioning pins 7 and the second positioning pins 8 are secured to the second housing 5 along the second direction A2-A2. At this time, the first positioning pins 7 and the second positioning pins 8 are inserted into the first positioning grooves 6111 and the second positioning grooves 6121, respectively, along the second direction A2-A2 to prevent the insertion modules 6 from detaching from the second housing 5. Referring to FIG. 93 and FIG. 94, during assembly or usage, one or more insertion modules 6 may become damaged and require repair or replacement. In such cases, a disassembly fixture 600 can be applied to the first disassembly hole 71 of the first positioning pin 7 and the second disassembly hole 81 of the second positioning pin 8 to facilitate the disassembly or assembly. In one embodiment of the present disclosure, the first disassembly hole 71 and the second disassembly hole 81 allow the disassembly fixture 600 to pass through, enabling a single insertion module 6 to be disassembled from or assembled to the second housing 5. In one embodiment of the present disclosure, the disassembly fixture 600 is provided with a hook 601. The hook 601 hooks the first disassembly hole 71 and the second disassembly hole 81, so that the single insertion module 6 can be more conveniently removed from the second housing 5 and assembled to the second housing 5. In the illustrated embodiment of the present disclosure, the first disassembly hole 71 and the second disassembly hole 81 are both complete holes. That is, the first positioning pin 7 has a solid structure completely surrounding the first disassembly hole 71, and the second positioning pin 8 has a solid structure completely surrounding the second disassembly hole 81. As a result, the present disclosure is beneficial to maintain the structural strength of the first positioning pin 7 and the second positioning pin 8, thereby reducing the risk that the first positioning pin 7 and the second positioning pin 8 may be damaged when the disassembly fixture 600 is disassembled and assembled.

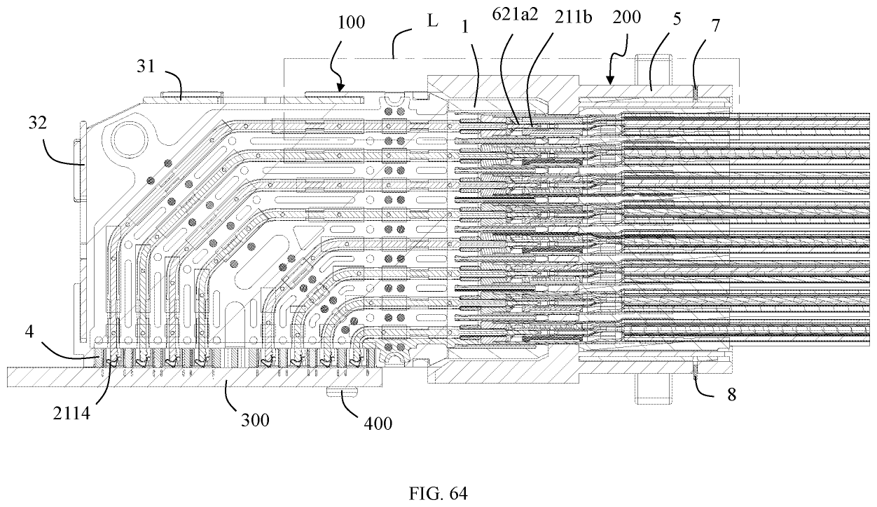

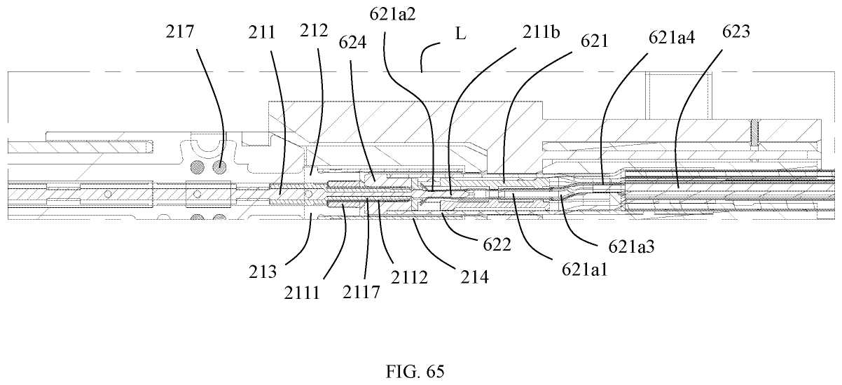

When the first connector 100 mates with the second connector 200, the first housing 1 of the first connector 100 is at least partially received in the receiving space 501 of the second connector 200. The second shielding sleeve 622 and the conductive component 624 of the second connector 200 are inserted into the first terminal receiving slot 112. The octagonal-shaped second shielding sleeve 622 matches the octagonal-shaped first terminal receiving slot 112. As mating progresses, the second shielding sleeve 622 and the conductive component 624 are inserted in the shielding space 2140 of the first shielding sleeve 214. The first contact portion 211b of the first conductive terminal S1 and the first contact portion 211b of the second conductive terminal S2 pass through the first insertion hole 6243 and the second insertion hole 6244, respectively, to enter the first accommodation space 621a22 of the first mating terminal 621a and the second accommodation space 621b22 of the second mating terminal 621b. Referring to FIG. 64 and FIG. 65, when the first connector 100 and the second connector 200 are fully mated, that is the first connector 100 and the second connector 200 are in a full mating status, the first shielding tube 2112 and the second shielding tube 2113 are at least partially inserted into the first insertion hole 6243 and the second insertion hole 6244, respectively, and are in contact with the conductive component 624 to provide grounding and shielding. The first slots 2112a and the second slots 2113a respectively opened on the first shielding tube 2112 and the second shielding tube 2113 can cause certain elastic deformation when the first shielding tube 2112 and the second shielding tube 2113 are at least partially inserted into the first insertion hole 6243 and the second insertion hole 6244, respectively. At this time, the second segment 211b2 of the first contact portion 211b of the first conductive terminal S1 and the second segment 211b2 of the first contact portion 211b of the second conductive terminal S2 are inserted into the insulating block 621c. In the illustrated embodiment of the present disclosure, a junction between the second segment 211b2 of the first contact portion 211b of the first conductive terminal S1 and the first segment 211b1 of the first contact portion 211b of the first conductive terminal S1 is disposed adjacent to an end face of the head 6241 of the conductive component 624. Similarly, a junction between the second segment 211b2 of the first contact portion 211b of the second conductive terminal S2 and the first segment 211b1 of the first contact portion 211b of the second conductive terminal S2 is also disposed adjacent to the end face. The third segment 211b3 of the first contact portion 211b of the first conductive terminal S1 is in contact with the first mating portion 621a2 of the first mating terminal 621a, and the contact area is located within the insulating block 621c. The third segment 211b3 of the first contact portion 211b of the second conductive terminal S2 is in contact with the second mating portion 621b2 of the second mating terminal 621b, the contact area is located within the insulating block 621c. Of course, it is understandable to those of ordinary skill in the art that the conductive component 624 may be arranged separately and assembled together with the second shielding sleeve 622, or the conductive component 624 is integrally formed with the second shielding sleeve 622.

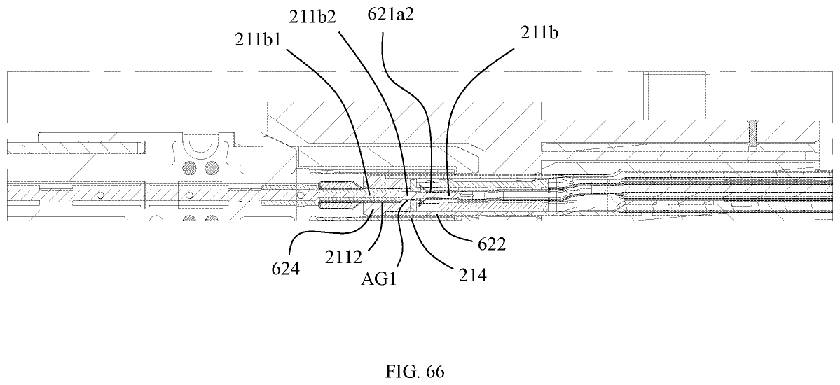

Referring to FIG. 66 and FIG. 67, during separation of the first connector 100 and the second connector 200, the positional relationship between the first contact portion 211b of the first conductive terminal S1 and the first contact portion 211b of the second conductive terminal S2 change in the positional relationship with respect to the first mating terminal 621a and the second mating terminal 621b, respectively. In this process, how to avoid impedance abruption is a technical problem that those skilled in the art need to solve.

In the illustrated embodiment of the present disclosure, the first shielding tube 2112 and the second shielding tube 2113 are single-ended coaxial structures. By providing the first shielding tube 2112 and the second shielding tube 2113, the impedance of the first segment 211b1 of the first contact portion 211b of the first conductive terminal S1 remains stable under the combined effects of the first insulating isolation block 2117 and the first shielding tube 2112, regardless of the mating/de-mating position between the first connector 100 and the second connector 200. Similarly, the impedance of the first segment 211b1 of the first contact portion 211b of the second conductive terminal S2 remains stable under the combined effects of the first insulating isolation block 2117 and the second shielding tube 2112, regardless of the mating/de-mating position between the first connector 100 and the second connector 200. At this time, the second segment 211b2 of the first contact portion 211b of the first conductive terminal S1 achieves impedance matching with the first segment 211b1 of the first conductive terminal S1 under the combined effects of the insulating block 621c and the tubular portion 622d. The second segment 211b2 of the first contact portion 211b of the second conductive terminal S2 achieves impedance matching with the first segment 211b1 of the second conductive terminal S2 under the combined effects of the insulating block 621c and the tubular portion 622d. Besides, the third segment 211b3 of the first contact portion 211b of the first conductive terminal S1 matches the impedance of the second segment 211b2 of the first conductive terminal S1 under the combined effects of the first mating portion 621a2, the insulating block 621c and the tubular portion 622d. Similarly, the third segment 211b3 of the first contact portion 211b of the second conductive terminal S2 matches the impedance of the second segment 211b2 of the second conductive terminal S2 under the combined effects of the second mating portion 621b2, the insulating block 621c and the tubular portion 622d.

Referring to FIG. 66, when the first connector 100 and the second connector 200 are just separated from each other, that is the first connector 100 and the second connector 200 are in a first de-mating status, the second segment 211b2 of the first contact portion 211b of the first conductive terminal S1 and the second segment 211b2 of the first contact portion 211b of the second conductive terminal S2 will at least partially enter the conductive component 624. At this time, the conductive component 624 defines a first air gap AG1 formed radially between the conductive component 624 and the second segment 211b2 of the first contact portion 211b of the first conductive terminal S1. Similarly, the conductive component 624 defines another first air gap AG1 formed radially between the conductive component 624 and the second segment 211b2 of the first contact portion 211b of the second conductive terminal S2. In other words, each of the second segment 211b2 of the first contact portion 211b of the first conductive terminal S1 and the second segment 211b2 of the first contact portion 211b of the second conductive terminal S2 is circumferentially surrounded by a corresponding first air gap AG1. The first air gap AG1 and the conductive component 624 together form an impedance medium surrounding a periphery of the second segment 211b2. Since the impedance of air is very high, it is necessary to use the conductive component 624 to prevent impedance abruption from occurring in the second segment 211b2. Specifically, a thickness of the second segment 211b2 is greater than a thickness of the first segment 211b1, so the impedance of the second segment 211b2 itself is smaller than the impedance of the first segment 211b1 itself. Combined with the conductive component 624 located on the periphery of the second segment 211b2, and in combination with the above factors, the impedance of the second segment 211b2 can be finally suppressed to prevent impedance abruption. Specifically, when the second segment 211b2 of the first contact portion 211b2 of the first conductive terminal S1 is at least partially located in the first air gap AG1, an inner wall of the first insertion hole 6243 of the conductive component 624 is disposed adjacent to the second segment 211b2 of the first contact portion 211b2 of the first conductive terminal S1. The inner wall of the first insertion hole 6243 of the conductive component 624 serves as a grounding reference for the second segment 211b2 of the first contact portion 211b2 of the first conductive terminal S1. Similarly, when the second segment 211b2 of the first contact portion 211b2 of the second conductive terminal S2 is at least partially located in the first air gap AG1, an inner wall of the second insertion hole 6244 of the conductive component 624 is disposed adjacent to the second segment 211b2 of the first contact portion 211b2 of the second conductive terminal S2. The inner wall of the second insertion hole 6244 of the conductive component 624 serves as a grounding reference for the second segment 211b2 of the first contact portion 211b2 of the second conductive terminal S2. By such arrangement, the present disclosure can prevent impedance abruption from occurring in the second segment 211b2.

Referring to FIG. 67 and FIG. 68, when the first connector 100 and the second connector 200 are further separated, the second segment 211b2 fully enters the conductive component 624. The first air gap AG1 and the conductive component 624 prevent impedance abruption in the second segment 211b2. At this time, at least part of the third segment 211b3 of the first contact portion 211b of the first conductive terminal S1 and at least part of the third segment 211b3 of the first contact portion 211b of the second conductive terminal S2 also enter the conductive component 624. At this time, the conductive component 624 defines a second air gap AG2 between the conductive component 624 and the third segment 211b3 of the first contact portion 211b of the first conductive terminal S1 in the radial direction. Similarly, the conductive component 624 defines another second air gap AG2 between the conductive component 624 and the third segment 211b3 of the first contact portion 211b of the second conductive terminal S2 in the radial direction. In other words, each of the third segment 211b3 of the first conductive terminal S1 and the third segment 211b3 of the second conductive terminal S2 is circumferentially surrounded by a corresponding second air gap AG2. Since the impedance of air is very high, a thickness of the second segment 211b2 is greater than a thickness of the first segment 211b1, a thickness of the third segment 211b3 is greater than the thickness of the first segment 211b1, and the thickness of the second segment 211b2 is greater than the thickness of the third segment 211b3. Therefore, an intrinsic impedance of the second segment 211b2 is lower than an intrinsic impedance of the first segment 211b1, and an intrinsic impedance of the third segment 211b3 is lower than the intrinsic impedance of the first segment 211b1. Combining the conductive component 624 at least partially located around the second segment 211b2 and the third segment 211b3, based on the above factors, the present disclosure can prevent impedance abruption from occurring in the third segment 211b3.

Besides, in the illustrated embodiment of the present disclosure, a cross-sectional area of the second segment 211b2 is larger than a cross-sectional area of the first segment 211b1, and the cross-sectional area of the second segment 211b2 is also larger than a cross-sectional area of the third segment 211b3. When the second segment 211b2 and/or the third segment 211b3 are exposed to the air within the conductive component 624, the conductive component 624 helps control impedance fluctuations. In other words, during the separation of the second segment 211b2 and the third segment 211b3 of the first conductive terminal S1 and the second segment 211b2 and the third segment 211b3 of the second conductive terminal S2 from the first mating portion 621a2 of the first mating terminal 621a and the second mating portion 621b2 of the second mating terminal 621b, respectively, they disengage from the impedance suppression provided by the insulating block 621c, the first mating portion 621a2 and the second mating portion 621b2, and enter the air. Since the impedance of air is high, in order to avoid impedance abruption, the present disclosure solves this problem well by providing the conductive component 624. At the same time, by designing the thickness of the second segment 211b2 and the third segment 211b3 to be greater than the thickness of the first segment 211b1, the conductive component 624 can achieve better anti-impedance abrupt effect.

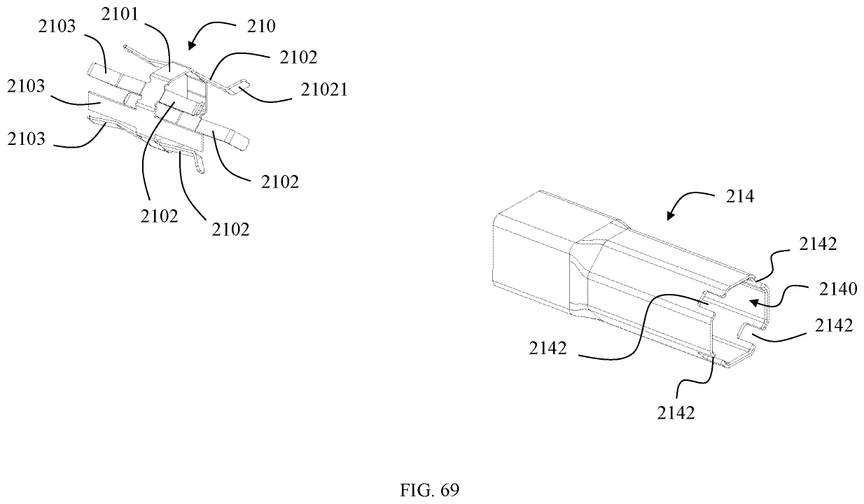

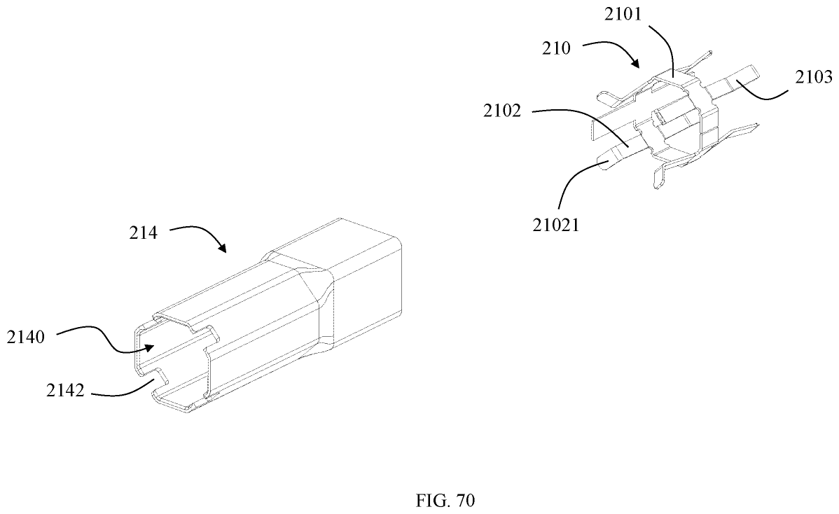

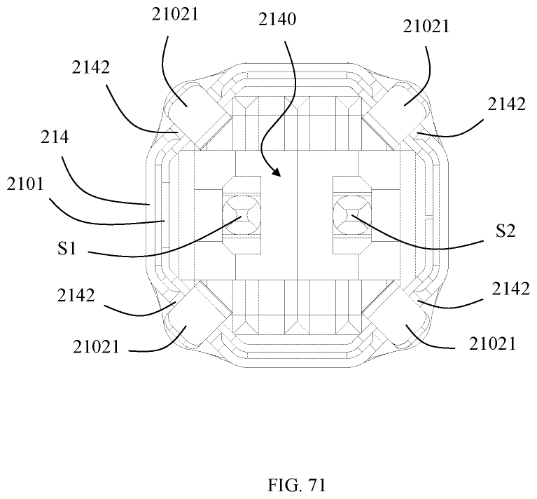

Referring to FIG. 69 to FIG. 71, in another embodiment of the present disclosure, the first terminal module 21 includes at least one elastic piece 210 partially received in the first shielding sleeve 214. The first shielding sleeve 214 defines a plurality of first opening slots 2142 at an end thereof. The plurality of first opening slots 2142 are spaced circumferentially along the first shielding sleeve 214. The elastic piece 210 includes an annular portion 2101, a plurality of elastic arms 2102 extending from one side of the annular portion 2101, and a plurality of extension arms 2103 extending from another side of the annular portion 2101. The annular portion 2101 is octagonal to conform to the shape of the inner wall of the first shielding sleeve 214. Each elastic arm 2102 is of a cantilevered configuration, and includes a flanged portion 21021 at a free end thereof. The flanged portion 21021 corresponds to the first opening slot 2142 and protrudes outward through the first opening slot 2142. The flanged portion 21021 guides the insertion of the second shielding sleeve 622 and prevents the elastic piece 210 from detaching from the first shielding sleeve 214.

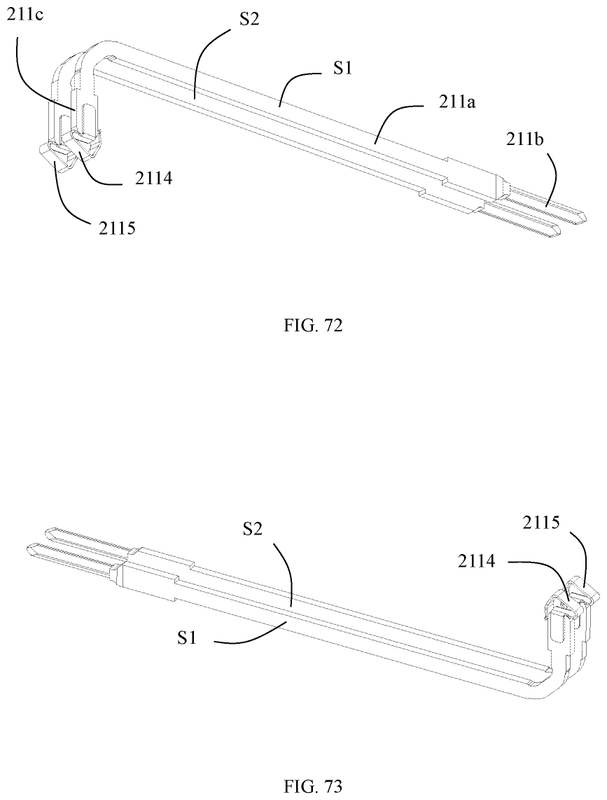

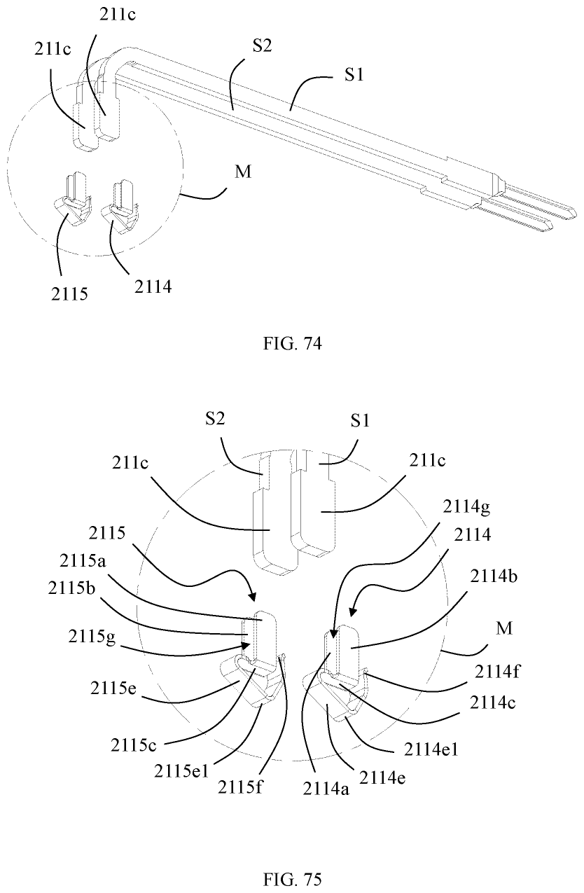

Referring to FIG. 72 to FIG. 75, in another illustrated embodiment of the present disclosure, each conductive terminal of the first terminal block 211 includes a first retaining portion 211a, a first contact portion 211b connected to one end of the first retaining portion 211a, and a first tail portion 211c connected to another end of the first retaining portion 211a. In the illustrated embodiment of the present disclosure, the first retaining portion 211a is of a bent configuration. The first contact portion 211b is pin-shaped and perpendicular to the first tail portion 211c. In another embodiment of the present disclosure, the first tail portion 211c is wider than the first retaining portion 211a connected thereto.

The first terminal block 211 further includes a first elastic abutting leg 2114 and a second elastic abutting leg 2115. The first elastic abutting leg 2114 is made of metal. The first elastic abutting leg 2114 and the first conductive terminal S1 are separately provided, and connected together. Similarly, the second elastic abutting leg 2115 and the second conductive terminal S2 are separately provided, and connected together.

Specifically, in the illustrated embodiment of the present disclosure, the first elastic abutting leg 2114 includes a first mounting plate 2114a, a second mounting plate 2114b disposed opposite to the first mounting plate 2114a, a first connecting portion 2114c connecting one side of the first mounting plate 2114a and one side of the second mounting plate 2114b, a first abutting arm 2114e connected to the first connecting portion 2114c, and a first distal end portion 2114f disposed at a free end of the first abutting arm 2114e. In the illustrated embodiment of the present disclosure, the first distal end portion 2114f extends adjacent to the first mounting plate 2114a and the second mounting plate 2114b. After the first elastic abutting leg 2114 is mounted to the circuit board 300, the first distal end portion 2114f is in contact with at least one of the first mounting plate 2114a, the second mounting plate 2114b and the first tail portion 211c of the first conductive terminal S1 to enhance performance. In the illustrated embodiment of the present disclosure, along the second direction A2-A2, the protruding heights of the first mounting plate 2114a and the second mounting plate 2114b are identical. The first mounting plate 2114a and the second mounting plate 2114b are spaced apart from each other along the third direction A3-A3. The first elastic abutting leg 2114 defines a first receiving slot 2114g between the first mounting plate 2114a and the second mounting plate 2114b. The first connecting portion 2114c is located at a bottom of the first receiving slot 2114g. In the illustrated embodiment of the present disclosure, the first abutting arm 2114e is approximately V-shaped, and includes a first pressing portion 2114e1 at a bottom thereof. In the illustrated embodiment of the present disclosure, the first pressing portion 2114e1 is not soldered or welded with the first conductive pad 303.

Specifically, in the illustrated embodiment of the present disclosure, the second elastic abutting leg 2115 includes a third mounting plate 2115a, a fourth mounting plate 2115b disposed opposite to the third mounting plate 2115a, a third connecting portion 2115c connecting one side of the third mounting plate 2115a and one side of the fourth mounting plate 2115b, a second abutting arm 2115e connected to the third connecting portion 2115c, and a second distal end portion 2115f connected to the second abutting arm 2115e and located at a free end of the second abutting arm 2115e. In the illustrated embodiment of the present disclosure, the second distal end portion 2115f extends adjacent to the third mounting plate 2115a and the fourth mounting plate 2115b. After the second elastic abutting leg 2115 is mounted to the circuit board 300, the second distal end portion 2115f is in contact with at least one of the third mounting plate 2115a, the fourth mounting plate 2115b and the first tail portion 211c of the second conductive terminal S2 to improve performance. In the illustrated embodiments of the present disclosure, along the second direction A2-A2, the protruding heights of the third mounting plate 2115a and the fourth mounting plate 2115b are identical. The third mounting plate 2115a and the fourth mounting plate 2115b are spaced apart from each other along the third direction A3-A3. The second elastic abutting leg 2115 includes a second receiving slot 2115g located between the third mounting plate 2115a and the fourth mounting plate 2115b along the third direction A3-A3. The third connecting portion 2115c is located at a bottom of the second receiving slot 2115g. In the illustrated embodiments of the present disclosure, the second abutting arm 2115e is substantially V-shaped, and includes a second pressing portion 2115e1 at a bottom thereof. The second pressing portion 2115e1 is configured to elastically abut against the second conductive pad 304. In the illustrated embodiment of the present disclosure, the second pressing portion 2115e1 is not soldered or welded with the second conductive pad 304.

During assembly, the first tail portion 211c of the first conductive terminal S1 is received in the first receiving slot 2114g of the first elastic abutting leg 2114. The first tail portion 211c of the first conductive terminal S1 is configured to abut against the first connecting portion 2114c along the second direction A2-A2 for positioning. The first mounting plate 2114a and the second mounting plate 2114b are located on two sides of the first tail portion 211c, and are in contact with the first tail portion 211c. In one embodiment of the present disclosure, at least one of the first mounting plate 2114a and the second mounting plate 2114b is fixed to the first tail portion 211c, for example, by soldering or welding.

Similarly, the first tail portion 211c of the second conductive terminal S2 is received in the second receiving slot 2115g of the second elastic abutting leg 2115. The first tail portion 211c of the second conductive terminal S2 is configured to abut against the third connecting portion 2115c along the second direction A2-A2 for positioning. The third mounting plate 2115a and the fourth mounting plate 2115b are located on two sides of the first tail portion 211c, and are in contact with the first tail portion 211c. In one embodiment of the present disclosure, at least one of the third mounting plate 2115a and the fourth mounting plate 2115b is fixed to the first tail portion 211c, for example, by soldering or welding.

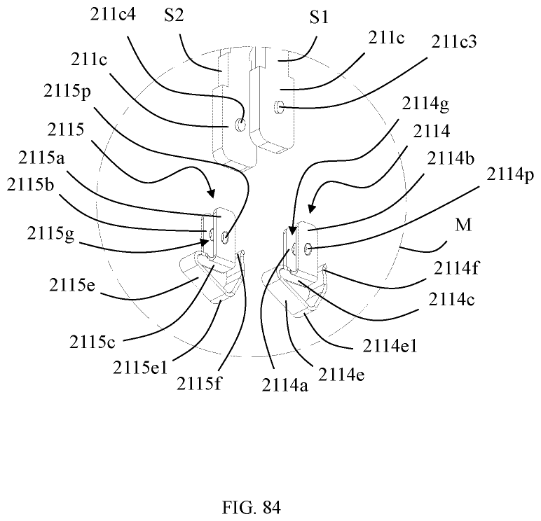

Referring to FIG. 84, in another embodiment shown in FIG. 75, the first tail portion 211c of the first conductive terminal S1 and at least one of the first mounting plate 2114a and the second mounting plate 2114b are provided with mutually engaging first protrusion 211c3 and first positioning hole 2114p. The first tail portion 211c of the second conductive terminal S2 and at least one of the third mounting plate 2115a and the fourth mounting plate 2115b are provided with mutually engaging second protrusion 211c4 and second positioning hole 2115p. In one embodiment of the present disclosure, the first protrusion 211c3 is a first boss integrally formed on the first tail portion 211c of the first conductive terminal S1. The first positioning hole 2114p extends through the first mounting plate 2114a and the second mounting plate 2114b. Similarly, the second protrusion 211c4 is a second boss integrally formed on the first tail portion 211c of the second conductive terminal S2. The second positioning hole 2115p extends through the third mounting plate 2115a and the fourth mounting plate 2115b. Through the engagement of the first protrusion 211c3 with the first positioning hole 2114p, combined with the restricting effect of the first connecting portion 2114c on the first tail portion 211c of the first conductive terminal S1, rotation of the first tail portion 211c with respect to the first elastic abutting leg 2114 during installation is prevented. Similarly, through the engagement of the second protrusion 211c4 with the second positioning hole 2115p, combined with the restricting effect of the third connecting portion 2115c on the first tail portion 211c of the second conductive terminal S2, rotation of the first tail portion 211c with respect to the second elastic abutting leg 2115 during installation is prevented.

Of course, in other embodiments of the present disclosure, the first protrusion 211c3 and the first positioning hole 2114p may both be of elongated configurations to prevent the first tail portion 211c of the first conductive terminal S1 from rotating with respect to the first elastic abutting leg 2114 after installation. Similarly, in other embodiments, the second protrusion 211c4 and the second positioning hole 2115p may both be of elongated configurations to prevent the first tail portion 211c of the second conductive terminal S2 from rotating with respect to the second elastic abutting leg 2115 after installation.

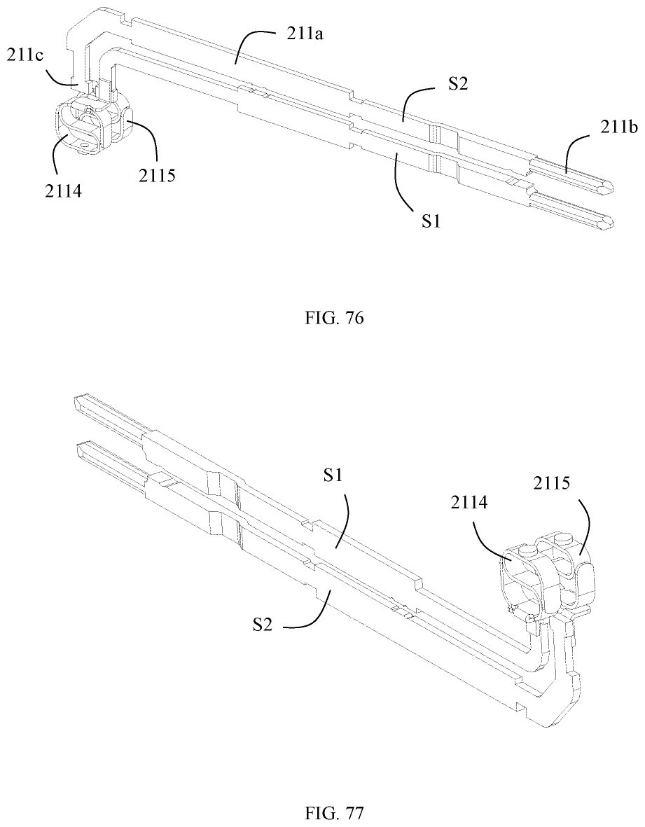

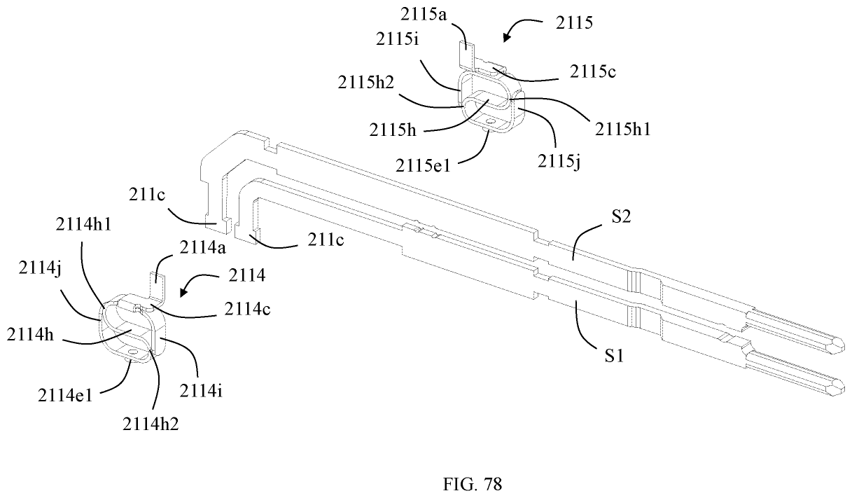

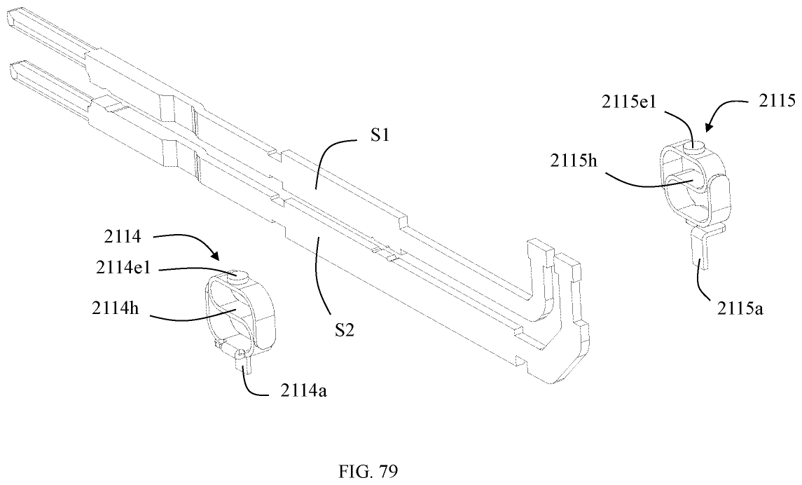

Referring to FIG. 76 to FIG. 79, in another illustrated embodiment of the present disclosure, each conductive terminal of the first terminal block 211 includes a first retaining portion 211a, a first contact portion 211b connected to one end of the first retaining portion 211a, and a first tail portion 211c connected to another end of the first retaining portion 211a. In the illustrated embodiment of the present disclosure, the first retaining portion 211a is of a bent configuration. The first contact portion 211b is needle-shaped and perpendicular to the first tail portion 211c. In another illustrated embodiment, the first tail portion 211c is widened compared to the first retaining portion 211a connected thereto.

The first terminal block 211 further includes a first elastic abutting leg 2114 and a second elastic abutting leg 2115. The first elastic abutting leg 2114 is made of metal. The first elastic abutting leg 2114 and the first conductive terminal S1 are separately provided and fixed together. The second elastic abutting leg 2115 and the second conductive terminal S2 are separately provided and fixed together.

Specifically, in another illustrated embodiment of the present disclosure, the first elastic abutting leg 2114 includes a first mounting plate 2114a, a first connecting portion 2114c connected to a bottom of the first mounting plate 2114a and perpendicular to the first mounting plate 2114a, a first S-shaped bending portion 2114h connected to the first connecting portion 2114c, a first bent portion 2114i connected to one end of the first S-shaped bending portion 2114h, and a second bent portion 2114j connected to another end of the first S-shaped bending portion 2114h. The first mounting plate 2114a is configured to contact the first tail portion 211c of the first conductive terminal S1. In one embodiment of the present disclosure, the first mounting plate 2114a is fixed to the first tail portion 211c of the first conductive terminal S1 by soldering welding. The first S-shaped bending portion 2114h includes a first arc-shaped bending portion 2114h1 and a second arc-shaped bending portion 2114h2. A free end of the first bent portion 2114i is disposed adjacent to an outer side of the second arc-shaped bending portion 2114h2. A free end of the second bent portion 2114j is adjacent to an outer side of the first arc-shaped bending portion 2114h1. A bottom of the first S-shaped bending portion 2114h is provided with a first pressing portion 2114e1 which is configured to elastically abut against the first conductive pad 303. In the illustrated embodiment of the present disclosure, the first pressing portion 2114e1 is not soldered or welded with the first conductive pad 303.

Similarly, the second elastic abutting leg 2115 includes a third mounting plate 2115a, a third connecting portion 2115c connected to the bottom of the third mounting plate 2115a and perpendicular to the third mounting plate 2115a, a second S-shaped bent portion 2115h connected to the third connecting portion 2115c, a third bent portion 2115i connected to one end of the second S-shaped bent portion 2115h, and a fourth bent portion 2115j connected to another end of the second S-shaped bent portion 2115h. The third mounting plate 2115a is configured to contact the first tail portion 211c of the second conductive terminal S2. In one embodiment of the present disclosure, the third mounting plate 2115a is welded to the first tail portion 211c of the second conductive terminal S2. The second S-shaped bent portion 2115h includes a third arc-shaped bending portion 2115h1 and a fourth arc-shaped bending portion 2115h2. The free end of the third bent portion 2115i is adjacent to the outer side of the fourth arc-shaped bending portion 2115h2. The free end of the fourth bent portion 2115j is adjacent to the outer side of the third arc-shaped bending portion 2115h1. The bottom of the second S-shaped bent portion 2115h is provided with a second pressing portion 2115e1, which is configured to elastically abut against the second conductive pad 304. In the illustrated embodiment of the present disclosure, the second pressing portion 2115e1 is not soldered or welded with the second conductive pad 304.

When the first pressing portion 2114e1 and the second pressing portion 2115e1 elastically abut against the first conductive pad 303 and the second conductive pad 304, respectively, the first elastic abutting leg 2114 and the second elastic abutting leg 2115 undergo elastic deformation. At this time, the free end of the first bent portion 2114i comes to contact with the outer side of the second arc-shaped bending portion 2114h2, the free end of the second bent portion 2114j comes to contact with the outer side of the first arc-shaped bending portion 2114h1, the free end of the third bent portion 2115i comes to contact with the outer side of the fourth arc-shaped bending portion 2115h2, and the free end of the fourth bent portion 2115j comes to contact with the outer side of the third arc-shaped bending portion 2115h1.

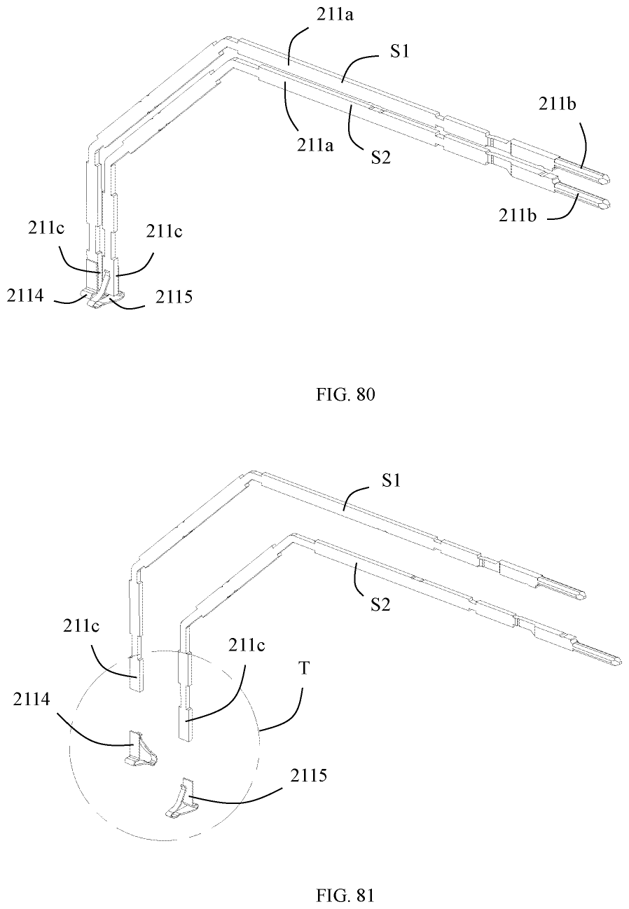

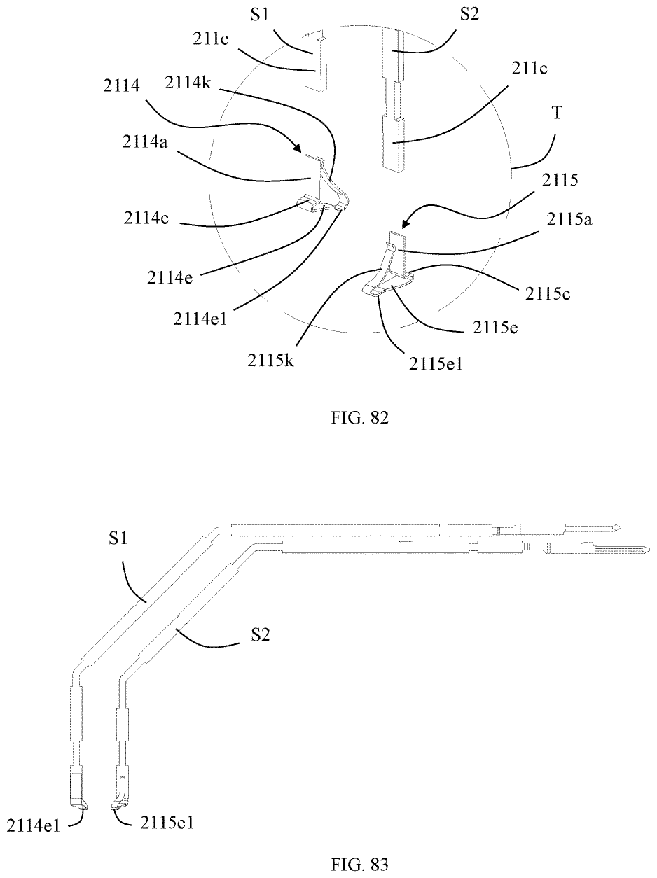

Referring to FIG. 80 to FIG. 83, in another illustrated embodiment of the present disclosure, the first elastic abutting leg 2114 includes a first mounting plate 2114a, a first connecting portion 2114c connected to a bottom of the first mounting plate 2114a, a first abutting arm 2114e connected to the first connecting portion 2114c, and a first retaining arm 2114k connected to the first abutting arm 2114e and extending toward the first mounting plate 2114a. In the illustrated embodiment of the present disclosure, the first mounting plate 2114a extends along the second direction A2-A2. The first connecting portion 2114c protrudes outwardly in the third direction A3-A3 with respect to the first mounting plate 2114a. A bottom of the first abutting arm 2114e is provided with a first pressing portion 2114e1 which is configured to elastically abut against the first conductive pad 303. In the illustrated embodiment of the present disclosure, the first pressing portion 2114e1 is not soldered or welded with the first conductive pad 303. The first retaining arm 2114k extends upwardly and obliquely, and is located beside the first mounting plate 2114a.

Similarly, the second elastic abutting leg 2115 includes a third mounting plate 2115a, a third connecting portion 2115c connected to a bottom of the third mounting plate 2115a, a second abutting arm 2115e connected to the third connecting portion 2115c, and a second retaining arm 2115k connected to the second abutting arm 2115e and extending toward the third mounting plate 2115a. In the illustrated embodiment of the present disclosure, the third mounting plate 2115a extends along the second direction A2-A2. The third connecting portion 2115c protrudes outwardly in the third direction A3-A3 compared with the third mounting plate 2115a. A bottom of the second abutting arm 2115e is provided with a second pressing portion 2115e1 which is configured to elastically abut against the second conductive pad 304. In the illustrated embodiment of the present disclosure, the second pressing portion 2115e1 is not soldered or welded with the second conductive pad 304. The second retaining arm 2115k extends upwardly and obliquely, and is located beside the third mounting plate 2115a.

In the illustrated embodiment of the present disclosure, the first elastic abutting leg 2114 and the second elastic abutting leg 2115 are share components to reduce costs.

During assembly, the first tail portion 211c of the first conductive terminal S1 is clamped between the first mounting plate 2114a and the first retaining arm 2114k. The first mounting plate 2114a is in contact with one side of the first tail portion 211c, and the first retaining arm 2114k is in contact with another side of the first tail portion 211c. By having the first retaining arm 2114k be in contact with the first tail portion 211c, the contact reliability between the first conductive terminal S1 and the first elastic abutting leg 2114 is enhanced. In one embodiment of the present disclosure, the first mounting plate 2114a is soldered or welded to the first tail portion 211c of the first conductive terminal S1. Similarly, the first tail portion 211c of the second conductive terminal S2 is clamped between the third mounting plate 2115a and the second retaining arm 2115k. The third mounting plate 2115a is in contact with one side of the first tail portion 211c, and the second retaining arm 2115k is in contact with another side. By having the second retaining arm 2115k be in contact with the first tail portion 211c, the contact reliability between the second conductive terminal S2 and the second elastic abutting leg 2115 is enhanced. In one embodiment of the present disclosure, the third mounting plate 2115a is soldered or welded to the first tail portion 211c of the second conductive terminal S2.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. A connector, comprising:
a housing; and
an insertion module, the insertion module being at least partially disposed in the housing; the insertion module comprising a terminal module; the terminal module comprising a terminal block, a shielding sleeve at least partially surrounding the terminal block, and a conductive component partially disposed on a side of the shielding sleeve; the terminal block comprising a first mating terminal; the first mating terminal comprising a first mating portion; the conductive component defining a first insertion hole at least partially located at one end of the first mating portion.

2. The connector according to claim 1, wherein the shielding sleeve comprises a tubular portion defining a hollow cavity; the terminal block is at least partially located in the cavity; a cross-sectional area of the first insertion hole is smaller than a cross-sectional area of the cavity.

3. The connector according to claim 2, wherein the shielding sleeve comprises a first shielding shell and a second shielding shell; and the first shielding shell and the second shielding shell are provided separately and fixed to each other.

4. The connector according to claim 3, wherein the first shielding shell comprises a first installation end portion and a first extending portion connected to the first installation end portion;
the second shielding shell comprises a second installation end portion and a second extending portion connected to the second installation end portion; the first installation end portion and the second installation end portion mate with each other; the first extending portion and the second extending portion mate with each other to form the tubular portion.

5. The connector according to claim 4, wherein the conductive component comprises a head and an insertion portion connected with the head; the insertion portion is partially inserted into the cavity.

6. The connector according to claim 5, wherein the first extending portion defines a first mounting notch; the second extending portion defines a second mounting notch;
the insertion portion comprises a first mounting rib and a second mounting rib; the first mounting rib and the second mounting rib are disposed on two sides of the insertion portion; the first mounting rib and the second mounting rib are inserted into the first mounting notch and the second mounting notch, respectively.

7. The connector according to claim 5, wherein the insertion portion comprises at least one latch protrusion, and the shielding sleeve defines at least one latch opening to engage with the at least one latch protrusion.

8. The connector according to claim 5, wherein the tubular portion is octagonal, and the head is octagonal to match the tubular portion.

9. The connector according to claim 1, wherein the first mating portion defines a first accommodation space, and the first insertion hole of the conductive component communicates with the first accommodation space.

10. The connector according to claim 1, wherein the terminal block comprises a second mating terminal; the second mating terminal comprises a second mating portion; the conductive component defines a second insertion hole at least partially located at one end of the second mating portion.

11. The connector according to claim 10, wherein a cross-sectional area of the second insertion hole is smaller than a cross-sectional area of the cavity.

12. The connector according to claim 10, wherein the second mating portion defines a second accommodation space, and the second insertion hole communicates with the second accommodation space.

13. The connector according to claim 1, wherein the conductive component is a metal block.

14. The connector according to claim 1, wherein the conductive component and the shielding sleeve are provided separately or integrated with each other.

15. A connector assembly, comprising:
a first connector comprising:
a first housing; and
a first terminal module assembled to the first housing; the first terminal module comprising a first terminal block; the first terminal block comprising a first conductive terminal and a first shielding tube; the first conductive terminal comprising a first contact portion; the first contact portion comprises a first segment, a second segment connected to the first segment, and a third segment connected to the second segment; the first shielding tube at least partially covering the first segment along a length thereof; the second segment and the third segment protruding beyond the first shielding tube;
a second connector comprising:
a second housing; and
an insertion module assembled to the second housing; the insertion module comprising a second terminal module; the second terminal module comprising a second terminal block, a second shielding sleeve at least partially surrounding the second terminal block, and a conductive component partially disposed on a side of the second shielding sleeve; the second terminal block comprising an insulating block and a first mating terminal; the first mating terminal comprising a first mating portion at least partially located in the insulating block; the conductive component defining a first insertion hole at least partially located at one end of the first mating portion;
when the first connector and the second connector are fully mated, the third segment of the first contact portion of the first conductive terminal passes through the first insertion hole, and is in contact with the first mating portion of the first mating terminal; and the second segment of the first contact portion is at least partially inserted into the insulating block.

16. The connector assembly according to claim 15, wherein when the first connector and the second connector are fully mated, the first shielding tube is at least partially accommodated in the first insertion hole.

17. The connector assembly according to claim 15, wherein in a first partially mated state, the second segment of the first contact portion is at least partially inserted in the first insertion hole of the conductive component.

18. The connector assembly according to claim 17, wherein when the first connector and the second connector are in the first partially mated state, the conductive component defines a first air gap circumferentially surrounding the second segment of the first contact portion of the first conductive terminal.

19. The connector assembly according to claim 17, wherein in a second partially mated state, the third segment of the first contact portion is at least partially inserted in the first insertion hole.

20. The connector assembly according to claim 19, wherein when the first connector and the second connector are in the second partially mated state, the conductive component defines a second air gap circumferentially surrounding the third segment of the first contact portion of the first conductive terminal.
